(19) United States
(12) Patent Application Publication
(10) Pub. No.: US 2024/0297764 A1
(43) Pub. Date: Sep. 5, 2024

(54) METHOD AND DEVICE FOR DETERMINING DEFAULT TRANSMISSION CONFIGURATION INDICATOR IN NETWORK COOPERATIVE COMMUNICATION

(71) Applicant: SAMSUNG ELECTRONICS CO., LTD., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 18/444,509

(22) Filed: Feb. 16, 2024

(30) Foreign Application Priority Data
Feb. 17, 2023 (KR) 10-2023-0021643

(51) Int. Cl. H04L 5/00; H04W 72/232

(52) U.S. Cl. CPC H04L 5/0053; H04L 5/0035; H04W 72/232

(57) ABSTRACT

The disclosure relates to a 5G or 6G communication system for supporting a higher data transmission rate. A method performed by a user equipment (UE) in a wireless communication system is provided. The method comprises receiving, from a base station, first downlink control information (DCI) including a transmission configuration indicator (TCI) field, receiving, from the base station, a second DCI for scheduling at least one physical downlink shared channel (PDSCH and receiving, from the base station, PDSCHs based on two TCI states for multi-transmission reception points (m-TRPs), in case that the second DCI includes a TCI selection field including a first value, wherein at least one of the two TCI states is identified based on the TCI field.

### CROSS-REFERENCE TO RELATED APPLICATIONS

This application is based on and claims priority under 35 U.S.C. § 119 to Korean Patent Application No. 10-2023-0021643, filed on Feb. 17, 2023, in the Korean Intellectual Property Office, the disclosure of which is herein incorporated by reference in its entirety.

### BACKGROUND

### 1. Field

The disclosure relates to an operation of a terminal and a base station in a wireless communication system. More specifically, the disclosure relates to a method of determining a default transmission configuration indicator in network cooperative communication, and a device capable of performing same.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An embodiment of the disclosure is to provide a device and a method enabling effective provision of a service in a mobile communication system.

A method performed by a user equipment (UE) in a wireless communication system is provided. The method comprises receiving, from a base station, first downlink control information (DCI) including a transmission configuration indicator (TCI) field, receiving, from the base station, a second DCI for scheduling at least one physical downlink shared channel (PDSCH and receiving, from the base station, PDSCHs based on two TCI states for multi-transmission reception points (m-TRPs), in case that the second DCI includes a TCI selection field including a first value, wherein at least one of the two TCI states is identified based on the TCI

### FIELD

A user equipment (UE) in a wireless communication system is provided. The UE comprises a transceiver and a controller coupled with the transceiver and configured to receive, from a base station, first downlink control information (DCI) including a transmission configuration indicator (TCI) field, receive, from the base station, a second DCI for scheduling at least one physical downlink shared channel (PDSCH), and receive, from the base station, PDSCHs based on two TCI states for multi-transmission reception points (m-TRPs), in case that the second DCI includes a TCI selection field including a first value, wherein at least one of the two TCI states is identified based on the TCI field.

A method performed by a base station in a wireless communication system is provided. The method comprises transmitting, to a user equipment (UE), first downlink control information (DCI) including a transmission configuration indicator (TCI) field, transmitting, to the UE, a second DCI for scheduling at least one physical downlink shared channel (PDSCH); and transmitting, to the UE, a PDSCH based on the second DCI, wherein the PDSCH is associated with multi-transmission reception points (m-TRPs) which are based on two TCI states, in case that the second DCI includes a TCI selection field including a first value, and wherein at least one of the two TCI states is identified based on the TCI field.

A base station in a wireless communication system is provided. The base station comprises a transceiver and a controller coupled with the transceiver and configured to transmit, to a user equipment (UE), first downlink control information (DCI) including a transmission configuration indicator (TCI) field, transmit, to the UE, a second DCI for scheduling at least one physical downlink shared channel (PDSCH), and transmit, to the UE, a PDSCH based on the second DCI, wherein the PDSCH is associated with multi-transmission reception points (m-TRPs) which are based on two TCI states, in case that the second DCI includes a TCI selection field including a first value, and wherein at least one of the two TCI states is identified based on the TCI field.

According to an embodiment of the disclosure, a device and a method enabling effective provision of a service in a mobile communication system are provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain of a wireless communication system according to an embodiment of the disclosure;

FIG. 2 illustrates a structure of a frame, a subframe, and a slot in a wireless communication system according to an embodiment of the disclosure;

FIG. 3 illustrates an example of bandwidth part configuration in a wireless communication system according to an embodiment of the disclosure;

FIG. 4 illustrates a wireless protocol structure between a terminal and a base station in single cell, carrier aggregation, and dual connectivity situations in a wireless communication system according to an embodiment of the disclosure;

FIG. 5 illustrates a multi-TRP-based PDSCH SFN transmission method according to an embodiment of the disclosure;

FIG. 6A illustrates an enhanced PDCCH TCI activation/deactivation MAC-CE structure according to an embodiment of the disclosure;

FIG. 6B illustrates an example of base station beam allocation according to a TCI state configuration;

FIG. 7 illustrates a beam application time which may be considered when a unified TCI scheme is used in a wireless communication system according to an embodiment of the disclosure;

FIG. 8 illustrates another MAC-CE structure for activation and indication of a joint TCI state or a separate DL or UL TCI state in a wireless communication system according to an embodiment of the disclosure;

FIG. 9 illustrates an example of configuration of a control resource set of a downlink control channel in a wireless communication system according to an embodiment of the disclosure;

FIG. 10 illustrates a structure of a downlink control channel in a wireless communication system according to an embodiment of the disclosure;

FIG. 11 illustrates an example of a TCI state allocation method for a PDCCH in a wireless communication system according to an embodiment of the disclosure;

FIG. 12 illustrates a TCI indication MAC CE signaling structure for a PDCCH DMRS in a wireless communication system according to an embodiment of the disclosure;

FIG. 13 illustrates an example of beam configuration of a control resource set and a search space in a wireless communication system according to an embodiment of the disclosure;

FIG. 14 illustrates an example of frequency axis resource allocation of a PDSCH in a wireless communication system according to an embodiment of the disclosure;

FIG. 15 illustrates an example of time axis resource allocation of a PDSCH in a wireless communication system according to an embodiment of the disclosure;

FIG. 16 illustrates a process for beam configuration and activation of a PDSCH according to an embodiment of the disclosure;

FIG. 17 illustrates an example of antenna port configuration and resource allocation for cooperative communication in a wireless communication system according to an embodiment of the disclosure;

FIG. 18 illustrates a configuration example of DCI for cooperative communication in a wireless communication system according to an embodiment of the disclosure;

FIG. 19 illustrates an enhanced PDSCH TCI state activation/deactivation MAC-CE structure according to an embodiment of the disclosure;

FIG. 20 illustrates a default beam operation when a unified TCI state-based PDSCH is received according to an embodiment of the disclosure;

FIG. 21A illustrates a default beam operation when a unified TCI state-based single or multi-TRP PDSCH is received according to an embodiment of the disclosure;

FIG. 21B illustrates a default beam operation when a unified TCI state-based single or multi-TRP PDSCH is received according to an embodiment of the disclosure;

FIG. 22 illustrates an operation depending on a TCI state selection field when a unified TCI state-based PDSCH is received according to an embodiment of the disclosure;

FIG. 23 illustrates an operation of a terminal according to an embodiment of the disclosure;

FIG. 24 illustrates an operation of a base station according to an embodiment of the disclosure;

FIG. 25 illustrates a structure of a terminal in a wireless communication system according to an embodiment of the disclosure; and

FIG. 26 illustrates a structure of a base station in a wireless communication system according to an embodiment of the disclosure.

### DETAILED DESCRIPTION

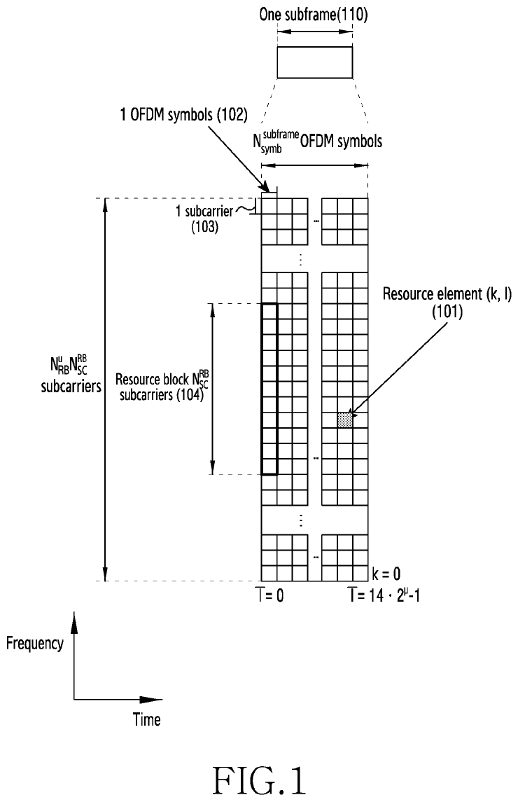

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery lifetime such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the above-described three services.

Hereinafter, the frame structure of a 5G system will be described in more detail with reference to the accompanying drawings.

FIG. 1 illustrates the basic structure of a time-frequency domain, which is a radio resource domain used to transmit data or control channels in a 5G system.

Referring to FIG. 1, the horizontal axis denotes a time domain, and the vertical axis denotes a frequency domain in FIG. 1. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

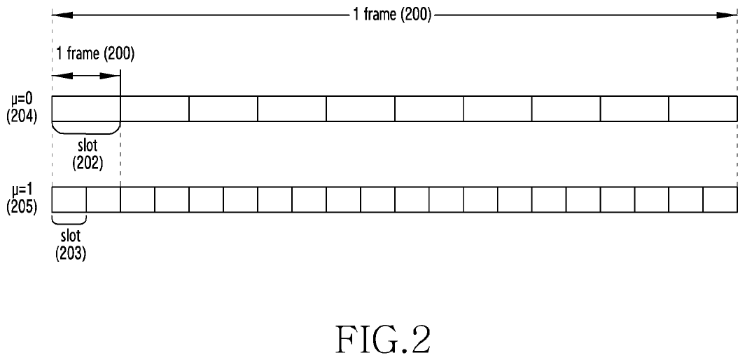

FIG. 2 illustrates the structure of frames, subframes, and slots in a wireless communication system according to an embodiment of the disclosure.

Referring to FIG. 2, an example of the structure of a frame 200, a subframe 201, and a slot 202 is illustrated in FIG. 2. One frame 200 may be defined as 10 ms. One subframe 201 may be defined as 1 ms. Therefore, one frame 200 may include a total of ten subframes 201. One slot 202 or 203 may be defined as 14 OFDM symbols (that is, the number of symbols per one slot N_{symb}^{slot}=14). One subframe 201 may include one slot or multiple slots 202 and 203. The number of slots 202 and 203 per one subframe 201 may differ depending on configuration values μ 204 and 205 regarding the subcarrier spacing.

The example in FIG. 2 illustrates a case in which the subcarrier spacing configuration value is μ=0 (204), and a case in which μ=1 (205). In the case of μ=0 (204), one subframe 201 may include one slot 202. In the case of μ=1 (205), one subframe 201 may include two slots 203. That is, the number of slots per one subframe Nₛₗₒₜ^{subframe,μ} may differ depending on the subcarrier spacing configuration value p, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration μ as in Table 1 below:

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, bandwidth part (BWP) configuration in a 5G communication system will be described in detail with reference to the accompanying drawings.

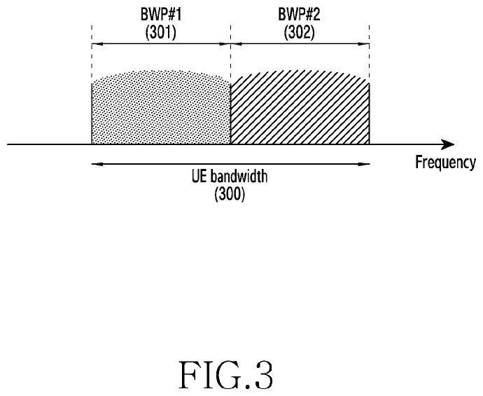

FIG. 3 illustrates an example of bandwidth part configuration in a wireless communication system according to an embodiment of the disclosure.

Referring to FIG. 3, FIG. 3 illustrates an example in which a UE bandwidth 300 is configured to include two bandwidth parts, that is bandwidth part #1 (BWP #1) 301 and bandwidth part #2 (BWP #2) 302. A base station may configure one or multiple bandwidth parts for a UE, and may configure the following pieces of information with regard to each bandwidth part.

TABLE 2

| | |
|---|---|
| BWP ::= | SEQUENCE |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

The pieces of information configured for the UE is not limited to the above example, and various parameters related to the bandwidth part may be configured for the UE, in addition to the configuration information in Table 2. The above pieces of configuration information may be transferred from the base station to the UE through upper layer signaling, for example, radio resource control (RRC) signaling. Among one or multiple bandwidth parts configured for the UE, at least one bandwidth part may be activated. Whether or not to activate the bandwidth part configured frequency range (FR) the UE may be semi-statically transferred from the base station to the UE through RRC signaling, or dynamically transferred through downlink control information (DCI).

According to some embodiment, the UE, prior to radio resource control (RRC) connection, may have an initial BWP for initial access configured by the base station through a master information block (MIB). To be more specific, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured by the MIB may be considered as identity (ID) 0. The base station may notify or configure the UE of configuration information, such as frequency allocation information regarding control resource set #0, time allocation information, and numerology, through the MIB. In addition, the base station may notify or configure the UE of configuration information regarding the monitoring cycle and occasion regarding control resource set #0, that is, configuration information regarding control resource set #0, through the MIB. The UE may identify or determine that a frequency domain configured by control resource set #0 acquired from the MIB is an initial bandwidth part for initial access. The ID of the initial bandwidth part may be considered 0.

According to an embodiment, the bandwidth part-related configuration supported by 5G may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE such that the UE can transmit and/or receive data at a specific frequency location within the system bandwidth.

According to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing, and when data is to be transmitted/received at a specific subcarrier spacing, the bandwidth part configured as the corresponding subcarrier spacing may be activated.

According to an embodiment, the base station may configure bandwidth parts having different sizes of bandwidths for the UE for the purpose of reducing power consumed by the UE. For example, if the UE supports a substantially large bandwidth (for example, 100 MHz) and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (e.g., a bandwidth part of 20 MHz) for the UE. The UE may perform a monitoring operation in the 20 MHz bandwidth part in the absence of traffic, and may transmit and/or receive data with the 100 MHz bandwidth part as instructed by the base station if data has occurred.

In connection with the bandwidth part configuring method, UEs, before being RRC-connected, may receive configuration information regarding the initial bandwidth part through a master information block (MIB) in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, and/or random access.

According to an embodiment, if a UE has one or more bandwidth parts configured therefor, the base station may instruct to the UE to change (or switch) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change (ort switch) the bandwidth part to bandwidth part #2 302 indicated by the bandwidth part indicator inside received DCI.

As described above, DCI-based bandwidth part changing may be indicated by DCI for scheduling a PDSCH or a PUSCH, and a UE, upon receiving a bandwidth part change request, needs to be able to receive or transmit the PDSCH or PUSCH scheduled by the corresponding DCI in the changed bandwidth part with no problem. To this end, a requirement regarding the delay time (TBWP) required during a bandwidth part change are specified standards, and may be defined, for example, as follows:

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

According to an embodiment, the requirement regarding the bandwidth part change delay time may support type 1 or type 2, depending on the capability of the UE. The UE may report the supportable bandwidth part delay time type to the base station. For example, the bandwidth part change delay time may vary depending on the capability of the UE, and the UE may report the bandwidth part delay time, determined based on the capability of the UE, to the base station. The bandwidth part delay time type may indicate the bandwidth part delay time.

According to an embodiment, if the UE has received DCI including a bandwidth part change indicator in slot n, according to the requirement regarding the bandwidth part change delay time, the UE may complete a change to the new bandwidth part indicated by the bandwidth part change indicator at a timepoint not later than slot n+TBWP, and may transmit and/or receive a data channel scheduled by the corresponding DCI in the newly changed bandwidth part.

In case that the base station wants to schedule a data channel by using the new bandwidth part, the base station may determine time domain resource allocation regarding the data channel, based on the UE's bandwidth part change delay time (TBWP). That is, when scheduling a data channel by using the new bandwidth part, the base station may schedule the corresponding data channel after the bandwidth part change delay time, in connection with determining time domain resource allocation regarding the data channel. Accordingly, the UE may not expect that the DCI that indicates a bandwidth part change may indicate a slot offset (K0 or K2) value smaller than the bandwidth part change delay time (TBWP).

In case that the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value. For example, the slot offset (K0 or K2) value may be indicated by a time domain resource allocation indicator field in the DCI.

For example, in case that the UE has received DCI indicating a bandwidth part change in slot n, and if the slot offset value indicated by the corresponding DCI is K, the UE may perform no transmission or reception from the third symbol of slot n to the symbol before slot n+K (that is, the last symbol of slot n+K−1).

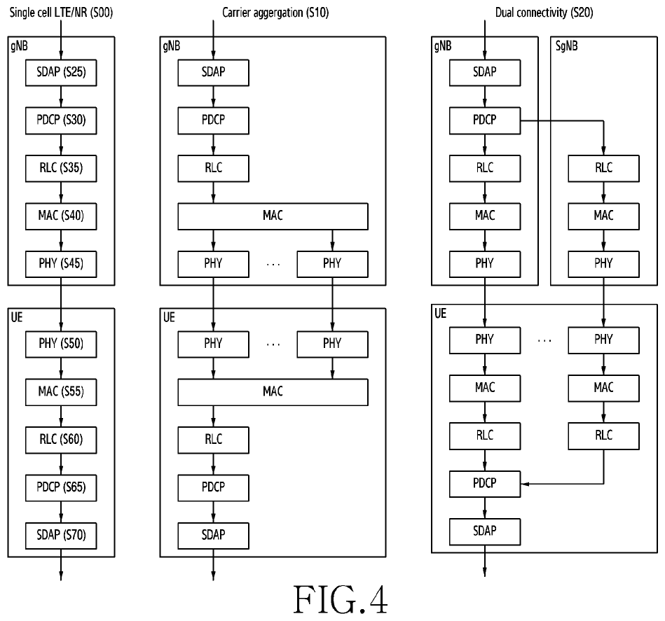

FIG. 4 illustrates radio protocol structures of a base station and a UE in single cell, carrier aggregation, and dual connectivity situations according to an embodiment of the present disclosure.

Referring to FIG. 4, a radio protocol of a next-generation wireless communication system includes an NR service data adaptation protocol (SDAP) S25 or S70, an NR packet data convergence protocol (PDCP) S30 or S65, an NR radio link control (RLC) S35 or S60, and an NR medium access control (MAC) S40 or S55 in each of a UE and an NR base station.

According to an embodiment, the main functions of the NR SDAP S25 or S70 may include some of functions below:
Transfer of user data (transfer of user plane data);
Mapping between a quality of service (QoS) flow and a data bearer for uplink and downlink (mapping between a QoS flow and a data radio bearer (DRB) for both DL and UL);
Marking a QoS flow ID in uplink and downlink (marking QoS flow ID in both DL and UL packets); and
Mapping a reflective QoS flow to a data bearer with respect to UL SDAP protocol data units (PDUs) (reflective QoS flow to DRB mapping for the UL SDAP PDUs).

For the SDAP layer device, whether to use a header of the SDAP layer device, or whether to use a function of the SDAP layer device may be configured for the UE through an RRC message for each PDCP layer device, each bearer, or each logical channel. In a case where an SDAP header is configured, the SDAP layer device may indicate the terminal to update or reconfigure mapping information relating to a QoS flow and a data bearer for uplink and downlink through a non access stratum (NAS) QoS reflective configuration one-bit indicator (NAS reflective QoS) and an As QoS reflective configuration one-bit indicator (AS reflective QoS) of the SDAP header. The SDAP header may include QoS flow ID information indicating a QoS. The QoS information may be used as data processing priority, scheduling information, etc. for smoothly supporting the service.

The main functions of the NR PDCP S30 or S65 may include some of functions below:
Header compression and decompression (ROHC only);
Transfer of user data;
In-sequence delivery (In-sequence delivery of upper layer PDUs);
Out-of-sequence delivery (Out-of-sequence delivery of upper layer PDUs);
Reordering (PDCP PDU reordering for reception);
Duplicate detection (Duplicate detection of lower layer SDUs);
Retransmission (Retransmission of PDCP SDUs);
Ciphering and deciphering; and
Timer-based SDU discard (Timer-based SDU discard in uplink).

The reordering of the NR PDCP device may refer to a function of reordering PDCP PDU received from a lower layer in an order based on PDCP sequence numbers (SNs), and the reordering of the NR PDCP device may include a function of transferring data to a higher layer according to a rearranged order.

The reordering of the NR PDCP device may include a function of directly transferring data without considering order, and may include a function of rearranging order to record lost PDCP PDUs. The reordering of the NR PDCP device may include a function of reporting the state of lost PDCP PDUs to a transmission side, and may include a function of requesting retransmission of lost PDCP PDUs.

The main functions of the NR RLC S35 or S60 may include some of functions below:
Data transfer (Transfer of upper layer PDUs);
In-sequence delivery (In-sequence delivery of upper layer PDUs);
Out-of-sequence delivery (Out-of-sequence delivery of upper layer PDUs);
ARQ (Error correction through ARQ);
Concatenation, segmentation and reassembly (Concatenation, segmentation and reassembly of RLC SDUs);
Re-segmentation (Re-segmentation of RLC data PDUs);
Reordering (Reordering of RLC data PDUs);
Duplicate detection;
Error detection (Protocol error detection);
RLC SDU discard; and
RLC re-establishment.

The in-sequence delivery of the NR RLC device may refer to a function of transferring RLC SDUs received from a lower layer to a higher layer in sequence. The in-sequence delivery may include a function of, if one original RLC SDU is divided into several RLC SDUs and then the RLC SDUs are received, reassembling the several RLC SDUs and transferring the reassembled RLC SDUs. The in-sequence delivery of the NR RLC device may include a function of rearranging received RLC PDUs with reference to RLC sequence numbers (SNs) or PDCP sequence numbers (SNs), and may include a function of rearranging order to record lost RLC PDUs. The in-sequence delivery of the NR RLC device may include a function of reporting the state of lost RLC PDUs to a transmission side, and may include a function of requesting retransmission of lost RLC PDUs.

The in-sequence delivery of the NR RLC device may include a function of, if there is a lost RLC SDU, sequentially transferring only RLC SDUs before the lost RLC SDU to a higher layer, may include a function of, although there is a lost RLC SDU, if a predetermined timer has expired, sequentially transferring, to a higher layer, all the RLC SDUs received before the timer is started, or may include a function of, although there is a lost RLC SDU, if a predetermined timer has expired, sequentially transferring all the RLC SDUs received up to the current, to a higher layer. Alternatively, the in-sequence delivery of the NR RLC device may process RLC PDUs in a reception order (an order in which the RLC PDUs have arrived, regardless of an order based on sequence numbers) and then transfer the processed RLC PDUs to a PDCP device regardless of order (out-of-sequence delivery). In a case of segments, the NR RLC device may receive segments stored in a buffer or to be received in the future, reconfigure the segments to be one whole RLC PDU, then process the RLC PDU, and transfer the processed RLC PDU to a PDCP device. The NR RLC layer may not include a concatenation function, and the concatenation function may be performed in an NR MAC layer or replaced with a multiplexing function of an NR MAC layer.

The out-of-sequence delivery function of the NR RLC device may refer to a function of immediately transferring RLC SDUs received from a lower layer, to an upper layer regardless of the order thereof. The out-of-sequence delivery function may include a function of, if one original RLC SDU is divided into several RLC SDUs and then the RLC SDUs are received, reassembling the several RLC SDUs and transferring the reassembled RLC SDUs, and may include a function of storing an RLC sequence number (SN) or a PDCP sequence number (SN) of received RLC PDUs and arranging order to record lost RLC PDUs.

The NR MAC S40 or S55 may be connected to several NR RLC layer devices configured in a single UE, and the main functions of the NR MAC may include some of functions below:
Mapping (Mapping between logical channels and transport channels);
Multiplexing and demultiplexing (Multiplexing/demultiplexing of MAC SDUs);
Scheduling information reporting;
HARQ (Error correction through HARQ);
Priority handling between logical channels (Priority handling between logical channels of one UE);
Priority handling between UEs (Priority handling between UEs by means of dynamic scheduling);
MBMS service identification;
Transport format selection; and
Padding.

An NR PHY layer S45 or S50 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer.

A detailed structure of a wireless protocol structure may be variously changed according to a carrier (or cell) operation scheme. For example, in a case where a base station transmits data to a terminal, based on a single carrier (or cell), the base station and the terminal use a protocol structure having a single structure on each layer as shown in structure S00. On the contrary, in a case where a base station transmits data to a terminal, based on carrier aggregation (CA) using multiple carriers at a single TRP, the base station and the terminal use a protocol structure having a single structure up to RLC, but multiplexing a PHY layer via a MAC layer as shown in structure S10. As another example, in a case where a base station transmits data to a terminal, based on dual connectivity (DC) using multiple carriers at multiple TRPs, the base station and the terminal use a protocol structure having a single structure up to RLC, but multiplexing a PHY layer via a MAC layer as shown in structure S20.

A method of indication and configuration, by a base station, using a combination of L1 signaling and higher layer signaling for multi-TRP-based PDSCH SFN transmission, and a method of reception by a terminal are described. In a case where a base station schedules a multi-TRP-based PDSCH SFN transmission method for a terminal through DCI, a condition of a DCI field and a condition of higher layer signaling may be as follows.

TCI state field in DCI: This may indicate a codepoint of a TCI state field including two TCI states.

Antenna port field in DCI: The number of CDM groups may be fixed to one or may be one or more.

Time domain resource allocation field in DCI: There may be no restriction on the field (e.g., one of condition 1, 2, or 3 of the time domain resource allocation field included in [Table 20] described later may be possible). Only condition 3 (e.g., the higher layer signaling repetitionNumber is not configured for all TDRA entries) may be possible.

Higher layer signaling repetitionScheme: This may be configured or not configured.

A new higher layer signaling for a multi-TRP-based PDSCH SFN technique may be additionally configured. For support of the above multi-TRP-based PDSCH technique (e.g., multi-TRP SDM, FDM scheme A, FDM scheme B, TDM scheme A, or TDM scheme B), a terminal may expect that a new higher layer signaling for a multi-TRP-based PDSCH SFN technique is not configured.

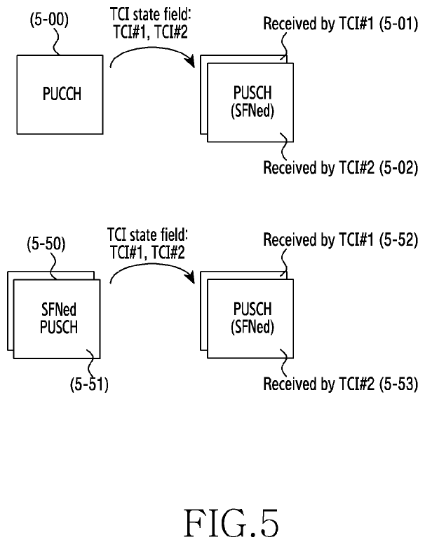

FIG. 5 illustrates a multi-TRP-based PDSCH SFN transmission method according to an embodiment of the disclosure.

Referring to FIG. 5, a base station according to an embodiment may indicate and configure the DCI field value and higher layer signaling described above for a terminal, and then transmits a PDCCH to the terminal (5-00). TCI states #1 and #2 may be indicated through a TCI state field in the transmitted PDCCH. Time and frequency resource allocation information may be indicated through one time domain resource allocation field and one frequency domain resource allocation field in the transmitted PDCCH, respectively.

According to an embodiment, the terminal may receive an SFN-transmitted PDSCH by using two different TCI states (TCI states #1 and #2) at a resource position based on the time and frequency resource allocation information (5-01 and 5-02). This may also be applied to SFN-based PDCCH repetitive transmission in the same way. The terminal may receive an SFN-transmitted PDCCH through application of two different TCI states in one control resource set (5-50 and 5-51). The terminal may receive an SFN-transmitted PDCCH by using two different TCI states (TCI states #1 and #2) at a resource position based on the time and frequency resource allocation information indicated based on pieces of information of a DCI field included in the SFN-transmitted PDCCH (5-52 and 5-53).

According to an embodiment, a method of indication and configuration, by a base station, using a combination of L1 signaling and higher layer signaling for a multi-TRP-based SFN PDCCH and SFN PDSCH transmission method, or restrictions are described.

According to an embodiment, one of an SFN transmission scheme of a base station using base station-based Doppler correction (hereinafter, this may be named a base station-based SFN scheme) or an SFN transmission scheme of a base station using terminal-based Doppler correction (hereinafter, this may be named a terminal-based SFN scheme) may be configured for a terminal by a base station through higher layer signaling.

According to an embodiment, an SFN transmission scheme may be configured for each bandwidth part or each carrier. In addition, configuration of an SFN transmission scheme may use configuration information of each of a PDCCH and a PDSCH, and may use one piece of configuration information that is common for a PDCCH and a PDSCH.

According to an embodiment, a terminal may not expect that SFN transmission schemes of a base station applied to a PDCCH and a PDSCH are different types. For example, in a case where particular SFN transmission schemes are applied to transmission of a PDCCH and a PDSCH by the base station, the terminal may expect that the same SFN transmission scheme is applied to the PDCCH and the PDSCH. For example, in a case where a particular SFN transmission scheme is applied to PDCCH transmission by the base station, the terminal may expect that the same SFN transmission scheme is configured for and applied to all control resource sets. That is, the terminal may not expect that a base station-based SFN scheme is configured for and applied to some control resource sets and a terminal-based SFN scheme is configured for and applied to the remaining some control resource sets.

According to an embodiment, a terminal may transfer, to a base station through a terminal capability report, whether a reception operation for single-TRP-based PDSCH single transmission or SFN PDSCH transmission by the base station is dynamically changeable. For example, the terminal capability report may be reportable for each carrier or each terminal.

According to an embodiment, with respect to a terminal having not reported a terminal capability relating to whether a reception operation for single-TRP-based PDSCH single transmission or SFN PDSCH transmission by a base station is dynamically changeable, the base station may transmit the enhanced PDSCH TCI state activation/deactivation MAC-CE to the terminal so that all codepoints of a TCI field in DCI each indicate two TCI states. When not reporting a terminal capability, the terminal may not expect that at least one codepoint of a TCI field in DCI indicates one TCI state.

According to an embodiment, with respect to a terminal having reported a terminal capability relating to whether a reception operation for single-TRP-based PDSCH single transmission or SFN PDSCH transmission by a base station is dynamically changeable, the base station may configure, through higher layer signaling, whether a reception operation for single-TRP-based PDSCH single transmission or multi-TRP-based PDSCH SFN transmission is dynamically changeable. The terminal may receive an indication of one or two TCI states through a TCI field in DCI according to whether the higher layer signaling is configured.

According to an embodiment, higher layer signaling relating to whether a reception operation for single-TRP-based PDSCH single transmission or multi-TRP-based PDSCH SFN transmission is dynamically changeable may not exist for a terminal having reported or having not reported a terminal capability. A base station may indicate one or two TCI states to a terminal having reported a terminal capability, through a TCI field in DCI by using a TCI state activation MAC-CE for a PDSCH. The base station may indicate that all TCI codepoints each have one TCI state or all TCI codepoints each have two TCI states, to a terminal having not reported a terminal capability, through a TCI field in DCI by using a TCI state activation MAC-CE for a PDSCH.

According to an embodiment, a terminal may transfer, to a base station through a terminal capability report, whether a reception operation for single-TRP-based PDCCH single transmission or SFN PDCCH transmission by the base station is dynamically changeable. For example, the terminal capability report may be reportable for each carrier or each terminal.

According to an embodiment, a base station may configure, for a terminal having not reported a terminal capability, higher layer signaling relating to whether a control resource set in which one TCI state is activated and a control resource set in which two TCI states are activated coexist. For example, the higher layer signaling may be configured for each bandwidth part or each carrier.

If a terminal has not reported a terminal capability, configuration information of higher layer signaling relating to coexistence from a base station may not be configured, or may be configured to indicate that coexistence of control resource sets in which different numbers of TCI states are activated is impossible. If a terminal has reported a terminal capability, configuration information of higher layer signaling relating to coexistence from a base station may be configured to indicate that coexistence of control resource sets in which different numbers of TCI states are activated is possible.

In addition, higher layer signaling relating to whether control resource sets in which different numbers of TCI states are activated coexist may not exist for a terminal having reported a terminal capability. A base station may perform activation allowing some control resource sets to have one TCI each and the remaining some control resource sets to have two TCI states each, through a TCI state activation MAC-CE for a PDCCH so that control resource sets in which different numbers of TCI states are activated are coexistable for a terminal having reported a terminal capability. The base station may perform activation allowing all control resource sets to have one TCI state each or activation allowing all control resource sets to have two TCI states each, through a TCI state activation MAC-CE for a PDCCH so that control resource sets in which different numbers of TCI states are activated do not coexist for a terminal having not reported the terminal capability. The all control resource sets may be all control resource sets in a carrier or all control resource sets configured for a terminal according to a unit of a terminal capability report (for each carrier or each terminal).

According to an embodiment, with respect to two types of terminal capabilities of a terminal (e.g., a terminal capability relating to whether a reception operation for single-TRP-based PDSCH single transmission or SFN PDSCH transmission is dynamically changeable, and a terminal capability relating to whether a reception operation for single-TRP-based PDCCH single transmission or SFN PDCCH transmission is dynamically changeable), the terminal may include information on the two types of terminal capabilities in one single terminal capability report, and transfer the information and the report. In addition, the two types of terminal capabilities may be defined as independent terminal capabilities. For example, the information on the two types of terminal capabilities may be included and transferred in different terminal capability reports.

According to an embodiment, a terminal may report terminal capability information on a PDCCH (e.g., whether a reception operation for single-TRP-based PDCCH single transmission or SFN PDCCH transmission is dynamically changeable) together through reporting of a terminal capability on a PDSCH (e.g., a terminal capability relating to whether a reception operation for single-TRP-based PDSCH single transmission or SFN PDSCH transmission is dynamically changeable).

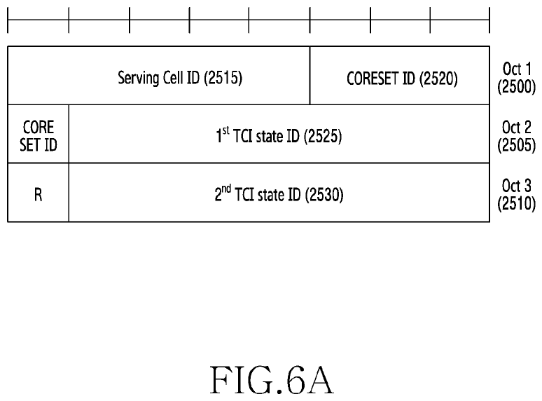

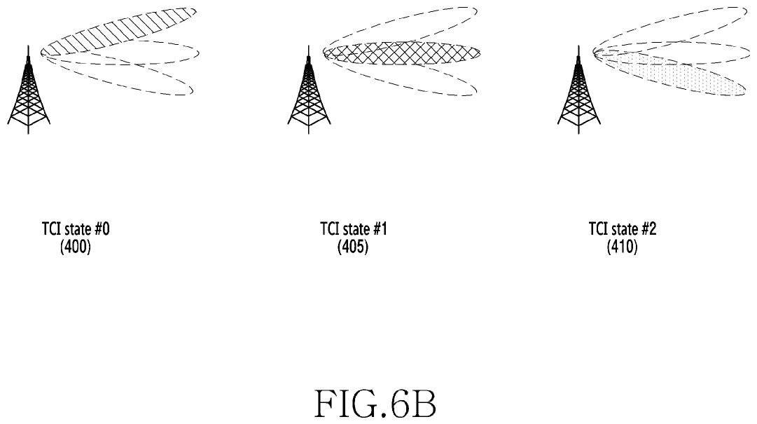

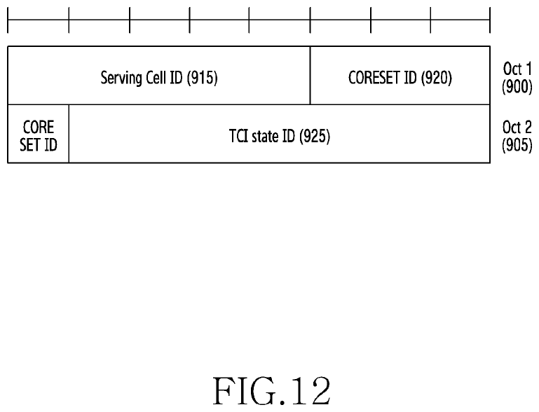

FIG. 6A illustrates an enhanced PDCCH TCI activation/deactivation MAC-CE structure according to an embodiment of the disclosure. FIG. 6A shows a structure in which a third octet 2510 is added to a structure of FIG. 12. Referring to FIG. 6A, a 2^{nd} TCI state ID may be additionally indicated to activate a 1^{st} TCI state ID 2525 and/or a 2^{nd} TCI state ID 2530 indicated by a MAC-CE for an indicated serving cell ID 2515 and a control resource set index (or CORESET ID) 2520. If the serving cell ID 2515 indicated by an enhanced PDCCH TCI state activation/deactivation MAC-CE is included in the higher layer signaling simultaneousTCI-UpdateList1-r16 or simultaneousTCI-UpdateList2-r16, a 1^{st} TCI state ID 2525 and a 2^{nd} TCI state ID indicated by a MAC-CE may be simultaneously applied to a control resource set index indicated by a MAC-CE, even for another serving cell ID included in simultaneousTCI-UpdateList1-r16 or simultaneousTCI-UpdateList2-r16. If a serving cell ID included in simultaneousTCI-UpdateList1-r16 is 1 to 4 and a serving cell ID, a control resource set index (or, CORESET ID), a 1^{st} TCI state ID, and a 2^{nd} TCI state ID indicated by a MAC-CE are 2, 1, 0, and 1, respectively, TCI state IDs #0 and #1 may be simultaneously activated even for control resource set index #1 existing in serving cells 1, 3, and 4 through the MAC-CE.

According to an embodiment, one or more different antenna ports (or one or more channels, signals, and a combination thereof are substitutable therefor, but are collectively referred to as different antenna ports for convenience of explanation in the following description of the disclosure) may be connected or associated with each other in a wireless communication system by a quasi co-location (QCL) configuration as [Table 4] below.

According to an embodiment, a TCI state is to notify of or indicate a QCL relation between a PDCCH (or PDCCH DMRS) and a different RS or channel. Reference antenna port A (reference RS #A) and another target antenna port B (target RS #B) being QCLed to each other implies that a terminal is allowed to apply all or some of large-scale channel parameters estimated in antenna port A to channel measurement in antenna port B. QCL may associate different parameters according to situations including 1) time tracking affected by average delay and delay spread, 2) frequency tracking affected by Doppler shift and Doppler spread, 3) radio resource management (RRM) affected by average gain, and 4) beam management (BM) affected by spatial parameter. Accordingly, NR supports four types of QCL relations as shown in [Table 1] below.

TABLE 4

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may include or indicate some or all of various parameters including angle of arrival (AoA), power angular spectrum (PAS) of AoA, angle of departure (AoD), PAS of AoD, transmit/receive channel correlation, transmit/receive beamforming, and spatial channel correlation.

The QCL relations are configurable for a terminal through an RRC parameter TCI-State and QCL-Info as shown in Table 5 below. Referring to [Table 5], a base station may configure at least one TCI state for a terminal to notify of a maximum of two types of QCL relations (qcl-Type1 and qcl-Type2) for an RS referring to an ID of the TCI state, that is, a target RS (or an RS associated with the TCI state ID). Each piece of QCL information (QCL-Info) included in each TCI state may include a serving cell index and a BWP index of a reference RS and the type and ID of a reference signal (RS) indicated by a corresponding piece of QCL information, and a QCL type described in [Table 4].

TABLE 5

| | |
|---|---|
| TCI-State ::= | SEQUENCE { |
| tci-StateId | TCI-StateId, |

(ID of TCI state)

| | |
|---|---|
| qcl-Type1 | QCL-Info, |

(QCL information of first reference RS of RS (target RS) referring
to TCI state ID)

| | | |
|---|---|---|
| qcl-Type2 | QCL-Info | OPTIONAL, -- Need R |

```
  (QCL information of second reference RS of RS (target RS) referring
to TCI state ID)
  ...
}
```

| QCL-Info ::= | SEQUENCE | |
|---|---|---|
| cell | ServCellIndex | OPTIONAL, -- Need R |

(Serving cell index of reference RS indicated by QCL information)

| | | |
|---|---|---|
| bwp-Id | BWP-Id | OPTIONAL, -- Cond |

CSI-RS-Indicated
(BWP index of reference RS indicated by QCL information)

| | |
|---|---|
| referenceSignal | CHOICE { |
| csi-rs | NZP-CSI-RS-ResourceId, |
| ssb | SSB-Index |

```
    (One of CSI-RS ID or SSB ID indicated by QCL information)
  },
```

| | |
|---|---|
| qcl-Type | ENUMERATED {typeA, typeB, typeC, typeD}, |

...
}

FIG. 6B illustrates an example of base station beam allocation according to a TCI state configuration.

Referring to FIG. 6B, a base station may transfer, to a terminal, information about N different beams through N different TCI states. For example, as illustrated in FIG. 6B, if N is equal to 3, the base station may allow qcl-Type 2 parameters included in three TCI states 400, 405, and 410 to be associated with CSI-RSs or SSBs corresponding to different beams and to be configured as QCL type D, so as to notify that antenna ports referring to the different TCI states 400, 405, and 410 are associated with different spatial Rx parameters, that is, different beams.

[Table 6] to [Table 10] below show valid TCI state configurations according to the type of a target antenna port.

[Table 6] shows a TCI state configuration that is valid when a target antenna port is a CSI-RS for tracking (e.g., TRS). The TRS may be referred to as an NZP CSI-RS, among CSI-RSs, for which a repetition parameter is not configured and trs-Info is configured as true. Configuration #3 in [Table 10] may be used for aperiodic TRSs. [Table 6] may include a TCI state configuration that is valid when a target antenna port is a CSI-RS for tracking (TRS).

TABLE 6

| Valid TCI | | | | |
|---|---|---|---|---|
| state | | | DL RS 2 (if | qcl-Type2 (if |
| Configuration | DL RS 1 | qcl-Type1 | configured) | configured) |
| 1 | SSB | QCL-TypeC | SSB | QCL-TypeD |
| 2 | SSB | QCL-TypeC | SCI-RS (BM) | QCL-TypeD |
| 3 | TRS | QCL-TypeA | TRS (same as | QCL-TypeD |
| | (periodic) | | DL RS 1) | |

[Table 7] shows a TCI state configuration that is valid when a target antenna port is a CS-RS for CSI. The CS-RS for CSI may be referred to as an NZP CS-RS, among CS-RSs, for which a parameter indicating repetition (e.g., repetition parameter) is not configured and trs-Info is also not configured as true. [Table 7] may include a TCI state configuration that is valid when a target antenna port is a CSI-RS for CSI.

TABLE 7

| Valid | | | DL RS 2 | qcl-Type2 |
|---|---|---|---|---|
| TCI state | | | (if | (if |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

[Table 8] shows a TCI state configuration that is valid when a target antenna port is a CSI-RS for beam management (BM) (This is the same as a CSI-RS for L1 RSRP reporting). The CSI-RS for BM may be referred to as an NZP CSI-RS, among CSI-RSs, for which a repetition parameter is configured and has a value of On or Off and trs-Info is not configured as true. [Table 8] may include a TCI state configuration that is valid when a target antenna port is a CSI-RS for BM (for L1 RSRP reporting).

TABLE 8

| Valid | | | DL RS 2 | qcl-Type2 |
|---|---|---|---|---|
| TCI state | | | (if | (if |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH Block | QCL-TypeD |
| | Block | | | |

[Table 9] may include or show a TCI state configuration that is valid when a target antenna port is a PDCCH DMRS. [Table 9] [Table 9] may include a TCI state configuration that is valid when a target antenna port is a PDCCH DMRS.

TABLE 9

| Valid | | | DL RS 2 | qcl-Type2 |
|---|---|---|---|---|
| TCI state | | | (if | (if |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

[Table 10] may include or show a TCI state configuration that is valid when a target antenna port is a PDSCH DMRS. [Table 10] may include a TCI state configuration that is valid when a target antenna port is a PDSCH DMRS.

TABLE 10

| Valid | | | DL RS 2 | qcl-Type2 |
|---|---|---|---|---|
| TCI state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

In a representative QCL configuration method according to [Table 6] to [Table 10] above, a target antenna port and reference antenna port of each stage are configured to be “SSB”→“TRS”→“CSI-RS for CSI, CSI-RS for BM, PDCCH DMRS, or PDSCH DMRS” and are operated. The method may enable assisting a reception operation of a terminal by associating statistical characteristics measurable by an SSB and a TRS with respective antenna ports.

According to an embodiment, an operation in which a terminal uses a default beam (TCI or QCL) when receiving a single TRP-based PDSCH is described. When a terminal receives a PDCCH from a base station, until reception and decoding of the PDCCH is ended, the terminal may be unable to know whether scheduling information is included in the PDCCH and to know scheduling information if the scheduling information is included. Therefore, the terminal may receive and store, in a buffer, a downlink signal by using a default beam, before passage of a beam change time reported as a terminal capability to the base station. Therefore, if the base station is to schedule, for the terminal, a PDSCH earlier than a time point indicated by a terminal capability value related to a reception beam change time reported by the terminal, the base station may transmit the PDSCH to the terminal by using a default beam assumed by the terminal.

According to an embodiment, factors determining a default beam operation of a terminal may include tci-PresentInDCI which is higher layer signaling for each control resource set and notifies of whether a TCI field exists in DCI, a scheduling offset which is an interval between a PDCCH containing scheduling information and a PDSCH scheduled by the PDCCH, and timeDurationForQCL which is a terminal capability representing a time taken for the terminal to perform beam change to receive a PDSCH. For example, a default beam operation of a terminal may be determined based on tci-PresentInDCI which is higher layer signaling for each control resource set and notifies of whether a TCI field exists in DCI, a scheduling offset which is an interval between a PDCCH containing scheduling information and a PDSCH scheduled by the PDCCH, and/or timeDurationForQCL which is a terminal capability representing a time taken for the terminal to perform beam change to receive a PDSCH.

According to an embodiment, a detailed description and information for timeDurationForQCL may be given by referring to [Table 11] and [Table 12] below.

TABLE 11

| | | Prerequisite | | | | | |
|---|---|---|---|---|---|---|---|
| Feature | | feature | Field name in | Parent IE in | Need of FDD/TDD | Need of FR1/FR2 | Mandatory/ |
| group | Components | groups | TS 38.331 | TS 38.331 | differentiation | differentiation | Optional |
| PDSCH | 9) Time | 2-1 | timeDurationForQCL | FeatureSetDownlink | No | Applicable | Mandatory |
| beam | duration | | | | | only to FR2 | with |
| switching | (definition | | | | | | capability |
| | follows | | | | | | signalling |
| | section | | | | | | for FR2 |
| | 5.1.5 in | | | | | | Candidate |
| | TS 38.214), | | | | | | value set |
| | Xi, to | | | | | | for X1 is |
| | determine | | | | | | {7, 14, 28}, |
| | and apply | | | | | | Candidate |
| | spatial QCL | | | | | | value set |
| | information for | | | | | | for X2, |
| | corresponding | | | | | | {14, 28} |
| | PDSCH | | | | | | |
| | reception. | | | | | | |
| | Time duration | | | | | | |
| | is defined | | | | | | |
| | counting from | | | | | | |
| | end of last | | | | | | |
| | symbol of | | | | | | |
| | PDCCH to | | | | | | |
| | beginning of | | | | | | |
| | the first | | | | | | |
| | symbol of | | | | | | |
| | PDSCH. | | | | | | |
| | Xi is the | | | | | | |
| | number of OFDM | | | | | | |
| | symbols, I is | | | | | | |
| | the index of | | | | | | |
| | SCS, l = 1, 2, | | | | | | |
| | corresponding | | | | | | |
| | to 60,120 | | | | | | |
| | kHz SCS. | | | | | | |

TABLE 12

| | | | FDD- | FR1- |
|---|---|---|---|---|
| | | | TDD | FR2 |
| Definitions for parameters | Per | M | DIFF | DIFF |
| timeDurationForQCL | FS | Yes | N/A | FR2 |
| Defines minimum number of OFDM symbols | | | | only |
| required by the UE to perform PDCCH | | | | |
| reception and applying spatial QCL | | | | |
| information received in DCI for PDSCH | | | | |
| processing as described in TS 38.214 clause | | | | |
| 5.1.5. UE shall indicate one value of the | | | | |
| minimum number of OFDM symbols per each | | | | |
| subcarrier spacing of 60 kHz and 120 kHz. | | | | |

A default beam operation is described in detail individually for a case where tci-PresentInDCI is not configured and a scheduling offset is longer than a reference time, a case where a scheduling offset is shorter than a reference time regardless of whether tci-PresentInDCI is configured, and a case where a scheduling offset is shorter than a reference time regardless of whether tci-PresentInDCI is configured and a corresponding PDSCH and another control resource set overlap with each other.

For example, described is a default beam operation for a case where the higher layer signaling tci-PresentInDCI is not configured in a control resource set and a scheduling offset between a PDCCH and a PDSCH is longer than timeDurationForQCL that is a reference time described above.

If the higher layer signaling tci-PresentInDCI is not configured in a control resource set in which a PDCCH scheduling a PDSCH is transmitted, a TCI state is configured or activated in the control resource set, and a scheduling offset between the PDCCH and the PDSCH is longer than timeDurationForQCL that is a reference time described above, a terminal is unable to obtain a TCI state as scheduling information for the PDSCH, and thus the terminal may, when receiving the PDSCH, use a configuration of the control resource set including the PDCCH scheduling the PDSCH, the activated TCI state, and/or a QCL assumption of the control resource set. In an example, the terminal may determine a default beam, based on a configuration of the control resource set including the PDCCH, the activated TCI state, and/or the QCL of the control resource set.

For example, described is a default beam operation for a case where a scheduling offset between a PDCCH and a PDSCH is shorter than timeDurationForQCL that is a reference time described above, regardless of whether the higher layer signaling tci-PresentInDCI is configured.

If the higher layer signaling tci-PresentInDCI is configured or is not configured in a control resource set in which a PDCCH scheduling a PDSCH is transmitted (i.e., regardless of whether tci-PresentInDCI is configured), and a scheduling offset between the PDCCH and the PDSCH is shorter than timeDurationForQCL that is a reference time described above, a terminal may, when receiving the PDSCH, use a TCI state configured or activated for a control resource set, among at least one control resource set monitorable in a slot closest to the PDSCH, having the lowest control resource set index, or a QCL assumption of the control resource set having the lowest index. In an example, the terminal may determine a default beam, based on a TCI state configured (or activated) for a control resource set having the lowest control resource set index among at least one control resource set monitorable in a slot closest to the PDSCH, and/or a QCL assumption of the control resource set having the lowest index.

For example, described is a default beam operation for a case where a scheduling offset between a PDCCH and a PDSCH is shorter than timeDurationForQCL that is a reference time described above, regardless of whether the higher layer signaling tci-PresentInDCI is configured, and the PDSCH and another control resource set overlap with each other.

If the higher layer signaling tci-PresentInDCI is configured or is not configured in a control resource set in which a PDCCH scheduling a PDSCH is transmitted (i.e., regardless of whether tci-PresentInDCI is configured), and a scheduling offset between the PDCCH and the PDSCH is shorter than timeDurationForQCL that is a reference time described above, a terminal may, when receiving the PDSCH, use a TCI state configured (or activated) for a control resource set having the lowest control resource set index among at least one control resource set monitorable in a slot closest to the PDSCH, and/or a QCL assumption of the control resource set having the lowest index. The terminal may, when receiving the PDSCH, determine a default beam, based on a TCI state configured (or activated) for a control resource set having the lowest control resource set index among at least one control resource set monitorable in a slot closest to the PDSCH, and/or a QCL assumption of the control resource set having the lowest index.

If QCL-TypeD applied to a PDSCH DMRS is different from QCL-TypeD applied to a DMRS of a PDCCH overlapping with a corresponding PDSCH on at least one OFDM symbol, a terminal may use QCL-TypeD of an overlapping control resource set to receive the PDSCH and the control resource set. The operation of using QCL-TypeD of the overlapping control resource set to receive the PDSCH and the control resource set may be applicable even in the same carrier or different carriers in a band (intra-band CA).

According to an embodiment, an operation in which a terminal uses a default beam (default beam, default TCI, or default QCL) when receiving a multi-TRP-based PDSCH is described.

According to an embodiment, when a terminal receives a PDCCH from a base station, until reception and decoding of the PDCCH is ended, the terminal is unable to know whether scheduling information is included in the PDCCH, and until reception and decoding of the PDCCH is ended, the terminal is unable to know scheduling information if the scheduling information is included. Therefore, the terminal may receive and store, in a buffer, a downlink signal by using a default beam, before passage of a beam change time reported as a terminal capability to the base station. Therefore, if the base station is to schedule, for the terminal, a PDSCH earlier than a time point indicated by a terminal capability value related to a reception beam change time reported by the terminal, the base station may transmit the PDSCH to the terminal by using a default beam assumed by the terminal.

According to an embodiment, tci-PresentInDCI which is higher layer signaling for each control resource set and notifies of whether a TCI field exists in DCI, a scheduling offset which is an interval between a PDCCH containing scheduling information and a PDSCH scheduled by the PDCCH, and/or timeDurationForQCL which is a terminal capability representing a time taken for a terminal to perform beam change to receive a PDSCH may be considered as factors determining a default beam operation of the terminal.

According to an embodiment, a detailed description and information for timeDurationForQCL may be given with reference to [Table 11] and [Table 12] above.

According to an embodiment, a terminal may define a terminal capability related to a default beam operation when a PDSCH is received via multiple TRPs. For example, a terminal may, when receiving a PDSCH transmitted via multi-DCI-based multiple TRPs, report, to a base station, defaultQCL-PerCORESETPoolIndex-r16 that is a terminal capability supporting a default beam operation for each of different values of CORESETPoolIndex. For example, a terminal may, when receiving a PDSCH transmitted via single-DCI-based multiple TRPs, report, to a base station, defaultQCL-TwoTCI-r16 that is a terminal capability supporting a default beam operation using two beams.

A terminal having reported the two terminal capabilities related to a default beam operation when a PDSCH is received via multiple TRPs may be required to report simultaneousReceptionDiffTypeD-r16 that is a terminal capability implying that the terminal is able to simultaneously receive reference signals corresponding to two different values of QCL Type-D. For example, only a terminal having reported the terminal capability simultaneousReceptionDiffTypeD-r16 may report the terminal capability defaultQCL-PerCORESETPoolIndex-r16 or defaultQCL-TwoTCI-r16. Specific information about the terminal capabilities defaultQCL-PerCORESETPoolIndex-r16, defaultQCL-TwoTCI-r16, and simultaneousReceptionDiffTypeD-r16 may be given by referring to [Table 13] and [Table 14] below. For example, the information about the terminal capabilities defaultQCL-PerCORESETPoolIndex-r16, defaultQCL-TwoTCI-r16, and simultaneousReceptionDiffTypeD-r16 may include configurations or information elements (IEs) of [Table 13] and [Table 14].

TABLE 13

| | | | | | | Need of | Need of | |
|---|---|---|---|---|---|---|---|---|
| | | | Prerequisite | Field | | FDD/TDD | FR1/FR2 | |
| | Feature | | feature | name in | | differen- | differen- | Mandatory/ |
| Index | group | Components | groups | TS 38.331 | Type | tiation | tiation | Optional |
| 16-2a-6 | Default QCL | Support of | 16-2a and | defaultQCL- | Per | No | FR2 only | Optional with |
| | enhancement | default QCL | 16-2c | PerCORESETPoolIndex-r16 | band | | | capability |
| | for multi- | assumption per | | | | | | signalling |
| | DCI based | CORESETPoolIndex | | | | | | |
| | multi-TRP | | | | | | | |
| 16-2b-0 | Two default | Support of | 16-2c | defaultQCL-TwoTCI-r16 | Per | No | FR2 only | Optional with |
| | beams for | default QCL | | | band | | | capability |
| | single-DCI | assumption | | | | | | signalling |
| | based multi- | with two | | | | | | |
| | TRP | TCI states | | | | | | |
| 16-2c | Simultaneous | Supports | | simultaneousRecep- | Per | No | FR2 only | Optional with |
| | reception | simultaneous | | tionDiffTypeD-r16 | band | | | capability |
| | with | reception | | | | | | signalling |
| | different | with | | | | | | |
| | Type-D | different QCL | | | | | | |
| | | Type-D RSs. | | | | | | |

TABLE 14

| | | | FDD- | FR1- |
|---|---|---|---|---|
| | | | TDD | FR2 |
| Definitions for parameters | Per | M | DIFF | DIFF |
| defaultQCL-PerCORESETPoolIndex-r16 | Band | No | N/A | FR2 |
| Indicates whether the UE supports default | | | | only |
| QCL assumption per CORESET pool index | | | | |
| using multi-DCI based multi-TRP. The UE | | | | |
| that indicates support of this feature | | | | |
| shall support multiDCI-MultiTRP-r16 and | | | | |
| simultaneousReceptionDiffTypeD-r16. | | | | |
| defaultQCL-TwoTCI-r16 | Band | No | N/A | FR2 |
| Indicates whether the UE supports default | | | | only |
| QCL assumption with two TCI states using | | | | |
| single-DCI based multi-TRP. The UE can | | | | |
| include this field only if | | | | |
| simultaneousReceptionDiffTypeD-r16 is | | | | |
| present. Otherwise, the UE does not | | | | |
| include this field. | | | | |
| simultaneousReceptionDiffTypeD-r16 | Band | No | N/A | FR2 |
| Indicates whether the UE supports | | | | only |
| simultaneous reception with different | | | | |
| QCL Type D reference signal as | | | | |
| specified in TS38.213. | | | | |

According to an embodiment, hereinafter, described is a default beam operation of a terminal in which, in a case where a scheduling offset is shorter than a reference time regardless of whether tci-PresentInDCI is configured, the terminal has reported simultaneousReceptionDiffTypeD-r16, has reported at least one of defaultQCL-PerCORESETPoolIndex-r16 and defaultQCL-TwoTCI-r16, and operates based on multi-DCI or single-DCI-based multiple TRPs.

If the higher layer signaling tci-PresentInDCI and tci-PresentInDCI-1-2 are configured or not configured for a terminal, a scheduling offset between a PDCCH and a PDSCH is shorter than timeDurationForQCL that is a reference time descried above, the terminal is in an RRC-connected mode, and at least one TCI state configured by higher layer signaling in a corresponding serving cell includes QCL-TypeD as qcl-Type information,—If the higher layer signaling enableDefaultTCI-StatePerCoresetPoolIndex is configured for the terminal, and different values of the higher layer signaling CORESETPoolIndex are configured for different control resource sets for the terminal, that is, the terminal receives a PDSCH by operating as multi-DCI multi-TRPs,
The terminal may, when receiving a PDSCH, apply, to a PDSCH DMRS, a TCI state configured or activated for a control resource set which has the lowest index and is monitorable in a slot closest to the PDSCH among control resource sets having the same value as a value of the higher layer signaling CORESETPoolIndex configured for a control resource set including a PDCCH scheduling the PDSCH, and/or a QCL assumption of the control resource set having the lowest index.
If QCL-TypeD applied to the PDSCH DMRS is different from QCL-TypeD applied to a DMRS of a PDCCH overlapping with the PDSCH on at least one OFDM symbol, and the PDCCH and the PDSCH are connected to the same value of CORESETPoolIndex (i.e., a value of the higher layer signaling CORESETPoolIndex configured for a control resource set in which a PDCCH including scheduling information for the PDSCH is transmitted is equal to a value of the higher layer signaling CORESETPoolIndex configured for a control resource set in which a PDCCH overlapping with the PDSCH is transmitted), the terminal may prioritize PDCCH reception and may perform the same operation even for intra-band CA (i.e., if the PDSCH and the overlapping control resource set exist on different subcarriers). —If the higher layer signaling enableTwoDefaultTCI-States is configured for the terminal, and two TCI states are activated in at least one codepoint of a TCI state field in DCI,
The terminal may, when receiving a PDSCH, apply, to a PDSCH DMRS, two TCI states corresponding to a codepoint having the lowest index among codepoints in which two TCI states are activated among codepoints in the TCI state field in the DCI.
If tdmSchemeA is configured for the terminal as a value of the higher layer signaling repetitionScheme or the higher layer signaling repetitionNumber is configured therefor, and a scheduling offset between a PDCCH and a first PDSCH reception occasion among multiple PDSCH reception occasions is shorter than timeDurationForQCL, the terminal may use two TCI states corresponding to a codepoint having the lowest index among codepoints in which two TCI states are activated among codepoints in the TCI state field in the DCI, to apply same to the PDSCH reception occasions repeatedly received on time resources. The terminal may use the activated TCI state codepoint for a slot including the first PDSCH reception occasion. If cyclicMapping is configured for the terminal through higher layer signaling, the terminal may apply first and second TCI states among the two TCI states corresponding to the codepoint having the lowest index to the first PDSCH reception occasion and a second PDSCH reception occasion, and may identically apply the same application method to subsequent PDSCH reception occasions. If the higher layer signaling sequentialMapping is configured for the terminal, the terminal may apply a first TCI state among the two TCI states corresponding to the codepoint having the lowest index to the first PDSCH reception occasion and a second PDSCH reception occasion, and may apply a second TCI state to third and fourth PDSCH reception occasions. Similarly, the terminal may identically apply the same application method to subsequent PDSCH reception occasions.
If all values of QCL-TypeD applied to the PDSCH DMRS (e.g., QCL-TypeD information in two TCI states indicated by a codepoint which has the lowest index and in which two TCI states are activated among codepoints of a TCI state field in a PDCCH) are different from QCL-TypeD applied to a DMRS of a PDCCH overlapping with the PDSCH on at least one OFDM symbol, the terminal may prioritize PDCCH reception and may perform the same operation even for intra-band CA (i.e., if the PDSCH and an overlapping control resource set exist on different subcarriers).

According to an embodiment, an operation in which a terminal uses a default beam (default beam, default TCI, or default QCL) when receiving an SFN PDSCH is described.

According to an embodiment, when a terminal receives a PDCCH from a base station, until reception and decoding of the PDCCH is ended, the terminal is unable to know whether scheduling information is included in the PDCCH and is unable to know scheduling information if the scheduling information is included. Therefore, the terminal may receive and store, in a buffer, a downlink signal by using a default beam, before passage of a beam change time reported as a terminal capability to the base station. Therefore, if the base station is to schedule, for the terminal, a PDSCH earlier than a time point indicated by a terminal capability value related to a reception beam change time reported by the terminal, the base station may transmit the PDSCH to the terminal by using a default beam assumed by the terminal.

According to an embodiment, tci-PresentInDCI which is higher layer signaling for each control resource set and notifies of whether a TCI field exists in DCI, a scheduling offset which is an interval between a PDCCH containing scheduling information and a PDSCH scheduled by the PDCCH, and/or timeDurationForQCL which is a terminal capability representing a time taken for a terminal to perform beam change to receive a PDSCH may be considered as factors determining a default beam operation of the terminal. For example, a default beam of a terminal may be determined based on tci-PresentInDCI which is higher layer signaling for each control resource set and notifies of whether a TCI field exists in DCI, a scheduling offset which is an interval between a PDCCH containing scheduling information and a PDSCH scheduled by the PDCCH, and/or timeDurationForQCL which is a terminal capability representing a time taken for the terminal to perform beam change to receive a PDSCH.

According to an embodiment, a description and information for timeDurationForQCL may be given by referring to [Table 11] and [Table 12] described above. For example, timeDurationForQCL may include at least some of configurations or IEs included in [Table 11] and [Table 12].

Additionally, a terminal may define or report a terminal capability related to a default beam operation when an SFN PDSCH is received. For example, a terminal may, when receiving an SFN PDSCH, report, to a base station, sfn-DefaultDL-BeamSetup-r17 that is a terminal capability supporting a default beam operation when an SFN PDSCH is received. In addition, when a terminal has reported sfn-DefaultDL-BeamSetup-r17 described above to a base station, the terminal may be required to report, to the base station, sfn-SchemeA-r17 or sfn-SchemeB-r17 that is a terminal capability implying that the terminal is able to support an SFN PDSCH. That is, only a terminal having reported the terminal capability sfn-SchemeA-r17 or sfn-SchemeB-r17 may report the terminal capability sfn-DefaultDL-BeamSetup-r17 to a base station. Specific information about the terminal capabilities sfn-DefaultDL-BeamSetup-r17, sfn-SchemeA-r17, and sfn-SchemeB-r17 may be given by referring to [Table 15] and [Table 16] below. For example, the information about the terminal capabilities sfn-DefaultDL-BeamSetup-r17, sfn-SchemeA-r17, and sfn-SchemeB-r17 may include at least some of configurations or IEs included in [Table 15] and/or [Table 16].

TABLE 15

| | | | Prerequisite | Field | | | | |
|---|---|---|---|---|---|---|---|---|
| | Feature | | feature | name in | | Need of FDD/TDD | Need of FR1/FR2 | Mandatory/ |
| Index | group | Components | groups | TS 38.331 | Type | differentiation | differentiation | Optional |
| 23- | SFN | 1. Support | | sfn- | Per | No | No | Optional with |
| 6-1 | scheme A | of SFN | | SchemeA- | FS | | | capability |
| | (scheme 1) | scheme A | | r17 | | | | signalling |
| | for PDSCH | for PDCCH | | | | | | |
| | and PDCCH | scheduling | | | | | | |
| | | SFN | | | | | | |
| | | Scheme A | | | | | | |
| | | PDSCH | | | | | | |
| 23- | SFN | 1. Support | | sfn- | Per | No | No | Optional with |
| 6-2 | scheme B | of SFN | | SchemeB- | FS | | | capability |
| | (TRP based | scheme B | | r17 | | | | signalling |
| | pre- | for PDCCH | | | | | | |
| | compensation) | scheduling | | | | | | |
| | for PDSCH | SFN | | | | | | |
| | and PDCCH | Scheme B | | | | | | |
| | | PDSCH | | | | | | |
| 23- | Default DL | 1. Support | 23-6-1 or | sfn- | Per | No | Note: | Optional with |
| 6-4 | beam setup | of PDSCH | 23-6-2 | DefaultDL- | band | | FR2 only | capability |
| | for SFN | reception | | BeamSetup- | | | for component 1 | signalling |
| | | using | | r17 | | | and 3 only | |
| | | default | | | | | | |
| | | beam for | | | | | | |
| | | Rel-17 | | | | | | |
| | | enhanced | | | | | | |
| | | SFN scheme | | | | | | |
| | | when PDSCH | | | | | | |
| | | is scheduled | | | | | | |
| | | with offset | | | | | | |
| | | less than | | | | | | |
| | | threshold | | | | | | |
| | | 2. Support | | | | | | |
| | | PDSCH | | | | | | |
| | | reception | | | | | | |
| | | using | | | | | | |
| | | default | | | | | | |
| | | beam for | | | | | | |
| | | Rel-17 | | | | | | |
| | | enhanced | | | | | | |
| | | SFN scheme | | | | | | |
| | | when TCI | | | | | | |
| | | field is not | | | | | | |
| | | present in | | | | | | |
| | | DCI format | | | | | | |
| | | 1_0/1_1/1_2 | | | | | | |
| | | when PDSCH | | | | | | |
| | | is scheduled | | | | | | |
| | | with offset | | | | | | |
| | | equal or | | | | | | |
| | | larger than | | | | | | |
| | | the | | | | | | |
| | | threshold, | | | | | | |
| | | if applicable | | | | | | |
| | | 3. Support | | | | | | |
| | | aperiodic | | | | | | |
| | | CSI-RS | | | | | | |
| | | reception | | | | | | |
| | | using | | | | | | |
| | | default | | | | | | |
| | | beam for | | | | | | |
| | | Rel-17 | | | | | | |
| | | enhanced SFN | | | | | | |
| | | scheme when | | | | | | |
| | | scheduling | | | | | | |
| | | offset is | | | | | | |
| | | less than | | | | | | |
| | | threshold | | | | | | |

TABLE 16

| | | | FDD- | FR1- |
|---|---|---|---|---|
| | | | TDD | FR2 |
| Definitions for parameters | Per | M | DIFF | DIFF |
| sfn-SchemeA-r17 | FS | No | N/A | N/A |
| Indicates whether the UE supports SFN | | | | |
| scheme A for PDCCH scheduling SFN | | | | |
| Scheme A PDSCH. | | | | |
| sfn-SchemeB-r17 | FS | No | N/A | N/A |
| Indicates whether the UE supports SFN | | | | |
| scheme B for PDCCH scheduling SFN | | | | |
| Scheme B PDSCH. | | | | |
| sfn-DefaultDL-BeamSetup-r17 | Band | No | N/A | N/A |
| Indicates whether the UE supports the | | | | |
| following features: | | | | |
| For FR2 only, PDSCH reception using | | | | |
| default beam for enhanced SFN scheme | | | | |
| when PDSCH is scheduled with offset | | | | |
| less than threshold. | | | | |
| For FR1 and FR2, PDSCH reception using | | | | |
| default beam for enhanced SFN scheme | | | | |
| when TCI field is not present in DCI | | | | |
| format 1_0/1_1/1_2 when PDSCH is | | | | |
| scheduled with offset equal or larger | | | | |
| than the threshold, if applicable. | | | | |
| For FR2 only, aperiodic CSI-RS reception | | | | |
| using default beam for enhanced SFN scheme | | | | |
| when scheduling offset is less than threshold. | | | | |
| The UE indicating support of this feature | | | | |
| shall also indicate sfn-schemeA-r17 or | | | | |
| sfn-schemeB-r17. | | | | |

According to an embodiment, a default beam operation of a terminal when an SFN PDSCH is received is described for a case where a scheduling offset is shorter than a reference time regardless of whether tci-PresentInDCI is configured, and the terminal has reported at least one of sfn-SchemeA-r17 or sfn-SchemeB-r17 described above and has reported sfn-DefaultDL-BeamSetup-r17 described above.

If the higher layer signaling sfnSchemePdcch and sfnSchemePdsch are both configured for a terminal and scheduling for PDSCH reception is indicated to the terminal as one of DCI format 1_0, 1_1, or 1_2, and/or if a scheduling offset between a PDCCH and a PDSCH is equal or longer than timeDurationForQCL that is a reference time described above, —If the terminal has reported sfn-DefaultDL-BeamSetup-r17 and thus PDSCH scheduling using DCI is possible without a TCI state field, the terminal may receive a scheduled PDSCH by using a TCI state activated in a control resource set having been used when receiving DCI scheduling the PDSCH, and the terminal may use the activated TCI state when receiving the scheduled PDSCH, regardless of the number of TCI states activated in the control resource set. If the terminal does not support sfn-SchemeA-DynamicSwitching-r17 or sfn-SchemeB-DynamicSwitching-r17 and thus has not reported same to a base station as a terminal capability, the terminal may expect or identify that two TCI states are activated in the control resource set. —If the terminal has not reported sfn-DefaultDL-BeamSetup-r17 and thus PDSCH scheduling using DCI is impossible without a TCI state field, the terminal may expect or identify that a TCI state field needs to be included in DCI formats 1_1 and 1_2.

If the higher layer signaling sfnSchemePdsch is configured for the terminal and the higher layer signaling sfnSchemePdcch is not configured therefor, and/or if the terminal is scheduled through DCI formats 1_1 and 1_2 and a scheduling offset between a PDCCH and a PDSCH is equal or longer than timeDurationForQCL that is a reference time described above, the terminal may expect or identify that a TCI state field needs to be included in DCI formats 1_1 and 1_2.

With respect to a PDSCH scheduled through DCI format 1_0, 1_1, or 1_2, if the higher layer signaling sfnSchemePdcch is configured for a terminal as a value of sfnSchemeA, the higher layer signaling sfnSchemePdsch is not configured therefor, there is no codepoint having two TCI states among codepoints of a TCI state field, a scheduling offset between a PDCCH and the PDSCH is equal or longer than timeDurationForQCL that is a reference time described above, and two TCI states are activated in a control resource set in which DCI having scheduling the PDSCH is transmitted, the terminal may receive the PDSCH by using a first TCI state of the control resource set.

If the higher layer signaling tci-PresentInDCI and tci-PresentInDCI-1-2 are configured or not configured for a terminal, a scheduling offset between a PDCCH and a PDSCH is shorter than timeDurationForQCL that is a reference time descried above, the terminal is in an RRC-connected mode, and at least one TCI state configured by higher layer signaling in a serving cell includes QCL-TypeD as qcl-Type information,

If the higher layer signaling sfnSchemePdsch is not configured for the terminal, the higher layer signaling sfnSchemePdcch is configured for the terminal as a value of sfnSchemeA, there is no codepoint having two TCI states among codepoints of a TCI state field, and two TCI states are indicated to or activated in a control resource set having the lowest index and existing in the latest slot, the terminal may receive a PDSCH by using a first TCI state among two TCI states of a control resource set in which DCI indicating corresponding PDSCH scheduling information is transmitted.

If there is a control resource set overlapping with the PDSCH in time, and a default beam of the PDSCH and a transmission beam of the overlapping control resource set are different from each other, the terminal may use the transmission beam of the overlapping control resource set to receive the PDSCH and the control resource set. The operation of using the transmission beam of the overlapping control resource set to receive the PDSCH and the control resource set may be applicable even in the same carrier or different carriers in a band (intra-band CA). —If QCL-TypeD applied to a PDSCH DMRS is different from QCL-TypeD applied to a DMRS of a PDCCH overlapping with the PDSCH on at least one OFDM symbol, and a control resource set in which the overlapping PDCCH is transmitted has one TCI state, the terminal may use QCL-TypeD of the overlapping control resource set to receive the PDSCH and the control resource set. The operation of using QCL-TypeD of the overlapping control resource set to receive the PDSCH and the control resource set may be applicable even in the same carrier or different carriers in a band (intra-band CA).

Hereinafter, a single TCI state indication and activation method based on a unified TCI scheme is described. The unified TCI scheme may be referred to as a scheme of integrally managing transmission and reception beam management schemes through a TCI state, the transmission and reception beam management schemes having been classified as a TCI state scheme used in downlink reception of a terminal and a spatial relation info scheme used in uplink transmission in conventional Rel-15 and 16. Therefore, in a case where a terminal receives an indication from a base station, based on the unified TCI scheme, the terminal may perform beam management even for uplink transmission by using a TCI state. If the higher layer signaling TCI-State having the higher layer signaling tci-stateId-r17 is configured for a terminal by a base station, the terminal may perform an operation based on the unified TCI scheme by using TCI-State. For example, TCI-State may exist in two types of a joint TCI state or a separate TCI state.

According to an embodiment, a first type may be a joint TCI state, and all TCI states to be applied to uplink transmission and downlink reception may be indicated to (or configured for) a terminal by a base station through one value of TCI-State. If joint TCI state-based TCI-state is indicated to (or configured for) the terminal, a parameter to be used in downlink channel estimation may be indicated to (or configured for) the terminal by using an RS corresponding to qcl-Type1 in the indicated joint TCI state-based TCI-state, and a parameter to be used as a downlink reception beam or reception filter may be indicated (or configured) thereto by using an RS corresponding to qcl-Type2. If joint TCI state-based TCI-state is indicated to (or configured for) the terminal, a parameter to be used as an uplink transmission beam or transmission filter may be indicated to (or configured for) the terminal by using an RS corresponding to qcl-Type2 in a corresponding joint DL/UL TCI state-based TCI-state. If a joint TCI state is indicated to the terminal, the terminal may apply the same beam to uplink transmission and downlink reception.

According to an embodiment, a second type may be a separate TCI state, and a UL TCI state to be applied to uplink transmission and a DL TCI state to be applied to downlink reception may be individually indicated to (or configured for) a terminal by a base station. If a UL TCI state is indicated to (or configured for) the terminal, a parameter to be used as an uplink transmission beam or transmission filter may be indicated to (or configured for) the terminal by using a reference RS or a source RS configured in the UL TCI state. If a DL TCI state is indicated to (or configured for) the terminal, a parameter to be used in downlink channel estimation may be indicated to (or configured for) the terminal by using an RS corresponding to qcl-Type 1 in the DL TCI state, and a parameter to be used as a downlink reception beam or reception filter may be indicated (or configured) thereto by using an RS corresponding to qcl-Type2.

If a DL TCI state and a UL TCI state are indicated to (or configured for) the terminal together, a parameter to be used as an uplink transmission beam or transmission filter may be indicated to (or configured for) the terminal by using a reference RS or a source RS configured in the indicated UL TCI state, a parameter to be used in downlink channel estimation may be indicated to the terminal by using an RS corresponding to qcl-Type1 in the DL TCI state, and a parameter to be used as a downlink reception beam or reception filter may be indicated thereto using an RS corresponding to qcl-Type2. If the reference RSs or source RSs configured in the DL TCI state and UL TCI state indicated to the terminal are different from each other, the terminal may apply individual beams to uplink transmission and downlink reception, based on the DL TCI state and UL TCI state indicated to the terminal.

According to an embodiment, a maximum of 128 values of joint TCI state may be configured to a terminal by a base station through higher layer signaling by each particular bandwidth part in a particular cell. A maximum of 64 or 128 DL TCI states, each of which is a separate TCI state, may be configured through higher layer signaling, based on a terminal capability report by each particular bandwidth part in a particular cell. A DL TCI state of a separate TCI state and a joint TCI state may use the same higher layer signaling structure. For example, if 128 joint TCI states are configured and 64 DL TCI states of separate TCI states are configured, the 64 DL TCI states may be included in the 128 joint TCI states.

According to an embodiment, a maximum of 32 or 64 UL TCI states, each of which is a separate TCI state, may be configured through higher layer signaling, based on a terminal capability report by each particular bandwidth part in a particular cell. Similar to the relation between a DL TCI state of a separate TCI state and a joint TCI state, a UL TCI state of a separate TCI state and a joint TCI state may also use the same higher layer signaling structure. A UL TCI state of separate TCI may use a higher layer signaling structure different from that of a joint TCI state and a DL TCI state of a separate TCI state.

As described above, using different or identical higher layer signaling structures may be defined in a specification. Using different or identical higher layer signaling structures may be determined through another higher layer signaling that is configured by a base station, based on a terminal capability report including information on a usage scheme which a terminal is able to support among two types of usage schemes.

According to an embodiment, a terminal may receive a transmission/reception beam-related indication in a unified TCI scheme by using one scheme among a joint TCI state and a separate TCI state configured by a base station. For example, a transmission/reception beam-related configuration may be received by or configured for a terminal in a unified TCI scheme by using one scheme among a joint TCI state and a separate TCI state configured by a base station.

According to an embodiment, whether to use one of a joint TCI state and a separate TCI state may be configured for a terminal by a base station through higher layer signaling.

According to an embodiment, a terminal may receive a transmission/reception beam-related indication through higher layer signaling by using one scheme selected from among a joint TCI state and a separate TCI state, and a transmission/reception beam-related indication method of a base station may be classified as two methods including a MAC-CE-based indication method and a MAC-CE-based activation and DCI-based indication method.

In a case where a terminal receives a transmission/reception beam-related indication through higher layer signaling by using a joint TCI state scheme, the terminal may receive a MAC-CE indicating a joint TCI state from a base station to perform a transmission/reception beam application operation, and the base station may schedule reception of a PDSCH including the MAC-CE to the terminal through a PDCCH. If a MAC-CE includes one joint TCI state, the terminal may determine an uplink transmission beam or transmission filter and a downlink reception beam or reception filter by using the indicated joint TCI state after 3 ms from transmission of a PUCCH including hybrid automatic repeat request (HARQ)-acknowledgement (ACK) information indicating whether reception of a PDSCH including the MAC-CE is successful. If a MAC-CE includes two or more joint TCI states, the terminal may identify that the multiple joint TCI states indicated by the MAC-CE correspond to respective codepoints of a TCI state field of DCI format 1_1 or 1_2 after 3 ms from transmission of a PUCCH including HARQ-ACK information indicating whether reception of a PDSCH including the MAC-CE is successful, and may activate the indicated joint TCI states. Thereafter, the terminal may receive DCI format 1_1 or 1_2 to apply one joint TCI state indicated by a TCI state field in the DCI to uplink transmission and downlink reception beams. DCI format 1_1 or 12 may include downlink data channel scheduling information (with DL assignment) or not include same (without DL assignment).

In a case where a terminal receives a transmission/reception beam-related indication through higher layer signaling by using a separate TCI state scheme, the terminal may receive a MAC-CE indicating a separate TCI state from a base station to perform a transmission/reception beam application operation. The base station may schedule reception of a PDSCH including the MAC-CE to the terminal through a PDCCH. If a MAC-CE includes one separate TCI state set, the terminal may determine an uplink transmission beam or transmission filter and a downlink reception beam or reception filter by using separate TCI states included in the indicated separate TCI state set after 3 ms from transmission of a PUCCH including HARQ-ACK information indicating whether reception of a corresponding PDSCH is successful. The separate TCI state set may be referred to as single or multiple separate TCI states which one codepoint of a TCI state field in DCI format 1_1 or 1_2 is able to have. For example, one separate TCI state set may include one DL TCI state, include one UL TCI state, or include one DL TCI state and one UL TCI state.

If a MAC-CE includes two or more separate TCI state sets, the terminal may identify that the multiple separate TCI state sets indicated by the MAC-CE correspond to respective codepoints of a TCI state field of DCI format 1_1 or 1_2 after 3 ms from transmission of a PUCCH including HARQ-ACK information indicating whether reception of a PDSCH is successful, and may activate the indicated separate TCI state sets. Each codepoint of the TCI state field of DCI format 1_1 or 1_2 may indicate one DL TCI state, indicate one UL TCI state, or indicate one DL TCI state and one UL TCI state.

The terminal may receive DCI format 1_1 or 12 to apply a separate TCI state set indicated by a TCI state field in the DCI to uplink transmission and downlink reception beams. DCI format 1_1 or 1_2 may include downlink data channel scheduling information (with DL assignment) or not include same (without DL assignment).

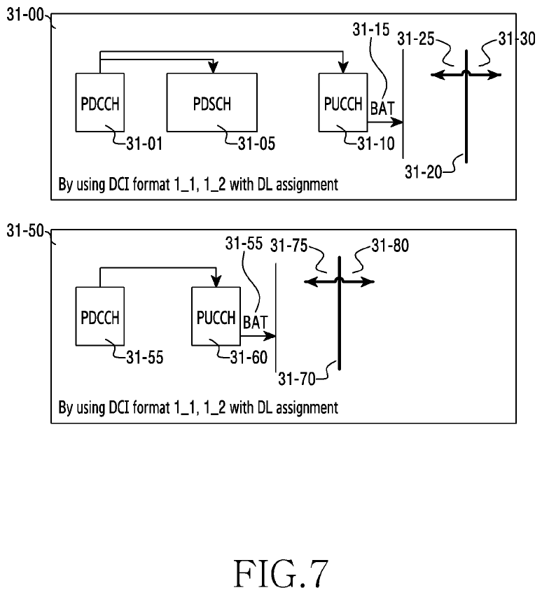

FIG. 7 illustrates a beam application time which may be considered when a unified TCI scheme is used in a wireless communication system according to an embodiment of the disclosure.

Referring to FIG. 7, a terminal may receive, from a base station, DCI format 1_1 or 1_2 including downlink data channel scheduling information (with DL assignment) or not including downlink data channel scheduling information (without DL assignment), and the terminal may apply one joint TCI state or one separate TCI state set indicated by a TCI state field in the DCI to uplink transmission and downlink reception beams. —DCI format 1_1 or 1_2 with DL assignment (31-00): If a terminal receives, from a base station, DCI format 1_1 or 1_2 including downlink data channel scheduling information (31-01) so that one joint TCI state or one separate TCI state set based on a unified TCI scheme is indicated, the terminal may receive a PDSCH scheduled based on the received DCI (31-05), and transmit a PUCCH including a HARQ-ACK indicating whether reception of the DCI and the PDSCH is successful (31-10). The HARQ-ACK may include whether reception is successful, for both the DCI and the PDSCH, if the terminal fails to receive at least one of the DCI and the PDSCH, the terminal may transmit a NACK, and if the terminal succeeds in receive both of them, the terminal may transmit an ACK. —DCI format 1_1 or 1_2 without DL assignment (31-50): If a terminal receives, from a base station, DCI format 1_1 or 1_2 not including downlink data channel scheduling information (31-55) so that one joint TCI state or one separate TCI state set based on a unified TCI scheme is indicated, the terminal may assume at least one combination of the following items for the DCI.
The DCI includes a CRC scrambled using a CS-RNTI.
The values of all bits assigned to all fields used as redundancy version fields are 1.
The values of all bits assigned to all fields used as modulation and coding scheme (MCS) fields are 1.
The values of all bits assigned to all fields used as new data indication (NDI) fields are 0.
In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The terminal may transmit a PUCCH including a HARQ-ACK indicating whether DCI format 1_1 or 1_2 is successfully received (31-60). —With respect to both DCI format 1_1 or 1_2 with DL assignment (31-00) and without DL assignment (31-50), if a new TCI state indicated through DCI 31-01 or 31-55 is the same as a TCI state having been previously indicated and thus having been being applied in uplink transmission and downlink reception, the terminal may maintain the previously applied TCI state. If the new TCI state is different from the previously indicated TCI state, the terminal may determine, as a time point for application of the joint TCI state or separate TCI state set, which is indicatable by a TCI state field included in the DCI, a time point 31-30 or 31-80 after the first slot 31-20 or 31-70 after passage of a time interval as long as a beam application time (BAT) 31-15 or 31-65 after PUCCH transmission. The terminal may use the previously indicated TCI-state at a time point 31-25 or 31-75 before the slot 31-20 or 31-70. —With respect to both DCI format 1_1 or 1_2 with DL assignment (31-00) and without DL assignment (31-50), the BAT is a particular number of OFDM symbols, and may be configured through higher layer signaling, based on terminal capability report information. Numerologies of the BAT and the first slot after the BAT may be determined based on the smallest numerology among all cells to which a joint TCI state or separate TCI set indicated through DCI is applied.

According to an embodiment, a terminal may apply one joint TCI state indicated through a MAC-CE or DCI to reception for control resource sets connected to all terminal-specific particular search spaces, apply the joint TCI state to reception of a PDSCH and transmission of a PUSCH, the PDSCH and the PUSCH being scheduled by a PDCCH transmitted in the control resource sets, and apply the joint TCH state to transmission of all PUCCH resources.

According to an embodiment, if one separate TCI state set indicated through a MAC-CE or DCI includes one DL TCI state, a terminal may apply the one separate TCI state set to reception for control resource sets connected to all terminal-specific particular search spaces, and apply the one separate TCI state set to reception of a PDSCH scheduled by a PDCCH transmitted in the control resource sets. The terminal may apply a previously indicated UL TCI state to all PUSCH and PUCCH resources.

According to an embodiment, if one separate TCI state set indicated through a MAC-CE or DCI includes one UL TCI state, a terminal may apply the UL TCI state to all PUSCH and PUCCH resources. The terminal may apply a previously indicated DL TCI state to reception for control resource sets connected to all terminal-specific particular search spaces, and to reception of a PDSCH scheduled by a PDCCH transmitted in the control resource sets.

If one separate TCI state set indicated through a MAC-CE or DCI includes one DL TCI state and one UL TCI state, a terminal may apply the DL TCI state to reception for control resource sets connected to all terminal-specific particular search spaces, and to reception of a PDSCH scheduled by a PDCCH transmitted in the control resource sets. The terminal may apply the UL TCI state to all PUSCH and PUCCH resources.

Hereinafter, a single TCI state indication and activation method based on a unified TCI scheme is described. A PDSCH including a MAC-CE described below may be scheduled to a terminal by a base station, and the terminal may interpret each codepoint of a TCI state field in DCI format 1_1 or 1_2, based on information in the MAC-CE received from the base station, after 3 slots from transmission of a HARQ-ACK for the PDSCH to the base station. That is, the terminal may activate each entry of the MAC-CE received from the base station in each codepoint of the TCI state field in DCI format 1_1 or 1_2.

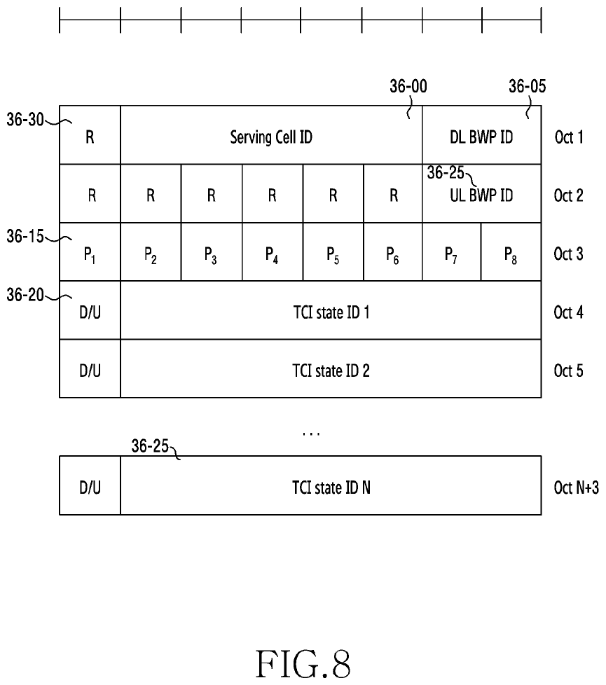

FIG. 8 illustrates another MAC-CE structure for activation and indication of a joint TCI state or a separate DL or UL TCI state in a wireless communication system according to an embodiment of the disclosure. Each field in the MAC-CE structure may have the following meaning. —Serving Cell ID (36-00): A serving cell ID field may indicate whether a corresponding MAC-CE is to be applied to which serving cell. The length of the serving cell ID field may be 5 bits. If a serving cell indicated by the serving cell ID field may be included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in at least one list among simultaneousU-TCI-UpdateList1, simultaneousU-TCI-UpdateList2, simultaneousU-TCI-UpdateList3, or simultaneousU-TCI-UpdateList4, in which the serving cell indicated by the field is included. —DL BWP ID (36-05): A DL BWP ID field may indicate whether the MAC-CE is to be applied to which DL BWP, and the meanings of codepoints in the DL BWP ID field may correspond to codepoints of a bandwidth part indicator in DCI, respectively. The length of this field may be 2 bits. —UL BWP ID (36-10): A UL BWP ID field may indicate whether the MAC-CE is to be applied to which UL BWP, and the meanings of codepoints in the UL BWP ID field may correspond to codepoints of a bandwidth part indicator in DCI, respectively. The length of the UL BWP ID field may be 2 bits. —Pi (36-15): A Pi field may indicate whether each codepoint of a TCI state field in DCI format 1_1 or 1_2 has multiple TCI states or one TCI state. If a value of Pi is 1, this indicates that a corresponding i-th codepoint has multiple TCI states, and may imply that the codepoint may include a separate DL TCI state and a separate UL TCI state. If a value of Pi is 0, this indicates that a corresponding i-th codepoint has a single TCI state, and may imply that the codepoint may include one of a joint TCI state, a separate DL TCI state, or a separate UL TCI state. —D/U (36-20): A D/U field may indicate whether a TCI state ID field in the same octet is a joint TCI state, a separate DL TCI state, or a separate UL TCI state. If the D/U field is 1, the TCI state ID field in the same octet is a joint TCI state or a separate DL TCI state. If the D/U field is 0, the TCI state ID field in the same octet is a separate UL TCI state. —TCI state ID (36-25): A TCI state ID field may indicate a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximumly activatable TCI states may be 8 in a case of joint TCI states, and may be 16 in a case of separate DL or UL TCI states. —R: This indicates a reserved bit and may be configured to be 0.

With respect to the MAC-CE structure of FIG. 8, a terminal may include, in the MAC-CE structure, a third octet including P1, P2, . . . , and P8 fields in FIG. 8 regardless of unifiedTCI-StateType-r17 in MIMOparam-r17 in the higher layer signaling ServingCellConfig being configured to be joint or separate. In this case, the terminal may perform TCI state activation by using a fixed MAC-CE structure regardless of higher layer signaling configured by a base station.

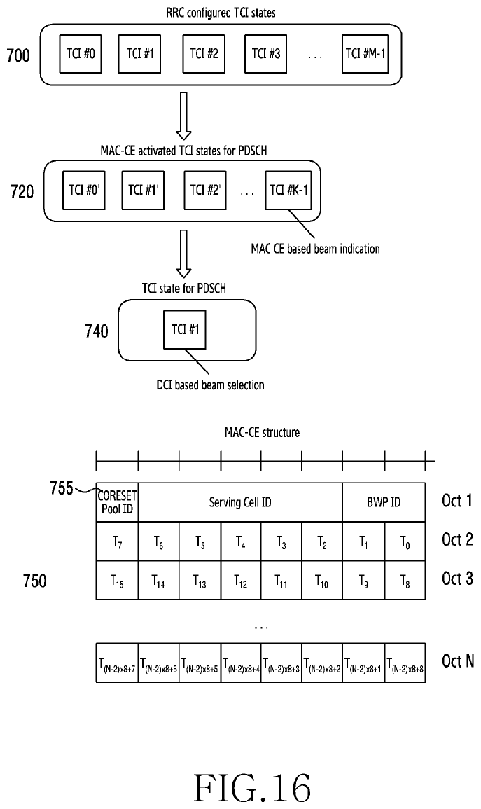

As another example, with respect to the MAC-CE structure of FIG. 8, a terminal may omit the third octet including P1, P2, . . . , and P8 fields, as illustrated in FIG. 8, in a case where unifiedTCI-StateType-r17 in MIMOparam-r17 in the higher layer signaling ServingCellConfig being configured to be joint. In this case, the terminal may save the payload of the MAC-CE structure by a maximum of 8 bits according to higher layer signaling configured by a base station. In addition, all D/U fields positioned on the first bits in octets starting from a fourth octet in FIG. 16 may be considered as R fields, and all the R fields may be configured as 0 bits.

Downlink control information (DCI) in a 5G system is described.

According to an embodiment, in a 5G system, scheduling information on uplink data (or physical uplink data channel (physical uplink shared channel, PUSCH)) or downlink data (or physical downlink data channel (physical downlink shared channel, PDSCH)) is transferred from a base station to a terminal through DCI. The terminal may monitor a fallback DCI format and a non-fallback DCI format for a PUSCH or a PDSCH. The fallback DCI format may be configured by a fixed field pre-defined between the base station and the terminal, and the non-fallback DCI format may include a configurable field.

According to an embodiment, DCI may undergo a channel coding and modulation process, and then be transmitted through a PDCCH that is a physical downlink control channel. A cyclic redundancy check (CRC) may be attached to a DCI message payload, and the CRC may be scrambled by a radio network temporary identifier (RNTI) corresponding to the identity of the terminal. Different RNTIs may be used according to the purpose of a DCI message, for example, terminal (UE)-specific data transmission, a power control command, a random access response, or the like. That is, an RNTI is not explicitly transmitted, and is transmitted after being included in a CRC calculation process. If a terminal receives a DCI message transmitted on a PDCCH, the terminal may identify a CRC by using an assigned RNTI, and if a CRC identification result is correct, the terminal may identify or recognize that the message has been transmitted to the terminal.

For example, DCI scheduling a PDSCH for system information (SI) may be scrambled by a SI-RNTI. DCI scheduling a PDSCH for a random access response (RAR) message may be scrambled by an RA-RNTI. DCI scheduling a PDSCH for a paging message may be scrambled by a P-RNTI. DCI notifying of a slot format indicator (SFI) may be scrambled by an SFI-RNTI. DCI notifying of a transmit power control (TPC) may be scrambled by a TPC-RNTI. DCI scheduling a terminal-specific PDSCH or PUSCH may be scrambled by a cell RNTI (C-RNTI).

According to an embodiment, DCI format 0_0 may be used as fallback DCI scheduling a PUSCH, and in this case, a CRC may be scrambled by a C-RNTI. DCI format 0_0 having a CRC scrambled by a C-RNTI may include, for example, at least one of pieces of information shown in [Table 17] below.

TABLE 17

Identifier for DCI formats (DCI format identifier) - [1] bit
$Frequency domain resource assignment ‐ [ [ {log}_{2} ( \frac{{N}_{R B}^{UL , BWP} ( {N}_{R B}^{UL , BWP} + 1 )}{2} ) ] ] bits$
Time domain resource assignment - X bits
Frequency hopping flag - 1 bit.
Modulation and coding scheme - 5 bits
New data indicator - 1 bit
Redundancy version - 2 bits
HARQ process number - 4 bits
Transmit power control (TPC) command for scheduled PUSCH - [2] bits
Uplink (UL)/supplementary UL (SUL) indicator - 0 or 1 bit

DCI format 0_1 may be used as non-fallback DCI scheduling a PUSCH, and in this case, a CRC may be scrambled by a C-RNTI. DCI format 0_1 having a CRC scrambled by a C-RNTI may include, for example, at least one of pieces of information shown in [Table 18] below.

```
TABLE 18
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
  $For resource allocation type 0 , [ \frac{{N}_{R B}^{UL , BWP}}{P} ] b its$
  $For resource allocation type 1 , [ {log}_{2} ( \frac{{N}_{R B}^{UL , BWP} ( {N}_{R B}^{UL , BWP} + 1 )}{2} ) ] bits$
  Time domain resource assignment - 1, 2, 3, or 4 bits
  Virtual resource block (VRB)-to-physical resource block (PRB) mapping - 0 or
1 bit, only for resource allocation type 1.
  0 bit if only resource allocation type 0 is configured;
  1 bit otherwise.
  Frequency hopping flag - 0 or 1 bit, only for resource allocation type 1.
  0 bit if only resource allocation type 0 is configured;
  1 bit otherwise.
  Modulation and coding scheme - 5 bits
  New data indicator - 1 bit
  Redundancy version - 2 bits
  HARQ process number - 4 bits
  ^{1s}t downlink assignment index - 1 or 2 bits
  1 bit for semi-static HARQ-ACK codebook;
  2 bits for dynamic HARQ-ACK codebook with single HARQ-ACK codebook
(when a dynamic HARQ-ACK codebook is used together with a single HARQ-ACK
codebook).
  ²ⁿd downlink assignment index - 0 or 2 bits
  2 bits for dynamic HARQ-ACK codebook with two HARQ-ACK sub-
codebooks (when a dynamic HARQ-ACK codebook is used together with two HARQ-
ACK sub-codebooks);
  0 bit otherwise.
  TPC command for scheduled PUSCH - 2 bits
  $SRS resource indicator ‐ [ {log}_{2} ( \begin{matrix}{\sum }_{k = 1}^{{L}_{max}} & \begin{matrix}{N}_{SRS} \\ k\end{matrix}\end{matrix} ) ] [ {log}_{2} ( {N}_{S R S} ) ] bits$
  $[ {log}_{2} ( \begin{matrix}{\sum }_{k = 1}^{{L}_{max}} & \begin{matrix}{N}_{SRS} \\ k\end{matrix}\end{matrix} ) ] ts for non ‐ codebook based PUSCH transmission ( when$
PUSCH transmission is not based on a codebook);
  [log₂(N_{SRS})] bits for codebook based PUSCH transmission (when PUSCH
transmission is based on a codebook).
  Precoding information and number of layers - up to 6 bits
  Antenna ports - up to 5 bits
  SRS request - 2 bits
  Channel state information (CSI) request - 0, 1, 2, 3, 4, 5, or 6 bits
  Code block group (CBG) transmission information - 0, 2, 4, 6, or 8 bits
  Phase tracking reference signal (PTRS)-demodulation reference signal (DMRS)
association - 0 or 2 bits.
  beta_offset indicator - 0 or 2 bits
  Demodulation reference signal (DMRS) sequence initialization - 0 or 1 bit
```

DCI format 1_0 may be use as fallback scheduling a PDSCH, an in this case, a CRC may be scrambled by a C-RNTI. DCI format 1_0 having a CRC scrambled by a C-RNTI may include, for example, at least one of pieces of information shown in [Table 19] below.

TABLE 19

Identifier for DCI formats - [1] bit
$Frequency domain resource assignment ‐ [ [ {log}_{2} ( \frac{{N}_{R B}^{DL , BWP} ( {N}_{R B}^{DL , BWP} + 1 )}{2} ) ] ] bits$
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
Physical uplink control channel (PUCCH) resource indicator - 3 bits
PDSCH-to-HARQ feedback timing indicator - [3] bits

DCI format 1_1 may be used as non-fallback DCI scheduling a PDSCH, and in this case, a CRC may be scrambled by a C-RNTI. DCI format 1_1 having a CRC scrambled by a C-RNTI may include, for example, at least one of pieces of information shown in [Table 20] below.

```
TABLE 20
  Carrier indicator - 0 or 3 bits
  Identifier for DCI formats - [1] bits
  Bandwidth part indicator - 0, 1 or 2 bits
  Frequency domain resource assignment
  $For resource allocation type 0 , [ \frac{{N}_{R B}^{DL , BWP}}{P} ] b its$
  $For resource allocation type 1 , [ {log}_{2} ( \frac{{N}_{R B}^{DL , BWP} ( {N}_{R B}^{DL , BWP} + 1 )}{2} ) ] bits$
  Time domain resource assignment - 1, 2, 3, or 4 bits
  VRB-to-PRB mapping - 0 or 1 bit, only for resource allocation type 1.
  0 bit if only resource allocation type 0 is configured;
  1 bit otherwise.
  Physical resource block (PRB) bundling size indicator - 0 or 1 bit
  Rate matching indicator - 0, 1, or 2 bits
  Zero power (ZP) channel state information reference signal (CSI-RS) trigger -
0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  Code block group (CBG) flushing out information - 0 or 1 bit
  DMRS sequence initialization - 1 bit
```

A diagram is illustrated for a downlink control channel in a 5G communication system.

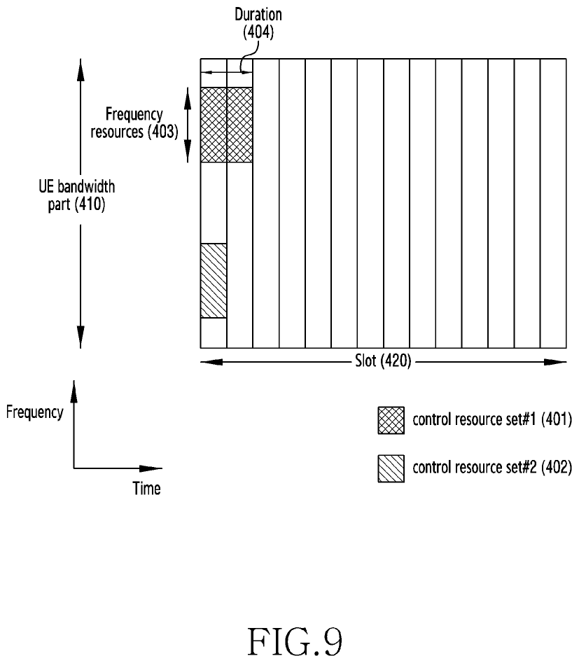

FIG. 9 illustrates an example of a control resource set (CORESET) in which a downlink control channel is transmitted in a 5G wireless communication system. FIG. 9 shows an example in which a bandwidth part (UE bandwidth part) 410 of a terminal is configured along a frequency axis and two control resource sets (control resource set #1 401 and control resource set #2 402) are configured in one slot 420 along a time axis.

Referring to FIG. 9, the control resource sets 401 and 402 may be configured on a particular frequency resource 403 in the entire terminal bandwidth part 410 along the frequency axis. The control resource sets may be configured to be one or multiple OFDM symbols along the time axis and the symbols may be defined as a control resource set duration 404. Referring to the example illustrated in FIG. 9, control resource set #1 401 is configured to have a control resource set duration of two symbols, and control resource set #2 402 is configured to have a control resource set duration of one symbol.

According to an embodiment, a control resource set in 5G described above may be configured for a terminal by a base station through higher layer signaling (e.g., system information, master information block (MIB), and/or radio resource control (RRC) signaling). Configuring a control resource set for a terminal means providing information such as a control resource set identity, the frequency position of the control resource set, and/or the symbol length of the control resource set. Configuration information on a control resource set may include at least one of pieces of information shown in [Table 21].

TABLE 21

| | |
|---|---|
| ControlResourceSet ::= | SEQUENCE { |

-- Corresponds to L1 parameter‘CORESET-ID’

| | |
|---|---|
| controlResourceSetId | ControlResourceSetId, (Control resource set |

identity)

| | |
|---|---|
| frequencyDomainResources | BIT STRING (SIZE (45)), (Frequency axis |

resource allocation information)

| | |
|---|---|
| duration | INTEGER (1..maxCoReSetDuration), (Time |

axis resource allocation information)

| | |
|---|---|
| cce-REG-MappingType | CHOICE { (CCE-to-REG mapping |

type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED { sameAsREG- |

bundle, allContiguousRBs},

| | |
|---|---|
| interleaverSize | ENUMERATED {n2, n3, n6} |

```
        (Interleaver size)
        shiftIndex
    INTEGER(0..maxNrofPhysicalResourceBlocks−1)
    OPTIONAL
      (Interlever shift)
  },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, (QCL configuration |

information)

| | |
|---|---|
| tci-PresentInDCI | ENUMERATED { enabled} |
| | OPTIONAL, -- Need S |

}

In [Table 21], tci-StatesPDCCH (simply, referred to as a transmission configuration indication (TCI) state) configuration information may include information of one or multiple synchronization signal (SS)/physical broadcast channel (PBCH) block indexes and/or channel state information reference signal (CSI-RS) indexes that have a quasi-co-located (QCL) relation with a DMRS transmitted in a corresponding control resource set.

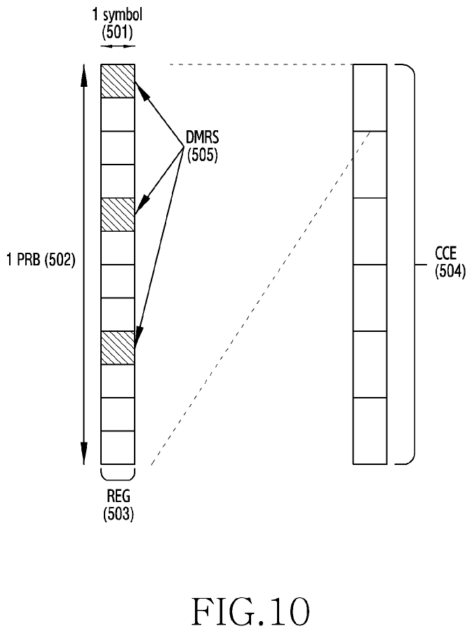

FIG. 10 illustrates an example of a basic unit of time and frequency resources configuring a downlink control channel usable in 5G.

Referring to FIG. 10, a basic unit of time and frequency resources configuring a control channel may be named a resource element group (REG) 503, and the REG 503 may be defined by one OFDM symbol 501 in a time axis and one physical resource block (PRB) 502, that is, 12 subcarriers in a frequency axis. A base station concatenates the REGs 503 with each other to configure a unit of downlink control channel assignment.

According to an embodiment, if a basic unit for assignment of a downlink control channel in 5G is a control channel element (CCE) 504, one CCE 504 may be configured by a plurality of the REGs 503. In description using, as an example, the REG 503 illustrated in FIG. 10, the REG 503 may be configured by 12 REs, and if one CCE 504 is configured by six REGs 503, the one CCE 504 may be configured by 72 REs. If a downlink control resource set is configured, the resource set may be configured by a plurality of CCEs 504, and a particular downlink control channel may be transmitted after being mapped to one or multiple CCEs 504 according to an aggregation level (AL) in the control resource set. CCEs 504 in a control resource set are distinguished by numbers, and the numbers of the CCEs 504 may be assigned according to a logical mapping scheme.

According to an embodiment, a basic unit of a downlink control channel, that is, the REG 503 may include REs to which DCI is mapped and a region to which a DMRS 505, which is a reference signal for decoding the DCI, is mapped. As illustrated in FIG. 10, three DMRSs 505 may be transmitted in one REG 503. The number of CCEs required for transmitting a PDCCH may be 1, 2, 4, 8, and 16 according to an aggregation level (AL), and different numbers of CCEs may be used to implement link adaptation of a downlink control channel. For example, if an AL is equal to L, one downlink control channel may be transmitted through L number of CCEs. A terminal may be required to detect a signal without knowing information about a downlink control channel, and a search space indicating a set of CCEs may be defined for blind decoding. A search space is a set of downlink control channel candidates configured by CCEs to which a terminal is required to attempt to decode at a given aggregation level. Since there are various aggregation levels making 1, 2, 4, 8, and 16 CCEs into one bundle, a terminal may have a plurality of search spaces. A search space set may be defined as a set of search spaces at all configured aggregation levels.

A search space may be classified as a common search space and a terminal (UE)-specific search space. A particular group of terminals or all terminals may investigate a common search space of a PDCCH to receive cell-common control information such as a paging message or dynamic scheduling for system information. For example, PDSCH scheduling assignment information for transmission of an SIB including service provider information of a cell may be received by investigating a common search space of a PDCCH. In a case of a common search space, a particular group of terminals or all terminals are required to receive a PDCCH, and thus the common search space may be defined as a pre-promised set of CCEs. Scheduling assignment information for a terminal-specific PDSCH or PUSCH may be received by investigating a terminal-specific search space of a PDCCH. A terminal-specific search space may be defined terminal-specifically by using functions of various system parameters and the identity of a terminal.

According to an embodiment, in 5G, a parameter for a search space of a PDCCH may be configured for a terminal by a base station through higher layer signaling (e.g., SIB, MIB, and RRC signaling) For example, the base station may configure, for the terminal, the number of PDCCH candidates at each aggregation level L, a monitoring period for the search space, a monitoring occasion in a unit of symbols in a slot of the search space, a search space type (common search space or terminal-specific search space), a combination of an RNTI and a DCI format to be monitored in the search space, and/or an index of a control resource set in which the search space is to be monitored. For example, configuration information configured for a terminal by a base station may include at least one of pieces of information shown in [Table 22].

TABLE 22

| | |
|---|---|
| SearchSpace ::= | SEQUENCE { |

-- Identity of the search space. SearchSpaceId = 0 identifies the SearchSpace configured
via PBCH (MIB) or ServingCellConfigCommon.

| | |
|---|---|
| searchSpaceId | SearchSpaceId, (Search space identifier) |
| controlResourceSetId | ControlResourceSetId, (Control resource set |

identifier)

| | |
|---|---|
| monitoringSlotPeriodicityAndOffset | CHOICE { (Monitoring slot level period) |
| s11 | NULL, |
| s12 | INTEGER (0..1), |
| s14 | INTEGER (0..3), |
| s15 | INTEGER (0..4), |
| s18 | INTEGER (0..7), |
| s110 | INTEGER (0..9), |
| s116 | INTEGER (0..15), |
| s120 | INTEGER (0..19) |
| | OPTIONAL, duration(Monitoring duration) INTEGER |

(2 .. 2559)

| | |
|---|---|
| monitoringSymbolsWithinSlot | BIT STRING (SIZE (14)) |
| | OPTIONAL, (Monitoring symbol in slot) |
| nrofCandidates | SEQUENCE { (The number of PDCCH |

candidates for each aggregation level)

| | |
|---|---|
| aggregationLevel1 | ENUMERATED {n0, n1, n2, n3, n4, n5, n6, |

n8},

| | |
|---|---|
| aggregationLevel2 | ENUMERATED {n0, n1, n2, n3, n4, n5, n6, |

n8},

| | |
|---|---|
| aggregationLevel4 | ENUMERATED {n0, n1, n2, n3, n4, n5, n6, |

n8},

| | |
|---|---|
| aggregationLevel8 | ENUMERATED {n0, n1, n2, n3, n4, n5, n6, |

n8},

| | |
|---|---|
| aggregationLevel16 | ENUMERATED {n0, n1, n2, n3, n4, n5, n6, |

n8}

| | |
|---|---|
| search SpaceType | CHOICE { |

(Search space type)
-- Configures this search space as common search space (CSS) and DCI formats to
monitor.

| | |
|---|---|
| common | SEQUENCE { |

(Common search space)
}

| | |
|---|---|
| ue-Specific | SEQUENCE |

(Terminal-specific search space)
-- Indicates whether the UE monitors in this USS for DCI formats 0-0 and 1-0 or
for formats 0-1 and 1-1.

| | |
|---|---|
| formats | ENUMERATED {formats0-0-And-1-0, |

formats0-1-And-1-1},
...
}

A base station may configure one or multiple search space sets for a terminal according to configuration information. According to an embodiment, a base station may configure, for a terminal, search space set 1 and search space set 2. The base station may configure the terminal to monitor DCI format A scrambled by an X-RNTI in search space set 1 in a common search space, and the base station may configure the terminal to monitor DCI format B scrambled by a Y-RNTI in search space set 2 in a terminal-specific search space.

According to an embodiment, according to configuration information, one or multiple search space sets may exist in a common search space or a terminal-specific search space. For example, search space set #1 and search space set #2 may be configured to be a common search space, and search space set #3 and search space set #4 may be configured to be a terminal-specific search space.

In a common search space, the following combinations of a DCI format and an RNTI below may be monitored. However, the disclosure is not limited to the example below:—DCI format 0_0/1_0 with CRC scrambled by C-RNTI, CS-RNTI, SP-CSI-RNTI, RA-RNTI, TC-RNTI, P-RNTI, SI-RNTI; —DCI format 2_0 with CRC scrambled by SFI-RNTI;
DCI format 2_1 with CRC scrambled by INT-RNTI; —DCI format 2_2 with CRC scrambled by TPC-PUSCH-RNTI, TPC-PUCCH-RNTI; and—DCI format 2_3 with CRC scrambled by TPC-SRS-RNTI.

According to an embodiment, in a terminal-specific search space, the following combinations of a DCI format and an RNTI may be monitored. However, the disclosure is not limited to the example below:—DCI format 0_0/1_0 with CRC scrambled by C-RNTI, CS-RNTI, TC-RNTI; and
DCI format 1_0/1_1 with CRC scrambled by C-RNTI, CS-RNTI, TC-RNTI.

The mentioned RNTIs may follow the definitions and uses below:
Cell RNTI (C-RNTI): for the purpose of scheduling a terminal-specific PDSCH;
Temporary Cell RNTI (TC-RNTI): for the purpose of scheduling a terminal-specific PDSCH;
Configured Scheduling RNTI (CS-RNTI): for the purpose of scheduling semi-statically configured terminal-specific PDSCH;
Random Access RNTI (RA-RNTI): for the purpose of scheduling a PDSCH in a random access stage;
Paging RNTI (P-RNTI): for the purpose of scheduling a PDSCH on which paging is transmitted;
System Information RNTI (SI-RNTI): for the purpose of scheduling a PDSCH on which system information is transmitted;
Interruption RNTI (INT-RNTI): for the purpose of notifying of whether a PDSCH is punctured;
Transmit Power Control for PUSCH RNTI (TPC-PUSCH-RNTI): for the purpose of indicating a power control command for a PUSCH;
Transmit Power Control for PUCCH RNTI (TPC-PUCCH-RNTI): for the purpose of indicating a power control command for a PUCCH; and
Transmit Power Control for SRS RNTI (TPC-SRS-RNTI): for the purpose of indicating a power control command for an SRS.

The specified DCI formats mentioned above may follow a definition in [Table 23] below.

TABLE 23

| DCI_format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for |
| | SRS transmissions by one or more UEs |

In 5G, a search space of an aggregation level L for a control resource set p and a search space set s may be expressed as in [Formula 1] below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + iL : \qquad [ Formula 1 ]$$

Aggregation level;
n_{CI}: Carrier index;
N_{CCE,p}: Number of total CCEs existing in control resource set p;
n_{s,f}^{μ}: Slot index;
M_{s,max}^{(L)} number of PDCCH candidates of aggregation level L;
m_{s,nCI}=0, . . . , M_{s,max}^{(L)}: Indexes of PDCCH candidates of aggregation level L;
i=0, . . . L−1;

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , \\ {A}_{p} = 39827 for p mod 3 = 0 , {A}_{p} = 39829 for p mod 3 = 1 , \\ {A}_{p} = 39839 for p mod 3 = 2 , D = 65537 ;$$

and
n_{RNTI}: Terminal identifier.

A value of Y_{p,n}_{_{s,f}}_{^{μ}} may correspond to 0 in a case of a common search space.

A value of Y_{p,n}_{_{s,f}}_{^{μ}} may change according to a time index and the identity of a terminal (C-RNTI or ID configured for a terminal by a base station) in a case of a terminal-specific search space.

According to an embodiment, in 5G, multiple search space sets may be configured by different parameters (e.g., parameters in [Table 22]). Therefore, a set of search space sets monitored by a terminal every time point may be changed. For example, if search space set #1 is configured according to an X-slot period, search space set #2 is configured according to a Y-slot period, and X is different from Y, a terminal may monitor both search space set #1 and search space set #2 in a particular slot, and may monitor one of search space set #1 and search space set #2 in a particular slot.

A combination of TCI states applicable to a PDCCH DMRS antenna port is as shown in [Table 24] below. In [Table 24], a combination in the fourth row is assumed by a terminal before RRC configuration, and may be unable to be configured after RRC.

TABLE 24

| Valid | | | DL RS 2 | qcl-Type2 |
|---|---|---|---|---|
| TCI state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | | |
| | (CSI) | | | |
| 4 | SS/PBCH | QCL-TypeA | SS/PBCH | QCL-TypeD |
| | Block | | Block | |

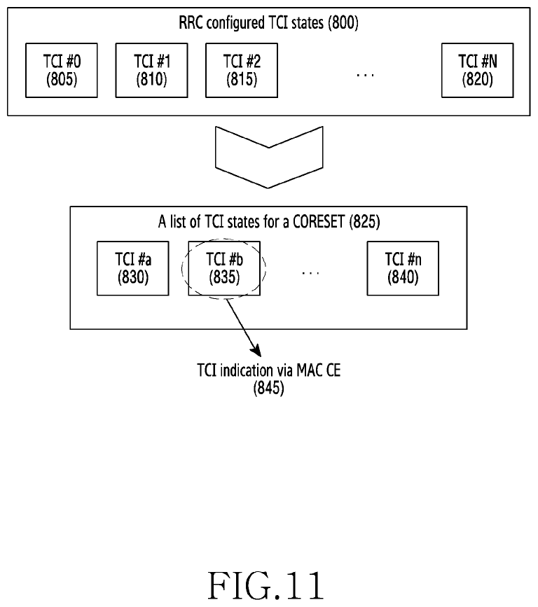

According to an embodiment, in NR, a hierarchical signaling method as illustrated in FIG. 11 is supported for dynamic allocation for PDCCH beams.

FIG. 11 illustrates an example of a TCI state allocation method for a PDCCH in a wireless communication system according to an embodiment of the disclosure.

Referring to FIG. 11, a base station may configure N number of TCI states 805, 810, . . . , and 820 for a terminal through RRC signaling 800, and may configure some of the TCI states as TCI states for a CORESET (825). Thereafter, the base station may indicate one of TCI states 830, 835, and 840 for the CORESET to the terminal through MAC CE signaling (845). Then, the terminal receives a PDCCH, based on beam information included in the TCI state indicated by the MAC CE signaling.

FIG. 12 illustrates a TCI indication MAC CE signaling structure for a PDCCH DMRS. Referring to FIG. 12, the TCI indication MAC CE signaling for a PDCCH DMRS may be configured by 2 bytes (16 bits), and may include a serving cell ID 915 of 5 bits, a CORESET ID 920 of 4 bits, and a TCI state ID 925 of 7 bits.

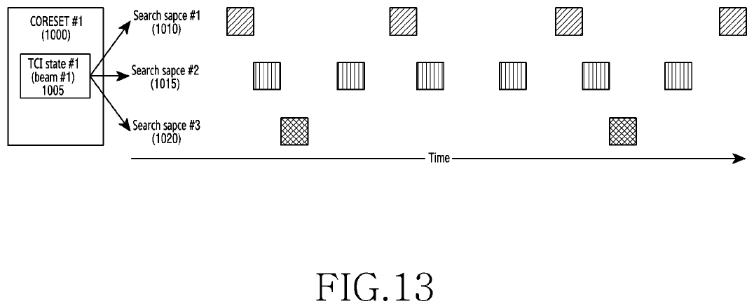

FIG. 13 illustrates an example of beam configuration in a control resource set (CORESET) and a search space according to the above description.

Referring to FIG. 13, a base station may indicate one TCI state in a TCI state list included in a configuration of a CORESET 1000 through MAC CE signaling (1005). Until another TCI state is indicated for the CORESET through another MAC CE signaling, a terminal may assume or identify that the same QCL information (beam #1 1005) is applied to one or more search spaces 1010, 1015, and 1020 connected to the CORESET. In the described PDCCH beam allocation method, it is difficult to indicate a beam change before passage of a MAC CE signaling delay, and there is a shortage in that the same beam is collectively applied for each CORESET regardless of the characteristics of search spaces, so that flexible PDCCH beam management is difficult.

Hereinafter, embodiments of the disclosure provide a more flexible PDCCH beam configuration and management method. In describing the embodiments of the disclosure below, for convenience of explanation, some distinguishable examples are provided, but the examples are not mutually exclusive and are applicable in proper combination according to a situation.

According to an embodiment, a base station may configure, for a terminal, one or multiple TCI states with respect to a particular control resource set, and may activate one of the configured TCI states through a MAC CE activation command. For example, {TCI state #0, TCI state #1, TCI state #2} is configured for control resource set #1 as TCI states, and the base station may transmit, to the terminal through a MAC CE, a command to activate assumption of TCI state #0 as a TCI state for control resource set #1. Based on the activation command for the TCI state received through the MAC CE, the terminal may correctly receive a DMRS of the control resource set, based on QCL information in the activated TCI state.

According to an embodiment, with respect to a control resource set (control resource set #0) configured to have an index of 0, if the terminal has failed to receive a MAC CE activation command for a TCI state of control resource set #0, the terminal may assume or identify that a DMRS transmitted in control resource set #0 is QCLed with an SS/PBCH block identified in an initial access process or a non-contention-based random access process that is not triggered by a PDCCH command.

According to an embodiment, with respect to a control resource set (control resource set #X) configured to have an index of a value other than 0, if a TCI state for control resource set #X has failed to be configured for the terminal, or if one or more TCI states are configured for the terminal, but the terminal has failed to receive a MAC CE activation command to activate one of the TCI states, the terminal may assume or identify that a DMRS transmitted in control resource set #X is QCLed with an SS/PBCH block identified in an initial access process.

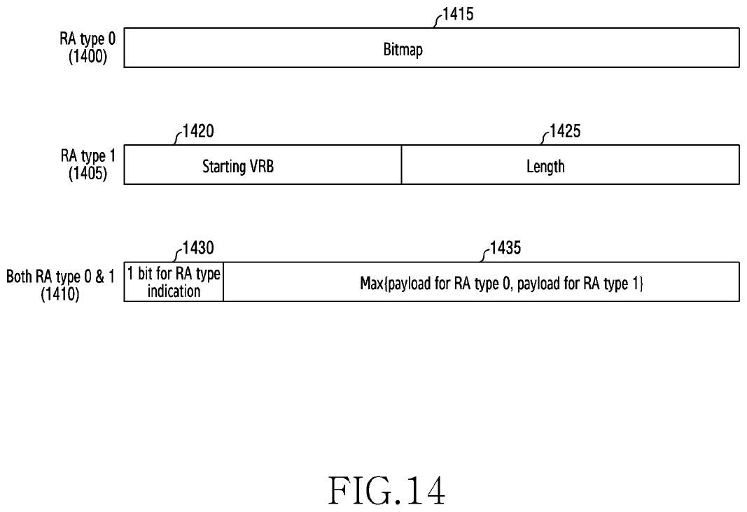

FIG. 14 illustrates an example of frequency axis resource allocation of a PDSCH in a wireless communication system according to an embodiment of the disclosure.

FIG. 14 is a diagram illustrating three frequency axis resource allocation methods including type 0 1400, type 1 1405, and a dynamic switch 1410 configurable through a higher layer in an NR wireless communication system.

Referring to FIG. 14, if a terminal is configured, through higher layer signaling, to use only resource type 0 (1400), partial downlink control information (DCI) allocating a PDSCH to the terminal may include a bitmap configured by N_RBG bits. A condition therefor will be described later. N_RBG may be referred to as the number of resource block groups (RBGs) determined as shown in [Table 25] below according to the higher layer parameter rbg-Size and a BWP size allocated by a BWP indicator. Data is transmitted on an RBG marked with 1 according to a bitmap.

TABLE 25

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In case that a terminal is configured, through higher layer signaling, to use only resource type 1 (1405), partial DCI allocating a PDSCH to the terminal may include frequency axis resource allocation information configured by

$$[ {log}_{2} ( \frac{{N}_{RB}^{DL , BWP} ( {N}_{RB}^{DL , BWP} + 1 )}{2} ) ]$$

number of bits. A condition therefor will be described later. A base station may configure, through the information, a starting VRB 1420 and a frequency axis resource length 1425 continuously allocated therefrom.

In case that a terminal is configured, through higher layer signaling, to use both resource type 0 and resource type 1 (1410), partial DCI allocating a PDSCH to the terminal may include frequency axis resource allocation information configured by bits of a payload 1435 having a greater value among the payload 1415 for configuring resource type 0 and the payload (1420 and 1425) for configuring resource type 1. A condition therefor will be described later. A bit 1430 is added to a foremost part (an MSB) of the frequency axis resource allocation information in the DCI, if the bit 1430 has a value of 0, this may indicate that resource type 0 is used, and if the bit has a value of 1, this may indicate that resource type 1 is used.

A time domain resource allocation method for a data channel in a next generation mobile communication system (5G or NR system) is described.

According to an embodiment, a base station may configure, for a terminal, a table relating to time domain resource allocation information for a downlink data channel (PDSCH) and an uplink data channel (PUSCH) through higher layer signaling (e.g., RRC signaling).

According to an embodiment, a table configured by a maximum of 16 entries (maxNrofDL-Allocations=16) may be configured for a PDSCH, and a table configured by a maximum of 16 entries (maxNrofUL-Allocations=16) may be configured for a PUSCH. In an embodiment, time domain resource allocation information may include a PDCCH-to-PDSCH slot timing, a PDCCH-to-PUSCH slot timing, information on a start symbol position and a length which a PDSCH or PUSCH is scheduled to have, and/or a PDSCH or PUSCH mapping type. The PDCCH-to-PDSCH slot timing may correspond to a time interval expressed in a unit of slots between a time point at which a PDCCH is received and a time point at which a PDSCH scheduled by the received PDCCH is transmitted, and may be represented by K0. The PDCCH-to-PUSCH slot timing may correspond to a time interval expressed in a unit of slots between a time point at which a PDCCH is received and a timepoint at which a PUSCH scheduled by the received PDCCH is transmitted, and may be represented by K2.

For example, information as shown in [Table 26] and [Table 27] below may be transmitted from a base station to a terminal. The information transmitted from a base station to a terminal may include at least one of pieces of information included in [Table 26] or [Table 27].

TABLE 26
PDSCH-TimeDomainResourceAllocation List information element

PDSCH-TimeDomainResourceAllocationList ::= SEQUENCE
(SIZE(1..maxNrofDL-Allocations)) OF
PDSCH-TimeDomainResourceAllocation
PDSCH-TimeDomainResourceAllocation ::= SEQUENCE {
k0 INTEGER(0..32) OPTIONAL, -- Need S
(PDCCH-to-PDSCH timing, unit of slot)
mapping Type ENUMERATED {typeA, typeB},
(PDSCH mapping type)
startSymbolAndLength INTEGER (0..127)
(Start symbol and length of PDSCH)
}

TABLE 27
PUSCH-TimeDomainResourceAllocation information element

PUSCH-TimeDomainResourceAllocationList ::= SEQUENCE
(SIZE(1..maxNrofUL-Allocations)) OF
PUSCH-TimeDomainResourceAllocation
PUSCH-TimeDomainResourceAllocation ::= SEQUENCE {
k2 INTEGER(0..32) OPTIONAL, -- Need S
(PDCCH-to-PUSCH timing, unit of slot)
mappingType ENUMERATED {typeA, typeB },
(PUSCH mapping type)
startSymbolAndLength INTEGER (0..127)
(Start symbol and length of PUSCH)
}

According to an embodiment, a base station may notify a terminal of one of the entries of the above table relating to time domain resource allocation information through L1 signaling (e.g., DCI). For example, the one entry may be indicated by a “time domain resource allocation” field in DCI. The terminal may obtain time domain resource allocation information for a PDSCH or PUSCH, based on the DCI received from the base station.

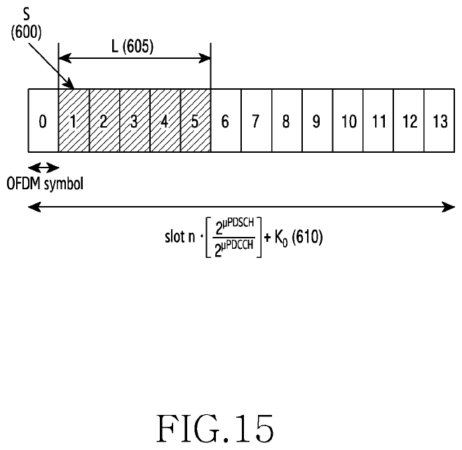

FIG. 15 illustrates an example of time axis resource allocation of a PDSCH in a wireless communication system according to an embodiment of the disclosure.

Referring to FIG. 15, a base station may indicate a time axis position of a PDSCH resource, based on a subcarrier spacing (SCS) (μPDSCH, μPDCCH) and a scheduling offset (K0) value of a data channel and a control channel configured using a higher layer, and/or a start position 600 and a length 605 of OFDM symbols in one slot dynamically indicated through DCI.

FIG. 16 illustrates a process for beam configuration and activation of a PDSCH.

Referring to FIG. 16, a list of TCI states for a PDSCH may be indicated through a higher layer list such as RRC 700. For example, the list of TCI states may be indicated by tci-StatesToAddModList and/or tci-StatesToReleaseList in a PDSCH-Config IE for each BWP. Some of the list of TCI states may be activated through a MAC-CE 720. A TCI state for a PDSCH among the TCI states activated through the MAC-CE may be indicated through DCI 740.

A maximum number of the activated TCI states may be determined according to a capability reported by a terminal. A first part 750 in FIG. 16 illustrates an example of a MAC-CE structure for PDSCH TCI state activation/deactivation.

The meaning of each field in the MAC CE and a value configurable for each field may be shown as in [Table 28] below. For example, a field included in a MAC-CE may include at least one of fields of [Table 28].

TABLE 28
Serving cell identifier (Serving Cell ID): This field indicates the identity of the
Serving Cell for which the MAC CE applies. The length of the field is 5 bits. If the indicated
Serving Cell is configured as part of a simultaneousTCI-UpdateList1 or simultaneousTCI-
UpdateList2 as specified in TS 38.331, this MAC CE applies to all the Serving Cells configured
in the set simultaneousTCI-UpdateList1 or simultaneousTCI-UpdateList2, respectively;
Bandwidth part identifier (BWP ID): This field indicates a DL BWP for which the
MAC CE applies as the codepoint of the DCI bandwidth part indicator field as specified in TS
38.212. The length of the BWP ID field is 2 bits. This field is ignored if this MAC CE applies
to a set of Serving Cells;
TCI state identifier (Tᵢ): If there is a TCI state with TCI-StateId i as specified in TS
38.331, this field indicates the activation/deactivation status of the TCI state with TCI-StateId i,
otherwise MAC entity shall ignore the Ti field. The Ti field is set to 1 to indicate that the TCI
state with TCI-StateId i shall be activated and mapped to the codepoint of the DCI Transmission
Configuration Indication field, as specified in TS 38.214. The Ti field is set to 0 to indicate that
the TCI state with TCI-StateId i shall be deactivated and is not mapped to the codepoint of the
DCI Transmission Configuration Indication field. The codepoint to which the TCI State is
mapped is determined by its ordinal position among all the TCI States with Ti field set to 1, i.e.,
the first TCI State with Tᵢ field set to 1 shall be mapped to the codepoint value 0, second TCI
State with Ti field set to 1 shall be mapped to the codepoint value 1 and so on. The maximum
number of activated TCI states is 8;
CORESET Pool identifier (ID): This field indicates that mapping between the
activated TCI states and the codepoint of the DCI Transmission Configuration Indication set by
field Ti is specific to the ControlResourceSetId configured with CORESET Pool ID as specified
in TS 38.331. This field set to 1 indicates that this MAC CE shall be applied for the DL
transmission scheduled by CORESET with the CORESET pool ID equal to 1, otherwise, this
MAC CE shall be applied for the DL transmission scheduled by CORESET pool ID equal to 0.
If the coresetPoolIndex is not configured for any CORESET, MAC entity shall ignore the
CORESET Pool ID field in this MAC CE when receiving the MAC CE. If the Serving Cell in
the MAC CE is configured in a cell list that contains more than one Serving Cell, the CORESET
Pool ID field shall be ignored when receiving the MAC CE.

A PDSCH processing time (PDSCH processing procedure time) is described. In a case where a base station schedules transmitting a PDSCH by using DCI format 1_0, 1_1, or 1_2 for a terminal, the terminal may need a PDSCH processing time to apply a transmission method (modulation/demodulation and coding indication index (MCS), demodulation reference signal-related information, and time and frequency resource allocation information) indicated through the DCI and receive a PDSCH. In NR, a PDSCH processing time is defined in consideration of the above description. The PDSCH processing time of the terminal may be determined based on [Formula 2] below.

$$Tproc , 1 = ( N 1 + d 1 , 1 + d 2 ) ( 2048 + 144 ) κ 2 - μ Tc + Text . \qquad [ Formula 2 ]$$

Each variable of Tproc, 1 described above as [Formula 2] may have the following meaning. —N1: This may be referred to as the number of symbols determined according to numerology and terminal (UE) processing capability 1 or 2 corresponding to the capability of the terminal. N1 may have values in [Table 29] when terminal processing capability 1 is reported according to a capability report of the terminal. If terminal processing capability 2 is reported and terminal processing capability 2 being available is configured through higher layer signaling, N1 may have values in [Table 30]. Numerology may correspond to a minimum value among PDCCH, PDSCH, and UL to maximize Tproc, 1 described above, and PDCCH, PDSCH, and UL may indicate the numerology of a PDCCH scheduling a PDSCH, the numerology of the scheduled PDSCH, and the numerology of an uplink channel through which a HARQ-ACK is to be transmitted, respectively.

[Table 29] may include information on a PDSCH processing time in a case of PDSCH processing capability 1.

TABLE 29

| | PDSCH decoding time N₁ [symbols] | |
|---|---|---|
| | | With respect to both PDSCH |
| | | mapping types A and B, dmrs- |
| | With respect to both PDSCH | AdditionalPosition in higher |
| | mapping types A and B, dmrs- | layer signaling DMRS- |
| | AdditionalPosition in higher | DownlinkConfig is not equal to |
| | layer signaling DMRS- | pos0 or higher layer parameter |
| μ | DownlinkConfig is equal to pos0 | is not configured |
| 0 | 8 | N_{1, 0} |
| 1 | 10 | 13 |
| 2 | 17 | 20 |
| 3 | 20 | 24 |

[Table 30] may include information on a PDSCH processing time in a case of PDSCH processing capability 2.

TABLE 30

| | PDSCH decoding time N₁ [symbols] |
|---|---|
| | With respect to both PDSCH mapping types A and B, |
| | dmrs-AdditionalPosition in higher layer signaling |
| μ | DMRS-DownlinkConfig is equal to pos0 |
| 0 | 3 |
| 1 | 4.5 |

κ: 64; —Text: If the terminal uses a shared spectrum channel access scheme, the terminal may calculate Text and apply same to a PDSCH processing time. Otherwise, Text is assumed to be 0; —If 11 indicating a PDSCH DMRS position value is 12, N1,0 in [Table 29] has a value of 14, and otherwise, has a value of 13; —With respect to PDSCH mapping type A, if the last symbol of a PDSCH is an i-th symbol in a slot in which the PDSCH is transmitted and i is smaller than 7, d1,1 is 7-i, and otherwise, d1,1 is 0; —d2: If a PUCCH having a high priority index and a PUCCH or PUSCH having a low priority index overlap with each other in time, d2 of the PUCCH having the high priority index may be configured as a value reported from the terminal. Otherwise, d2 is equal to 0; —In a case where PDSCH mapping type B is used for terminal processing capability 1, a d1,1 value may be determined according to L that is the number of symbols of a scheduled PDSCH and d that is the number of symbols on which a PDCCH scheduling the PDSCH and the scheduled PDSCH overlap with each other, as described below; —In case that L is equal to or greater than 7, d1,1 is equal to 0 (if L≥7, d1,1=0); —If L is equal to or greater than 4 and is equal to or smaller than 6, d1,1 is equal to 7−L (if L≥4 and L≤6, d1,1=7−L); —In case that L is equal to 3, d1,1 is equal to min (d, 1)(if L=3, d1,1=min (d, 1)); —In case that L is equal to or greater than 2, d1,1 is equal to 3+d (if L=2, d1,1=3+d). —In a case where PDSCH mapping type B is used for terminal processing capability 2, a d1,1 value may be determined according to L that is the number of symbols of a scheduled PDSCH and d that is the number of symbols on which a PDCCH scheduling the PDSCH and the scheduled PDSCH overlap with each other, as described below. —In case that L is equal to or greater than 7, d1,1 is equal to 0 (if L≥7, d1,1=0); —In case that L is equal to or greater than 4 and is equal to or smaller than 6, d1,1 is equal to 7−L (if L≥4 and L≤6, d1,1=7−L); —In a case where L is equal to 2 (if L=2); —In case that a PDCCH for scheduling exists in a CORESET configured by 3 symbols and the CORESET and a scheduled PDSCH have the same start symbol, d1,1 is equal to 3 (d1,1=3); —Otherwise, d1,1 is equal to d (d1,1=d); —In a case of a terminal supporting capability 2 in a given serving cell, the terminal may apply a PDSCH processing time corresponding to terminal processing capability 2 when the higher layer signaling processingType2Enabled is configured to be enabled for the cell; and

In case that the position of a first uplink transmission symbol of a PUCCH including HARQ-ACK information does not start earlier than a first uplink transmission symbol after a time interval as long as Tproc, 1 after a last symbol of a PDSCH, a terminal is required to transmit a valid HARQ-ACK message. The position of the first uplink transmission symbol may be determined based on K1 defined as a HARQ-ACK transmission time point, a PUCCH resource used for HARQ-ACK transmission, and/or a timing advance effect.

That is, a terminal is required to a PUCCH including HARQ-ACK only when a PDSCH processing time is enough. Otherwise, a terminal is unable to provide valid HARQ-ACK information corresponding to a scheduled PDSCH to a base station. Tproc, 1 described above may be used for both a normal or expanded CP. In a case of a PDSCH configured to have two PDSCH transmission occasions in one slot, d1,1 may be calculated based on a first PDSCH transmission occasion in the slot.

In LTE and NR, while being connected to a serving base station, a terminal may perform a procedure of reporting a capability supported by the terminal to the base station. In the following description, this is called a terminal (UE) capability report.

A base station may transfer a terminal (UE) capability enquiry message requesting a capability report from a terminal connected thereto. The message may include a terminal capability request for each radio access technology (RAT) type of the base station. The request for each RAT type may include supported frequency band combination information. In addition, in the case of the terminal capability enquiry message, UE capabilities for multiple RAT types may be requested through one RRC message container transmitted by the base station, or the base station may include a terminal capability enquiry message including a terminal capability request for each RAT type multiple times and transfer same to the terminal. That is, a terminal capability enquiry may be repeated multiple times in one message, and the terminal may configure a terminal (UE) capability information message corresponding to a terminal capability enquiry and report same multiple times. In a next generation mobile communication system, a terminal capability request for multi-RAT dual connectivity (MR-DC) in addition to NR, LTE, and E-UTRA—NR dual connectivity (EN-DC) may be performed. In addition, the terminal capability enquiry message is generally transmitted at an initial state after a terminal is connected to a base station, but may also be requested under a designated condition if required by the base station.

In the above stage, a terminal having received a UE capability report request from a base station may configure a terminal capability according to a RAT type and band information requested by the base station. The following description provides a method of configuring a UE capability by a terminal in an NR system.

Stage 1. If a terminal receives a list for LTE and/or NR bands from a base station as a UE capability request, the terminal configures a band combination (BC) for EN-DC and NR standalone (SA). That is, the terminal configures a candidate list of BCs for EN-DC and NR SA, based on bands requested by the base station through FreqBandList. In addition, the priorities of the bands follow an order described in FreqBandList.

Stage 2. If the base station configures a “eutra-nr-only” flag or “eutra” flag to request a UE capability report, the terminal completely removes what is related to NR SA BCs from the configured candidate list of BCs. The complete removing of what is related to NR SA BCs from the configured candidate list of BCs may occur only when an LTE base station (eNB) requests a “eutra” capability.

Stage 3. Thereafter, the terminal removes fallback BCs from the candidate list of BCs configured in the above stage. The fallback BC may be referred to as a BC which is obtainable removing a band corresponding to at least one SCell from a random BC. The fallback BC is omissible because a BC before removing a band corresponding to at least one SCell is already able to cover the fallback BC. This stage is applied to MR-DC, that is, is applied to LTE bands. BCs remaining after stage 3 correspond to a final “candidate BC list.”

Stage 4. The terminal selects BCs to be reported by selecting the BCs matching a requested RAT type in the final “candidate BC list.” In stage 4, the terminal may configure supportedBandCombinationList according to a determined order. That is, the terminal may configure BCs and UE capabilities according to a pre-configured order of rat-types. (nr→eutra-nr→eutra). In addition, the terminal configures featureSetCombination for the configured supportedBandCombinationList, and the terminal may configure a list of “candidate feature set combinations” from the candidate BC list from which a list for fallback BCs (including a capability having the same or lower level) has been removed. The “candidate feature set combinations” may include all feature set combinations for NR and EUTRA-NR BCs, and may be obtained from feature set combinations of UE-NR-Capabilities and UE-MRDC-Capabilities containers.

Stage 5. In addition, if the requested rat Type is eutra-nr and has an influence, featureSetCombinations may be included in both of two containers of UE-MRDC-Capabilities and UE-NR-Capabilities. However, feature sets of NR may be included only in UE-NR-Capabilities.

After a terminal capability is configured, the terminal transfers a terminal capability information message including the terminal capability to the base station. The base station may perform proper scheduling and transmission/reception management for the terminal in the future, based on the terminal capability received from the terminal.

According to an embodiment of the disclosure, non-coherent joint transmission (NC-JT) may be used to enable a terminal to receive a PDSCH from multiple TRPs.

According to an embodiment, unlike the conventional system, a 5G wireless communication system may support all services including a service having very short transmission delay and a service requiring high connection density, as well as a service requiring high data rate. In a wireless communication network including multiple cells, transmission and reception points (TRPs), or beams, cooperative communication (coordinated transmission) between cells, TRPs, and/or beams may increase the strength of a signal received by a terminal or efficiently perform interference control between cells, TRPs, and/or beams so as to satisfy various service requirements.

According to an embodiment, joint transmission (JT) is a representative transmission technology for cooperative communication described above, and transmits a signal to one terminal through multiple different cells, TRPs, and/or beams so as to increase the strength of the signal received by the terminal or a processing rate. The characteristics of channels between the terminal and each cell, TRP, and/or beam may be largely different from each other. Particularly, in a case of non-coherent joint transmission (NC-JT) supporting non-coherent precoding between cells, TRPs, and/or beams, individual precoding, MCS, resource allocation, and/or TCI indication may be required according to a channel characteristic for each link between a terminal and each cell, TRP, and/or beam.

NC-JT described above may be applied to at least one channel among a downlink data channel (PDSCH), a downlink control channel (PDCCH), an uplink data channel (PUSCH), and an uplink control channel (PUCCH). Transmission information, such as precoding, MCS, resource allocation, and/or TCI, may be indicated by DL DCI at the time of PDSCH transmission. For NC-JT, the transmission information is required to be independently indicated for each cell, TRP, and/or beam. This is a main reason for increasing a payload required for DL DCI transmission and may adversely affect the reception performance of a PDCCH transmitting DCI. Therefore, for support of JT of a PDSCH, careful design of the tradeoff between the amount of DCI information amount and the reception performance of control information is necessary.

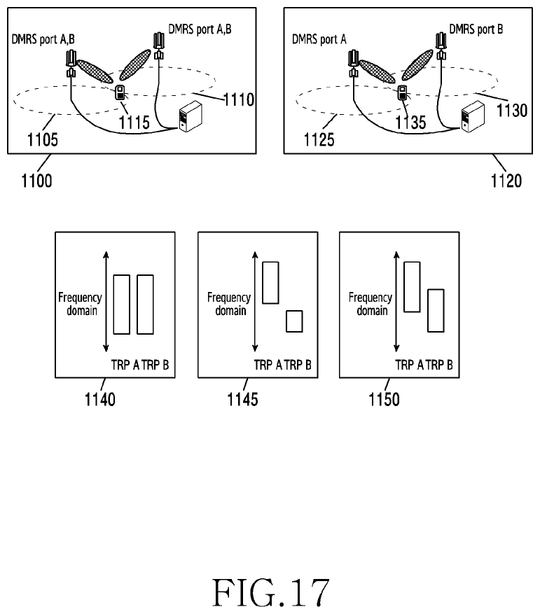

FIG. 17 illustrates an example of antenna port configuration and resource allocation for transmitting a PDSCH by using cooperative communication in a wireless communication system according to an embodiment of the disclosure.

Referring to FIG. 17, examples for PDSCH transmission are described for respective joint transmission (JT) schemes, and embodiments for allocating a wireless resource for each TRP are illustrated.

Referring to FIG. 17, an example 1100 for coherent joint transmission (C-JT) supporting coherent precoding between cells, TRPs, and/or beams is illustrated.

According to an embodiment, in a case of C-JT, TRP A 1105 and TRP B 1100 transmit single data (PDSCH) to a terminal 1115, and multiple TRPs may perform joint precoding. This may imply that a DMRS is transmitted through the same DMRS ports to allow TRP A 1105 and TRP B 1100 to transmit the same PDSCH. For example, each of TRP A 1105 and TRP B 1100 may transmit a DMRS to the terminal through DMRS port A and DMRS B. In this case, the terminal may receive one piece of DCI information for receiving one PDSCH demodulated based on the DMRS transmitted through DMRS port A and DMRS B.

Referring to FIG. 17, an example 1120 for non-coherent joint transmission (NC-JT) supporting non-coherent precoding between cells, TRPs, and/or beams for PDSCH transmission is illustrated.

According to an embodiment, in a case of NC-JT, cells, TRPs, and/or beams transmit respective PDSCHs to a terminal 1135, and individual precoding may be applied to each PDSCH. Respective cells, TRPs, and/or beams may transmit different PDSCHs or different PDSCH layers to the terminal so as to improve a processing rate compared to single cell, TRP, or/and beam transmission. In addition, respective cells, TRPs, and/or beams may perform repeated transmission of the same PDSCH to the terminal so as to improve reliability compared to single cell, TRP, or/and beam transmission. For convenience of explanation, hereinafter, a cell, TRP, or/and beam is collectively called a TRP.

Various wireless resource allocations may be considered for a case 1140 where frequency and time resources used in multiple TRPs for PDSCH transmission are all the same, a case 1145 where frequency and time resources used in multiple TRPs do not overlap at all, and a case 1150 where some of frequency and time resources used in multiple TRPs overlap.

For NC-JT support, pieces of DCI having various types, structures, and relations may be considered to simultaneously allocate multiple PDSCHs to one terminal.

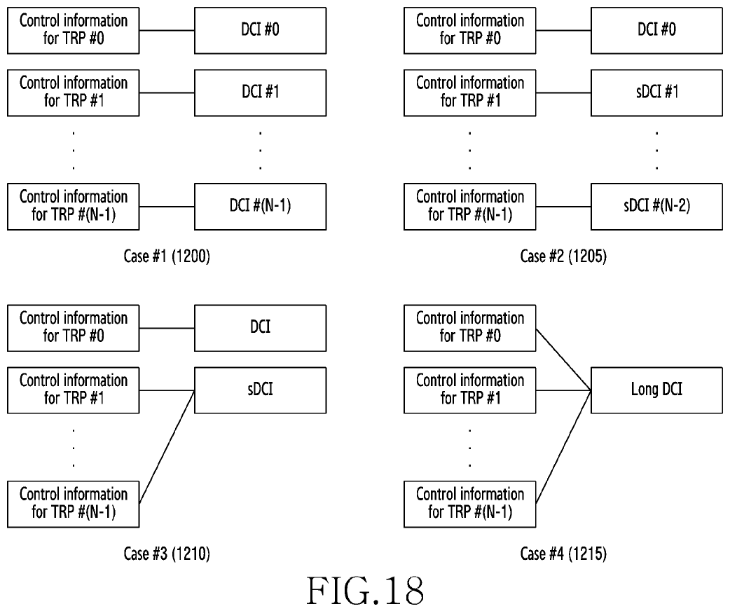

FIG. 18 illustrates a configuration example of downlink control information (DCI) for NC-JT wherein respective TRPs transmit different PDSCHs or different PDSCH layers to a terminal in a wireless communication system according to an embodiment of the disclosure.

Referring to FIG. 18, case #1 1200 according to an embodiment is an example in which, in a situation where different (N−1) number of PDSCHs are transmitted from additional (N−1) number of TRPs (TRP #1 to TRP #(N−1)) other than a serving TRP (TRP #0) used at the time of single PDSCH transmission, control information for the PDSCHs transmitted from the additional (N−1) number of TRPs is transmitted independently to control information for a PDSCH transmitted from the serving TRP. That is, a terminal may obtain control information for PDSCHs transmitted from different TRPs (TRP #0 to TRP #(N−1)) through independent pieces of DCI (DCI #0 to DCI #(N−1)). The formats of the independent pieces of DCI may be identical to or different from each other, and the payloads of the pieces of DCI may also be identical to or different from each other. In case #1 described above, free control or allocation of each PDSCH may be completely ensured, but when pieces of DCI are transmitted from different TRPs, there occurs a difference in coverage between the pieces of DCI and thus reception performance may be degraded.

According to an embodiment, case #2 1205 shows an example in which, in a situation where different (N−1) number of PDSCHs are transmitted from additional (N−1) number of TRPs (TRP #1 to TRP #(N−1)) other than a serving TRP (TRP #0) used at the time of single PDSCH transmission, pieces of control information (DCI) for the PDSCHs of the additional (N−1) number of TRPs are transmitted respectively, and each of the pieces of control information is dependent on control information for a PDSCH transmitted from the serving TRP.

For example, DCI #0 that is the control information for the PDSCH transmitted from the serving TRP (TRP #0) includes all information elements of DCI format 1_0, DCI format 1_1, or DCI format 1_2, but shortened DCI (hereinafter, sDCI) (sDCI #0 to sDCI #(N−2)) that is control information for PDSCHs transmitted from cooperative TRPs (TRP #1 to TRP #(N−1)) may include only some of information elements of DCI format 1_0, DCI format 1_1, or DCI format 1_2. Therefore, sDCI transmitting control information for PDSCHs transmitted from the cooperative TRPs has a payload smaller than that of normal DCI (nDCI) transmitting control information related to a PDSCH transmitted from the serving TRP, and thus is able to include reserved bits compared to nDCI.

According to an embodiment, in case #2, free control or allocation of each PDSCH may be limited according to the contents of information elements included in sDCI, but the reception performance of sDCI is superior than nDCI, and thus a probability that a difference in coverage between pieces of DCI may occur may be lowered.

According to an embodiment, case #3 1210 shows an example in which, in a situation where different (N−1) number of PDSCHs are transmitted from additional (N−1) number of TRPs (TRP #1 to TRP #(N−1)) other than a serving TRP (TRP #0) used at the time of single PDSCH transmission, one piece of control information for the PDSCHs of the additional (N−1) number of TRPs is transmitted, and the piece of control information is dependent on control information for a PDSCH transmitted from the serving TRP.

For example, DCI #0 that is the control information for the PDSCH transmitted from the serving TRP (TRP #0) may include all information elements of DCI format 1_0, DCI format 1_1, or DCI format 1_2. In a case of control information for PDSCHs transmitted from cooperative TRPs (TRP #1-TRP #(N−1)), it is possible to group only some pieces of information elements of DCI format 10, DCI format 1_1, or DCI format 1_2 into one pieces of “secondary DCI” (sDCI) and transmit same. For example, the sDCI may include at least one piece of information among pieces of HARQ-related information, such as frequency domain resource assignment resource assignment, time domain resource assignment, or MCS of cooperative TRPs. Other information not included in sDCI, such as a bandwidth part (BWP) indicator or a carrier indicator, may be determined based on DCI (DCI #0, normal DCI, or nDCI) of the serving TRP.

According to an embodiment, case #3 1210, free control or allocation of each PDSCH may be limited according to the contents of information elements included in sDCI, but the reception performance of sDCI is controllable and the complexity of DCI blind decoding of a terminal may be reduced compared to case #1 1200 or case #2 1205.

According to an embodiment, case #4 1215 is an example in which, in a situation where different (N−1) number of PDSCHs are transmitted from additional (N−1) number of TRPs (TRP #1-TRP #(N−1)) other than a serving TRP (TRP #0) used at the time of single PDSCH transmission, control information for the PDSCHs transmitted from the additional (N−1) number of TRPs is transmitted through the same DCI (long DCI) as that of control information for a PDSCH transmitted from the serving TRP. That is, a terminal may obtain control information for PDSCHs transmitted from different TRPs (TRP #0-TRP #(N−1)) through single DCI. In case of case #4 1215, the complexity of DCI blind decoding of the terminal may not be increased, but a PDSCH may not be freely controlled or allocated like limitation of the number of cooperative TRPs caused by the limitation of a long DCI payload.

In the following description and embodiments, sDCI may be referred to as various pieces of auxiliary DCI, such as shortened DCI, secondary DCI, or normal DCI (DCI format 1_0 or 1_1 described above) including PDSCH control information transmitted from a cooperative TRP, and if there is no special explicit limitation, the corresponding description is similarly applicable to the various pieces of auxiliary DCI.

In the following description and embodiments, case #1 1200, case #2 1205, and case #3 1210 described above in which one or more pieces of DCI (PDCCHs) are used for NC-JT support may be classified as NC-JT based on multiple PDCCHs. Case #4 1215 described above in which single DCI (PDCCH) is used for NC-JT support may be classified as NC-JT based on a single PDCCH. In PDSCH transmission based on multiple PDCCHs, a CORESET in which DCI of a serving TRP (TRP #0) is scheduled may be distinguished from a CORESET in which DCI of cooperative TRPs (TRP #1 to TRP #(N−1)) is scheduled. As a method for distinguishing CORESETs, there may be a method of distinguishment using a higher layer indicator for each CORESET or a method of distinguishment using beam configuration for each CORESET. In addition, in NC-JT based on a single PDCCH, single DCI schedules a single PDSCH having multiple layers rather than scheduling multiple PDSCHs, and the multiple layers may be transmitted from multiple TRPs. The connection relation between a layer and a TRP transmitting the layer may be indicated through a transmission configuration indicator (TCI) indication.

In embodiments of the disclosure, a “cooperative TRP” may be replaced with various terms including a “cooperative panel” or a “cooperative beam,” when actually applied.

In embodiments of the disclosure, “a case where NC-JT is applied” is variously interpretable in accordance with a situation as “a case where a terminal simultaneously receives one or more PDSCHs in one BWP,” “a case where a terminal receives a PDSCH, based on two or more TCI indications simultaneously, in one BWP,” and “a case where a PDSCH received by a terminal is associated with one or more DMRS port groups.” However, for convenience of explanation, one expression is used.

In the disclosure, a wireless protocol structure for NC-JT may be variously used according to a TRP-based scenario. For example, if there is no or a small backhaul delay between cooperative TRPs, a method (CA-like method) using a structure based on MAC layer multiplexing similarly to structure S10 in FIG. 4 is possible. On the contrary, if a backhaul delay between cooperative TRPs is large and is thus not ignorable (e.g., a time of 2 ms or longer is required for exchange of information, such as CSI, scheduling, or HARQ-ACK, between cooperative TRPs), a method of using a TRP-specific independent structure from an RLC layer, similarly to structure S20 in FIG. 4, so as to ensure a characteristic resistant to delays is possible.

According to an embodiment, a terminal supporting C-JT and/or NC-JT may receive a parameter or setting value related to C-JT and/or NC-JT from a higher layer configuration, and set an RRC parameter of the terminal, based on the parameter or setting value related to C-JT and/or NC-JT. The terminal may use a UE capability parameter, for example, tci-StatePDSCH for the higher layer configuration. For example, the UE capability parameter (e.g., tci-StatePDSCH) may define TCI states for PDSCH transmission. The number of TCI states may be configured to be 4, 8, 16, 32, 64, or 128 in FR 1 and 64 and 128 in FR 2, and a maximum of 8 states indicatable by 3 bits of a TCI field of DCI may be configured among the configured number of TCI states through a MAC CE message. The maximum value 128 means a value indicated by maxNumberConfiguredTCIstatesPerCC in a tci-StatePDSCH parameter included in capability signaling of the terminal. As described above, a series of configuration processes from higher layer configuration to MAC CE configuration may be applied to a beamforming indication or beamforming change command for at least one PDSCH from one TRP.

As an embodiment of the disclosure, a multi-DCI-based multi-TRP transmission method is described. In the multi-DCI-based multi-TRP transmission method, a downlink control channel for NC-JT transmission may be configured based on multiple PDCCHs.

In NC-JT based on multiple PDCCHs, at the time of DCI transmission for scheduling a PDSCH of each TRP, a CORESET or a search space distinguished for each TRP may be provided. The CORESET or search space for each TRP may be configured according to at least one of the following cases.
Configuration of higher layer index for each CORESET: CORESET configuration information configured by a higher layer may include an index value, and the configured index value for each CORESET may be used to distinguish a TRP transmitting a PDCCH in a corresponding CORESET. That is, in a set of CORESETs having the same higher layer index value, it may be considered that the same TRP transmits a PDCCH or a PDCCH scheduling a PDSCH of the same TRP is transmitted. The index for each CORESET may be called CORESETPoolIndex, and it may be considered that a PDCCH is transmitted from the same TRP in CORESETs configured to have the same value of CORESETPoolIndex. For a CORESET for which a value of CORESETPoolIndex is not configured, it may be considered that a default value of CORESETPoolIndex is configured, and the default value may be 0.
   In the disclosure, if the number of CORESETPoolIndex types of multiple CORESETs included in the higher layer signaling PDCCH-Config exceeds 1, that is, if each CORESET has a different value of CORESETPoolIndex, a terminal may consider that a base station is able to use a multi-DCI-based multi-TRP transmission method.
   On the contrary, in the disclosure, if the number of CORESETPoolIndex types of multiple CORESETs included in the higher layer signaling PDCCH-Config is 1, that is, if all the CORESETs have the same value of CORESETPoolIndex, such as 0 or 1, a terminal may consider that a base station performs transmission by using a single TRP without using a multi-DCI-based multi-TRP transmission method.
Configuration of multiple values of PDCCH-Config: Multiple values of PDCCH-Config is configured in one BWP, each value of PDCCH-Config may include a TRP-specific PDCCH configuration. That is, a CORESET list for each TRP and/or a search space list for each TRP may be configured in one value of PDCCH-Config, and one or more CORESETs and one or more search spaces included in one value of PDCCH-Config may be considered to correspond to a particular TRP.
Configuration of CORESET beam/beam group: Through a beam or beam group configured for each CORESET, a TRP corresponding to a corresponding CORESET may be distinguished. For example, if the same TCI state is configured for multiple CORESETs, it may be assumed that the CORESETs are transmitted through the same TRP or a PDCCH scheduling a PDSCH of the same TRP is transmitted in the CORESETs.
Configuration of search space beam/beam group: A beam or beam group is configured for each search space, and a TRP for each search space may be distinguished therethrough. For example, if the same beam/beam group or TCI state is configured for multiple search spaces, it may be assumed that the same TRP transmits a PDCCH in the search spaces or a PDCCH scheduling a PDSCH of the same TRP is transmitted in the search spaces.

A CORESET or search space is distinguished for each TRP, whereby PDSCH and HARQ-ACK information classification for each TRP may be possible and thus independent HARQ-ACK codebook generation and independent PUCCH resource usage for each TRP is also possible.

This configuration for a CORESET may be independent for each cell or each BWP. For example, two different values of CORESETPoolIndex may be configured in a Pcell, and on the contrary, a value of CORESETPoolIndex may not be configured in a particular SCell. In this case, it may be assumed that NC-JT is configured in the PCell, but NC-JT is not configured in the SCell in which a value of CORESETPoolIndex is not configured.

According to an embodiment, a PDSCH TCI state activation/deactivation MAC-CE which is applicable to a multi-DCI-based multi-TRP transmission method may follow FIG. 16. If CORESETPoolIndex for all CORESETs in the higher layer signaling PDCCH-Config is not configured for a terminal, the terminal may disregard a CORESET pool ID field 755 in the MAC-CE 750. If the terminal is able to support a multi-DCI-based multi-TRP transmission method, that is, if CORESETs in the higher layer signaling PDCCH-Config have different values of CORESETPoolIndex, the terminal may activate a TCI state in DCI included in a PDCCH transmitted in CORESETs having the same value of CORESETPoolIndex as that of the CORESET pool ID field 755 in the MAC-CE 750. For example, if the value of the CORESET pool ID field 755 in the MAC-CE 750 is 0, a TCI state in DCI included in a PDCCH transmitted from CORESETs having CORESETPoolIndex of 0 may follow activation information of the MAC-CE or may be determined based on the activation information.

According to an embodiment, in a case where a terminal is configured by a base station to be able to use a multi-DCI-based multi-TRP transmission method (e.g., in a case where the number of CORESETPoolIndex types of multiple CORESETs included in the higher layer signaling PDCCH-Config exceeds 1, or in a case where each CORESET has a different value of CORESETPoolIndex), the terminal may recognize that PDSCHs scheduled by PDCCHs in respective CORESETs having two different values of CORESETPoolIndex have the following restrictions.

1) If PDSCHs indicated by PDCCHs in respective CORESETs having two different values of CORESETPoolIndex entirely or partially overlap with each other, the terminal may apply TCI states indicated by the PDCCHs, to different CDM groups, respectively. That is, two or more TCI states may not be applied to one CDM group.

2) If PDSCHs indicated by PDCCHs in respective CORESETs having two different values of CORESETPoolIndex entirely or partially overlap with each other, the terminal may expect or identify that the PDSCHs have the same number of actual front loaded DMRS symbols, the same number of actual additional DMRS symbols, the same position of an actual DMRS symbol, and/or the same DMRS type.

3) The terminal may expect or identify that bandwidth parts indicated by PDCCHs in respective CORESETs having two different values of CORESETPoolIndex are the same and the subcarrier spacings thereof are also the same.

4) The terminal may expect or identify that information on a PDSCH scheduled by a PDCCH in each of CORESETs having two different values of CORESETPoolIndexs is fully included in a corresponding PDCCH.

As an embodiment of the disclosure, a single-DCI-based multi-TRP transmission method is described. In the single-DCI-based multi-TRP transmission method, a downlink control channel for NC-JT may be configured based on a single PDCCH.

According to an embodiment, in a single-DCI-based multi-TRP transmission method, a PDSCH transmitted by multiple TRPs may be scheduled by one DCI. As a method of indicating the number of TRPs transmitting the PDSCH, the number of TCI states may be used. For example, if the number of TCI states indicated in DCI scheduling a PDSCH is 2, transmission may be considered or identified as single PDCCH-based NC-JT. For example, if the number of TCI states is 1, transmission may be considered or identified as single TRP transmission. TCI states indicated in DCI may correspond to one or two TCI states among TCI states activated by a MAC-CE. If TCI states of DCI may correspond to two TCI states activated by a MAC-CE, a TCI codepoint indicated in DCI and the TCI states activated by the MAC-CE may have a correspondence relation, and this may correspond to a case where the number of TCI states activated by a MAC-CE and corresponding to a TCI codepoint is 2.

As another example, if at least one codepoint among all codepoints of a TCI state field in DCI indicates two TCI states, a terminal may consider that a base station is able to perform transmission based on a single-DCI-based multi-TRP transmission method. The at least one codepoint of the TCI state field indicating two TCI states may be activated through an enhanced PDSCH TCI state activation/deactivation MAC-CE.

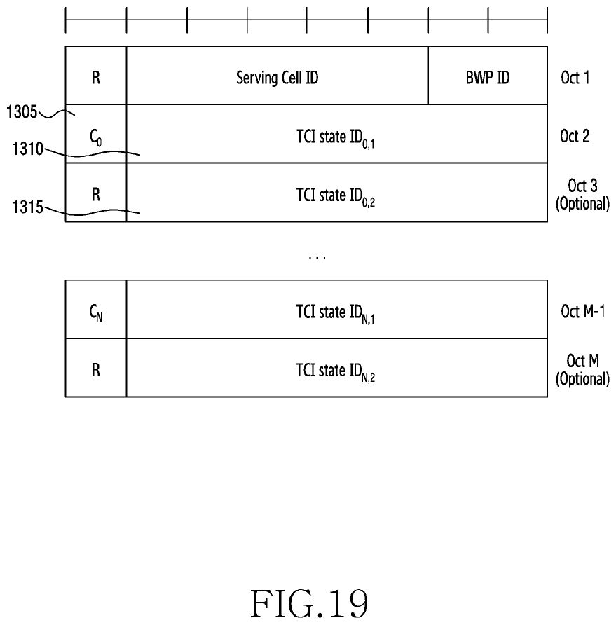

FIG. 19 illustrates an enhanced PDSCH TCI state activation/deactivation MAC-CE structure. The meaning of each field in the MAC CE and a value available in each field may be shown as in [Table 31] below.

TABLE 31
Serving Cell ID: This field indicates the identity of the Serving Cell for which the
MAC CE applies. The length of the field is 5 bits. If the indicated Serving Cell is configured as
part of a simultaneousTCI-UpdateList1 or simultaneousTCI-UpdateList2 as specified in TS
38.331, this MAC CE applies to all the Serving Cells configured in the set simultaneousTCI-
UpdateList1 or simultaneousTCI-UpdateList2, respectively;
BWP ID: This field indicates a DL BWP for which the MAC CE applies as the
codepoint of the DCI bandwidth part indicator field as specified in TS 38.212. The length of the
BWP ID field is 2 bits;
Cᵢ: This field indicates whether the octet containing TCI state ID_{i, 2} is present. If this
field is set to “1”, the octet containing TCI state ID_{i, 2} is present. If this field is set to “0”, the octet
containing TCI state ID_{i, 2} is not present;
TCI state ID_{i, j}: This field indicates the TCI state identified by TCI-StateId as specified
in TS 38.331, where i is the index of the codepoint of the DCI Transmission configuration
indication field as specified in TS 38.212 and TCI state Id_{i, j} denotes the j-th TCI state indicated
for the i-th codepoint in the DCI Transmission Configuration Indication field. The TCI codepoint
to which the TCI States are mapped is determined by its ordinal position among all the TCI
codepoints with sets of TCI state Id_{i, j} fields, i.e., the first TCI codepoint with TCI state ID_{0, 1} and
TCI state ID_{0, 2} shall be mapped to the codepoint value 0, the second TCI codepoint with TCI
state ID_{1, 1} and TCI state ID_{1, 2} shall be mapped to the codepoint value 1 and so on. The TCI state
ID_{i, 2} is optional based on the indication of the Ci field. The maximum number of activated TCI
codepoint is 8 and the maximum number of TCI states mapped to a TCI codepoint is 2.
R: Reserved bit, set to “0”.

In FIG. 19, if a value of a C0 field 1305 is 1, the MAC-CE may include a TCI state ID0,2 field 1315 in addition to TCI state ID0,1 field 1310. This implies that TCI state ID0,1 and TCI state ID0,2 are activated for a 0-th codepoint of a TCI state field included in DCI, and if a base station indicates the codepoint to a terminal, two TCI states may be indicated to the terminal. If a value of the C0 field 1305 is 0, the MAC-CE is unable to include the TCI state ID0,2 field 1315, and this implies that one TCI state corresponding to TCI state ID0,1 is activated for a 0-th codepoint of a TCI state field included in DCI.

This configuration may be independent for each cell or each BWP. For example, the number of activated TCI states corresponding to one TCI codepoint is a maximum of 2 in a PCell, but the number of activated TCI states corresponding to one TCI codepoint may be a maximum of 1 in a particular SCell. In this case, it may be considered that NC-JT is configured in the PCell, but NC-JT is not configured in the SCell.

Next, a method of distinguishing a single-DCI-based multi-TRP PDSCH repetitive transmission technique is described. Different single-DCI-based multi-TRP PDSCH repetitive transmission techniques (e.g., TDM, FDM, and SDM) may be indicated to a terminal by a base station according to a value indicated by a DCI field and a higher layer signaling configuration. [Table 32] below shows a method of distinguishing between single or multi-TRP-based techniques indicated to a terminal according to a value of a particular DCI field and a higher layer signaling configuration.

TABLE 32

| | | | repetitionNumber | | Transmission |
|---|---|---|---|---|---|
| | TCI | CDM | configuration | Related to | technique |
| | state | group | and indication | repetitionScheme | indicated to |
| Combination | Number | Number | condition | configuration | terminal |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP |
| | | | | | TDM scheme B |

In [Table 32], each column may be described as follows.
Number of TCI states (second column): This indicates the number of TCI states indicated by a TCI state field in DCI, and for example, may be 1 or 2.
Number of CDM groups (third column): This indicates the number of different CDM groups of DMRS ports indicated by an antenna port field in DCL. For example, same may be 1, 2, or 3.
repetitionNumber configuration and indication condition (fourth column): There may be three conditions according to whether repetitionNumber is configured for all TDRA entries indicatable by a time domain resource allocation field in DCI, and whether an actually indicated TDRA entry has a repetitionNumber configuration.
   Condition 1: At least one of all TDRA entries indicatable by a time domain resource allocation field includes a configuration on repetitionNumber, and a TDRA entry indicated by a time domain resource allocation field in DCI includes a configuration on repetitionNumber greater than 1
   Condition 2: At least one of all TDRA entries indicatable by a time domain resource allocation field includes a configuration on repetitionNumber, and a TDRA entry indicated by a time domain resource allocation field in DCI does not include a configuration on repetitionNumber
   Condition 3: All TDRA entries indicatable by a time domain resource allocation field do not include a configuration on repetitionNumber
Related to repetitionScheme configuration (fifth column): This indicates whether the higher layer signaling repetitionScheme is configured. As the higher layer signaling repetitionScheme, one of “tdmSchemeA,” “fdmSchemeA,” and “fdmSchemeB” may be configured.
Transmission technique indicated to terminal (sixth column): This indicates single or multi-TRP techniques indicated by combinations (first column) represented in [Table 32] above.
   Single-TRP: This indicates single-TRP-based PDSCH transmission. If pdsch-AggegationFactor in the higher layer signaling PDSCH-config is configured for a terminal, single-TRP-based PDSCH repetitive transmission performed configured times may be scheduled for the terminal. Otherwise, single-TRP-based PDSCH single transmission may be scheduled for the terminal.
   Single-TRP TDM scheme B: This indicates single-TRP-based inter-slot time resource division-based PDSCH transmission. According to condition 1 related to repetitionNumber described above, a terminal repeats PDSCH transmission on the time domain in a number of slots equal to the count of repetitionNumber greater than 1 configured in a TDRA entry indicated by a time domain resource allocation field. The terminal applies a start symbol and a symbol length of a PDSCH indicated by the TDRA entry identically for the slots, the number of which is equal to the count of repetitionNumber, and applies the same TCI state to every PDSCH repetitive transmission. The above technique is similar to a slot aggregation scheme in that inter-slot PDSCH repetitive transmission is performed on time resources, but differs from slot aggregation in that whether repetitive transmission is indicated may be dynamically determined based on a time domain resource allocation field in DCI.
   Multi-TRP SDM: This means a multi-TRP-based spatial resource division PDSCH transmission scheme. This is a method of receiving distributed layers from TRPs, and is not a repetitive transmission scheme, but may increase the reliability of PDSCH transmission in that the number of layers is increased to enable transmission at a lowered code rate. A terminal may apply two TCI states indicated through a TCI state field in DCI to two CDM groups indicated by a base station, respectively, so as to receive a PDSCH.
   Multi-TRP FDM scheme A: This means a multi-TRP-based frequency resource division PDSCH transmission scheme. This scheme provides one PDSCH transmission occasion and thus is not repetitive transmission like multi-TRP SDM. However, the amount of frequency resources is increased to lower a code rate and thus enable transmission with high reliability. Multi-TRP FDM scheme A may apply two TCI states indicated through a TCI state field in DCI to frequency resources not overlapping each other, respectively. In a case where a PRB bundling size is determined to be a wideband, if the number of RBs indicated by a frequency domain resource allocation field is N, a terminal applies a first TCI state to a first ceil(N/2) number of RBs, and applies a second TCI state to the remaining floor(N/2) number of RBs so as to perform reception. Here, ceil(·) and floor(·) are operators indicating rounding up and down for one decimal place. If a PRB bundling size is determined to be 2 or 4, the first TCI state is applied to even-numbered PRGs, and the second TCI state is applied to odd-numbered PRGs for reception.
   Multi-TRP FDM scheme B: This means a multi-TRP-based frequency resource division PDSCH repetitive transmission scheme, and provides two PDSCH transmission occasions to repeat PDSCH transmission at the respective occasions. In the same way as multi-TRP FDM scheme A, multi-TRP FDM scheme B may also apply two TCI states indicated through a TCI state field in DCI to frequency resources not overlapping each other, respectively. In a case where a PRB bundling size is determined to be a wideband, if the number of RBs indicated by a frequency domain resource allocation field is N, a terminal applies a first TCI state to a first ceil(N/2) number of RBs, and applies a second TCI state to the remaining floor(N/2) number of RBs so as to perform reception. Here, ceil(·) and floor(·) are operators indicating rounding up and down for one decimal place. If a PRB bundling size is determined to be 2 or 4, the first TCI state is applied to even-numbered PRGs, and the second TCI state is applied to odd-numbered PRGs for reception.
   Multi-TRP TDM scheme A: This means a multi-TRP-based time resource division intra-slot PDSCH repetitive transmission scheme. A terminal may have two PDSCH transmission occasions in one slot, and a first reception occasion may be determined based on a start symbol and a symbol length of a PDSCH indicated through a time domain resource allocation field in DCI. A start symbol of a second reception occasion of the PDSCH may be a position obtained by applying a symbol offset of the higher layer signaling StartingSymbolOffsetK to a last symbol of the first transmission occasion, and the transmission occasion may be determined to be an occasion as long as the indicated symbol length from the position. If the higher layer signaling StartingSymbolOffsetK is not configured, a symbol offset may be considered as 0.
   Multi-TRP TDM scheme B: This means a multi-TRP-based time resource division inter-slot PDSCH repetitive transmission scheme. A terminal may have one PDSCH transmission occasion in one slot, and receive repetitive transmission, based on the same PDSCH start symbol and symbol length during a number of slots corresponding to the count of repetitionNumber indicated through a time domain resource allocation field in DCI. If repetitionNumber is 2, the terminal may receive PDSCH repetitive transmission in first and second slots by applying first and second TCI states, respectively. If repetitionNumber is greater than 2, the terminal may use different TCI state application schemes according to which the higher layer signaling tciMapping is configured to be. If tciMapping is configured to be cyclicMapping, the terminal applies first and second TCI states to first and second PDSCH transmission occasions, respectively, and also applies this TCI state application method to the remaining PDSCH transmission occasions in the same way. If tciMapping is configured to be sequenticalMapping, the terminal applies a first TCI state to first and second PDSCH transmission occasions, applies a second TCI state to third and fourth PDSCH transmission occasions, respectively, and also applies this TCI state application method to the remaining PDSCH transmission occasions in the same way.

Hereinafter, an embodiment of the disclosure will be described in detail with reference to the accompanying drawings. The contents in the disclosure are applicable to frequency division duplex (FDD) and time division duplex (TDD) systems. Hereinafter, in the disclosure, higher signaling (or higher layer signaling) is a signal transfer method in which a signal is transferred to a terminal by a base station by using a physical layer downlink data channel, or is transferred to a base station by a terminal by using a physical layer uplink data channel. The higher signaling may be mentioned to as RRC signaling, PDCP signaling, or a medium access control (MAC) control element (MAC CE).

Hereinafter, in the disclosure, a terminal may, when determining whether cooperative communication is applied, use various methods including a case where a PDCCH(s) allocating a PDSCH to which cooperative communication is applied has a particular format, a case where a PDCCH(s) allocating a PDSCH to which cooperative communication is applied includes a particular indicator indicating whether cooperative communication is applied, a case where a PDCCH(s) allocating a PDSCH to which cooperative communication is applied is scrambled by a particular RNTI, or a case where cooperative communication application is assumed in a particular interval indicated by a higher layer. In the following description, for convenience of explanation, a terminal receiving a PDSCH to which cooperative communication is applied, based on conditions similar to the above cases is called a NC-JT case.

Hereinafter, determining priorities between A and B in the disclosure may be variously mentioned as selecting which has a higher priority according to a predetermined priority rule and performing an operation corresponding thereto or omitting or dropping an operation for which has a lower priority.

Hereinafter, in the disclosure, the examples described above will be explained through multiple embodiments. However, the embodiments are not independent, and one or more embodiments are applicable simultaneously or in combination.

For convenience in the following description of in disclosure, a cell, a transmission point, a panel, a beam, and/or a transmission direction, which is distinguishable by a higher layer/L1 parameter, such as TCI states or spatial relation information, or by an indicator, such as a cell ID, a TRP ID, or a panel ID, may be described collectively as a transmission reception point (TRP), a beam, or a TCI state. Therefore, in practical application, a TRP, a beam, or a TCI state is properly replaceable with one of the terms.

Hereinafter, in the disclosure, a terminal may, when determining whether cooperative communication is applied, use various methods including a case where a PDCCH(s) allocating a PDSCH to which cooperative communication is applied has a particular format, a case where a PDCCH(s) allocating a PDSCH to which cooperative communication is applied includes a particular indicator indicating whether cooperative communication is applied, a case where a PDCCH(s) allocating a PDSCH to which cooperative communication is applied is scrambled by a particular RNTI, or a case where cooperative communication application is assumed in a particular interval indicated by a higher layer. In the following description, for convenience of explanation, a terminal receiving a PDSCH to which cooperative communication is applied, based on conditions similar to the above cases is called a NC-JT case.

Hereinafter, an embodiment of the disclosure will be described in detail with reference to the accompanying drawings. Hereinafter, a base station is a subject which performs resource allocation for a terminal, and may be at least one of a gNode B, a gNB, an eNode B, a Node B, a base station (BS), a wireless access unit, a base station controller, or a node on a network. A terminal may include a user equipment (UE), a mobile station (MS), a cellular phone, a smartphone, a computer, or a multimedia system capable of a communication function. In the following description, an embodiment of the disclosure is described by using a 5G system as an example, but the embodiment of the disclosure may be applied to other communication systems having similar technical backgrounds or channel form. For example, the communication systems may include LTE or LTE-A mobile communication, and mobile communication technology developed after 5G. Therefore, an embodiment of the disclosure may be also applied to other communication systems through partial modification without departing too far from the scope of the disclosure according to the determination of a person skilled in the art. The contents in the disclosure are applicable to FDD and TDD systems.

In addition, in describing the disclosure, a detailed description of relevant functions or configurations will be omitted when it may make the subject matter of the disclosure rather unclear. The terms as described below are defined in consideration of functions in the disclosure and may vary according to the intention of a user or operator, convention, or the like. Therefore, the definitions of the terms should be made based on the contents throughout the specification.

Hereinafter, in describing the disclosure, higher layer signaling may be signaling corresponding to at least one of the following signalings or a combination of one or more:
Master information block (MIB);
System information block (SIB) or SIB X (X=1, 2, . . . );
Radio resource control (RRC); and/or
Medium access control (MAC) control element (CE).

In addition, L1 signaling may be signaling corresponding to at least one of signaling methods using the following physical layer channels or signalings or a combination of one or more:
Physical downlink control channel (PDCCH);
Downlink control information (DCI);
UE-specific DCI;
Group common DCI;
Common DCI;
Scheduling DCI (e.g., DCI used for scheduling downlink or uplink data);
Non-scheduling DCI (e.g., DCI not for scheduling downlink or uplink data);
Physical uplink control channel (PUCCH); and/or
Uplink control information (UCI).

Hereinafter, determining priorities between A and B in the disclosure may be variously mentioned as selecting which has a higher priority according to a predetermined priority rule and performing an operation corresponding thereto or omitting or dropping an operation for which has a lower priority.

Hereinafter, the term “slot” used in the disclosure is a general term capable of indicating a particular time unit corresponding to a transmit time interval (TTI) and may specifically mean a slot used in a 5G NR system or a slot or subframe used in a 4G LTE system.

Hereinafter, in the disclosure, the examples described above will be explained through multiple embodiments. However, the embodiments are not independent, and one or more embodiments are applicable simultaneously or in combination.

### <Default Beam Operation Considering PDSCH Reception in Unified TCI Scheme>

As an embodiment of the disclosure, an operation in which, when operating in a unified TCI state scheme, a terminal uses a default beam (default beam, default TCI, or default QCL) to receive a multi-TRP-based PDSCH is described. The embodiment may be operated in combination with all the embodiments of the disclosure.

A TCI state mentioned in an embodiment may indicate a joint TCI, a separate DL TCI, or a separate UL TCI.

A default beam mentioned in an embodiment may indicate a default TCI state or a default QCL assumption.

According to an embodiment, when a terminal receives a PDCCH from a base station, until reception and decoding of the PDCCH is ended, the terminal is unable to know whether scheduling information is included in the PDCCH and is unable to know scheduling information if the scheduling information is included. Therefore, the terminal may receive and store, in a buffer, a downlink signal by using a default beam, before passage of a beam change time reported as a terminal capability to the base station. Therefore, if the base station is to schedule, for the terminal, a PDSCH earlier than a time point indicated by a terminal capability value related to a reception beam change time reported by the terminal, the base station may transmit the PDSCH to the terminal by using a default beam assumed by the terminal.

In a case of a unified TCI state scheme, a TCI state is indicated to a terminal by a base station through a PDCCH, and the terminal may perform downlink reception and uplink transmission using the indicated TCI state from a first slot after a number of symbols corresponding to a beam application time (BAT) after a last symbol of PUCCH transmission including information relating to whether reception of the PDCCH is successful. If the terminal operates in a unified TCI state scheme, the terminal may apply the TCI state indicated by the base station to time resources starting from the defined time resource. For example, the defined time resource may be a first slot after a number of symbols corresponding to a BAT after a last symbol of PUCCH transmission including information relating to whether reception of a PDCCH is successful, after a TCI state is indicated to a terminal by a base station through the PDCCH. Therefore, before passage of a time interval of timeDurationForQCL after a last symbol of PDCCH reception, if a time point of the last symbol of the PDCCH reception of the terminal is included in the defined time resource, the terminal may perform downlink channel reception through the indicated TCI state without defining a default beam to be used before passage of the time interval of timeDurationForQCL after the last symbol of the PDCCH reception. For example, timeDurationForQCL may be a terminal capability related to a reception beam change time reported by the terminal.

However, according to which physical cell ID (PCID) to which a TCI state indicated to a terminal is connected, the terminal is required to define a default beam to be used before passage of a time interval of timeDurationForQCL, which is a terminal capability related to a reception beam change time reported by the terminal, after a last symbol of PDCCH reception.

If a TCI state indicated to a terminal is connected to a PCID of a serving cell, that is, if both downlink channel reception and uplink transmission are performed with a TRP having a PCID of a serving cell through a unified TCI state scheme, the terminal may perform, through the indicated TCI state, both reception of a (UE-dedicated) PDSCH that is transmitted specifically to the terminal from a base station and reception of a (non-UE dedicated, UE common, or broadcast) PDSCH that is transmitted commonly to all terminals including the terminal.

However, if a TCI state indicated to a terminal is connected to a PCID different from that of a serving cell, that is, if both downlink channel reception and uplink transmission are performed with a TRP having a PCID different from that of a serving cell through a unified TCI state scheme, the terminal may perform, through the indicated TCI state, reception of a (UE-dedicated) PDSCH that is transmitted specifically to the terminal from a base station. However, only terminals supporting an inter-cell beam management function are able to perform PDSCH reception by using a TCI state connected to a PCID different from that of a serving cell, and thus the terminal may not be able to perform, through the indicated TCI state, reception of a (non-UE dedicated, UE common, or broadcast) PDSCH that is transmitted commonly to all terminals including the terminal. In addition, until PDCCH reception and decoding, the terminal is unable to know whether the PDCCH includes PDSCH scheduling information, and if the PDCCH includes scheduling information, whether the PDSCH is a terminal-specifically transmitted PDSCH or a terminal-commonly transmitted PDSCH. Therefore, the terminal may define a default beam to be used before passage of a time interval of timeDurationForQCL, which is a terminal capability related to a reception beam change time reported by the terminal, after a last symbol of PDCCH reception, and may define a default beam other than a unified TCI state indicated by the base station before the passage of the time interval of timeDurationForQCL and receive a downlink channel including a PDSCH.

If the higher layer signaling tci-PresentInDCI and tci-PresentInDCI-1-2 are configured or not configured for a terminal, a scheduling offset between a PDCCH and a PDSCH is shorter than timeDurationForQCL that is a reference time descried above, the terminal is in an RRC-connected mode, at least one TCI state configured by higher layer signaling in a corresponding serving cell includes QCL-TypeD as qcl-Type information, and the higher layer signaling followUnifiedTCIstate is configured or not configured, the terminal may perform an operation corresponding to the following conditions according to same.
Regardless of whether the higher layer signaling SSB-MTCAdditionalPCI is configured or not configured for the terminal by a base station, if a TCI state indicated to the terminal by the base station is connected to a PCID of a serving cell, the terminal may receive a PDSCH by applying the indicated TCI state.
If the higher layer signaling SSB-MTCAdditionalPCI is configured for the terminal by the base station and a TCI state indicated by the base station is different from a PCID of a serving cell, the terminal may use, when a PDSCH is received, a TCI state configured or activated for a control resource set having the lowest control resource set index among at least one control resource set monitorable in a slot closest to the PDSCH, or a QCL assumption of the lowest control resource set.
   In case of carrier aggregation (CA), if values of QCL-TypeD for a PDSCH DMRS in several subcarriers in one band in one slot are different from each other, the terminal may apply QCL-TypeD for a PDSCH of a subcarrier having the lowest ID in the band to QCL-TypeD assumptions for the PDSCH DMRS in all subcarriers in the band.
   If QCL-TypeD applied to a PDSCH DMRS is different from QCL-TypeD applied to a DMRS of a PDCCH overlapping with a corresponding PDSCH on at least one OFDM symbol, the terminal may use QCL-TypeD of an overlapping control resource set to receive the PDSCH and the control resource set. One TCI state may be activated or indicated for the control resource set. Alternatively, there may be no limit to the number of TCI states for the control resource set. The operation may be applicable even in the same carrier or different carriers in a band (intra-band CA).

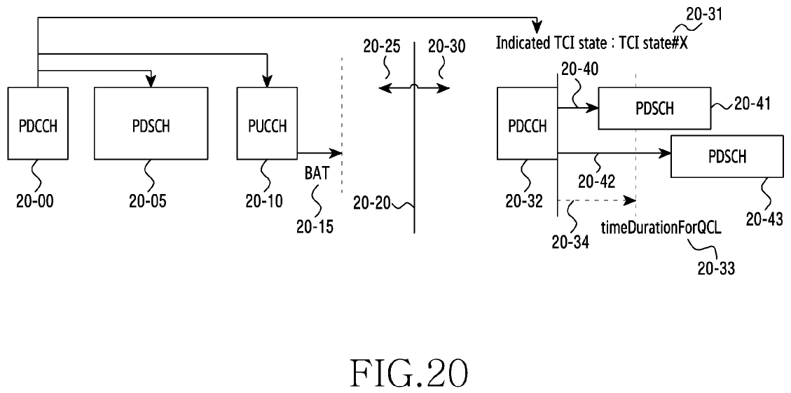

FIG. 20 illustrates a default beam operation when a unified TCI state-based PDSCH is received according to an embodiment of the disclosure.

Referring to FIG. 20, a terminal may receive, from a base station, DCI format 1_1 or 1_2 including or not including downlink data channel scheduling information (with DL assignment or without DL assignment), and the terminal may apply one joint TCI state or one separate TCI state set indicated by a TCI state field in the DCI to uplink transmission and downlink reception beams.

According to an embodiment, if a terminal receives, from a base station, DCI format 1_1 or 1_2 including downlink data channel scheduling information (20-00) and one joint TCI state or one separate TCI state set based on a unified TCI scheme is indicated, the terminal may receive a PDSCH scheduled based on the received DCI (20-05) and transmit a PUCCH including a HARQ-ACK indicating whether reception of the DCI and the PDSCH is successful (20-10). The HARQ-ACK may include whether reception is successful, for both the DCI and the PDSCH, if the terminal fails to receive at least one of the DCI and the PDSCH, the terminal may transmit a NACK, and if the terminal succeeds in receive both of them, the terminal may transmit an ACK.

If the new TCI state indicated through DCI 20-00 is the same as a TCI state that has previously been indicated and thus been being applied to uplink transmission and downlink reception beams, the terminal may maintain the previously applied TCI state. If the new TCI state is different from the previously indicated TCI state, the terminal may determine, as a time point for application of the joint TCI state or separate TCI state set, which is indicatable by a TCI state field included in the DCI, a time point 20-30 after the first slot 20-20 after passage of a time interval as long as a beam application time (BAT) 20-15 after PUCCH transmission. The terminal may use the previously indicated TCI-state at a time point 20-25 before the corresponding slot 20-20.

According to an embodiment, when the TCI state indicated through the PDCCH 20-00 is TCI state #X 20-31, the terminal may determine whether to a default beam, according to whether TCI state #X 20-31 is connected to a PCID of a serving cell and/or a PCID different from that of the serving cell.

If TCI state #X 20-31 indicated to the terminal is connected to the PCID of the serving cell, the terminal may receive a PDSCH by using the TCI state #X indicated by the base station, during or after a time interval 20-34 corresponding to timeDurationForQCL 20-33, which is a terminal capability value related to a beam change time reported by the terminal, after reception of a PDCCH 20-32. That is, the terminal may receive a PDSCH by using TCI state #X indicated by the base station, regardless of the time interval corresponding to timeDurationForQCL.

Therefore, if the base station transmits a PDSCH 20-41 to the terminal before completion of reception and decoding of the PDCCH 20-32, that is, even if the terminal receives the PDSCH 20-41 at a time point 20-40 before passage of a time interval of timeDurationForQCL after a last symbol of PDCCH reception, the terminal may receive the PDSCH by using TCI state #X indicated by the base station. If the base station transmits a PDSCH 20-43 to the terminal at a time point after completion of reception and decoding of the PDCCH 20-32, that is, even if the terminal receives the PDSCH 20-43 at a time point 20-42 after passage of a time interval of timeDurationForQCL after a last symbol of PDCCH reception, the terminal may receive the PDSCH by using TCI state #X indicated by the base station.

If TCI state #X 20-31 indicated to the terminal is connected to a PCID different from that of the serving cell, the terminal may receive a PDSCH by applying a TCI state and/or a QCL assumption activated (or configured or indicated) for a control resource set having the lowest ID among control resource sets monitorable in the most recent slot rather than TCI state #X that is a TCI state indicated by the base station, during the time interval 20-34 corresponding to timeDurationForQCL 20-33, which is a terminal capability value related to a beam change time reported by the terminal, after reception of the PDCCH 20-32.

Therefore, if the base station transmits the PDSCH 20-41 to the terminal before completion of reception and decoding of the PDCCH 20-32, that is, if the terminal receives the PDSCH 20-41 at a time point 20-40 before passage of a time interval of timeDurationForQCL after a last symbol of PDCCH reception, the terminal may receive the PDSCH 20-41 by applying a TCI state and/or a QCL assumption activated (or configured or indicated) for a control resource set having the lowest ID among control resource sets monitorable in the most recent slot. If the base station transmits the PDSCH 20-43 to the terminal at a time point after completion of reception and decoding of the PDCCH 20-32, that is, even if the terminal receives the PDSCH 20-43 at the time point 20-42 after passage of a time interval of timeDurationForQCL after a last symbol of PDCCH reception, the terminal may receive the PDSCH by using TCI state #X indicated by the base station.

<Default Beam Operation when Multi-DCI-Based Multi-TRP PDSCH is Received in Unified TCI Scheme>

As an embodiment of the disclosure, a default beam operation when a terminal receives a PDSCH in a multi-DCI-based multi-TRP environment while operating in a unified TCI scheme is described. The embodiment may be operated in combination with all the embodiments of the disclosure.

A TCI state mentioned in an embodiment may indicate a joint TCI, a separate DL TCI, or a separate UL TCI.

A default beam mentioned in an embodiment may indicate a default TCI state or a default QCL assumption.

Hereinafter, a condition to be commonly applied in situations described later may be as follows.
Multi-DCI-based multi-TRP environment: In an embodiment, a multi-DCI-based multi-TRP environment may be assumed. As described above, the multi-DCI-based multi-TRP environment may imply a case where two different values of CORESETPoolIndex are configured for a terminal. More specifically, i) if the higher layer signaling coresetPoolIndex is not configured for a terminal in an activated downlink bandwidth part in a serving cell or the terminal includes one or more first CORESETs configured to have a coresetPoolIndex value of 0, and ii) the terminal includes one or more second CORESETs configured to have a coresetPoolIndex value of 1, which is higher layer signaling, in the activated downlink bandwidth part in the serving cell, the terminal may be assumed to operate in a multi-DCI-based multi-TRP environment.
Usage of unified TCI state: In an embodiment, an environment where a terminal uses a unified TCI state described above may be assumed. For example, the using of the unified TCI state may indicate a case where TCI-State_r17 that is higher layer signaling implying that a terminal operates in a unified TCI scheme in a particular serving cell is configured for the terminal with respect to a PCell or PSCell (primary secondary cell group (SCG) cell or primary secondary cell).

If the higher layer signaling SSB-MTCAdditionalPCI is not configured for a terminal by a base station, the terminal may assume that both TCI states corresponding to two different values of CORESETPoolIndex configured through higher layer signaling are connected to a PCID of a serving cell. That is, the terminal may assume that both TCI states are TCI states to which the PCID of the serving cell is connected, the both TCI states including a TCI state indicated through a TCI state field in a PDCCH transmitted in a control resource set configured to have a CORESETPoolIndex value of 0 and a TCI state indicated through a TCI state field in a PDCCH transmitted in a control resource set configured to have a CORESETPoolIndex value of 1. That is, it may be assumed that TCI states corresponding to two TRPs to which the PCID of the serving cell is connected are indicated to the terminal to correspond to values of CORESETPoolIndex, respectively.

If the higher layer signaling SSB-MTCAdditionalPCI is configured for a terminal by a base station, the terminal may assume that TCI states corresponding to two different values of CORESETPoolIndex configured through higher layer signaling are connected to a PCID of a serving cell and a PCID different from that of the serving cell. That is, the terminal may assume that a TCI state indicated through a TCI state field in a PDCCH transmitted in a control resource set configured to have a CORESETPoolIndex value of 0 is a TCI state to which the PCID of the serving cell is connected. The terminal may assume that a TCI state indicated through a TCI state field in a PDCCH transmitted in a control resource set configured to have a CORESETPoolIndex value of 1 is a TCI state to which the PCID different from that of the serving cell is connected. Therefore, with respect to all TCI states activated in a TCI state field in a PDCCH transmitted in a control resource set configured to have a CORESETPoolIndex value of 1, the terminal may assume that all TCI states activated in all codepoints of the TCI state field are connected to the PCID different from that of the serving cell.

If the higher layer signaling tci-PresentInDCI and tci-PresentInDCI-1-2 are configured or not configured for a terminal, a scheduling offset between a PDCCH and a PDSCH is shorter than timeDurationForQCL that is a reference time descried above, the terminal is in an RRC-connected mode, at least one TCI state configured by higher layer signaling in a corresponding serving cell includes QCL-TypeD as qcl-Type information, and the higher layer signaling followUnifiedTCIstate is configured or not configured, the terminal may perform an operation for a combination of at least one of the following items.
If the higher layer signaling enableDefaultTCI-StatePerCoresetPoolIndex is configured for the terminal, the terminal may receive a PDSCH scheduled in a control resource set configured to have a CORESETPoolIndex value of 0, which is higher layer signaling, by using a TCI state indicated by a PDCCH transmitted in a control resource set configured to have a CORESETPoolIndex value of 0, which is higher layer signaling. —The terminal may receive a PDSCH scheduled in a control resource set configured to have a CORESETPoolIndex value of 1, which is higher layer signaling, by using a TCI state indicated by a PDCCH transmitted in a control resource set configured to have a CORESETPoolIndex value of 1, which is higher layer signaling.
If the higher layer signaling enableDefaultTCI-StatePerCoresetPoolIndex is configured for the terminal, the terminal may receive a PDSCH scheduled in a control resource set configured to have a CORESETPoolIndex value of 0, which is higher layer signaling, by using a TCI state indicated by a PDCCH transmitted in a control resource set configured to have a CORESETPoolIndex value of 0, which is higher layer signaling. With respect to a PDSCH scheduled in a control resource set configured to have a CORESETPoolIndex value of 1, which is higher layer signaling, the terminal may apply, to a PDSCH DMRS, a TCI state configured or activated for a control resource set which has the lowest index and is monitorable in a slot closest to the PDSCH among control resource sets having the same value as a CORESETPoolIndex value (e.g., 1), which is the higher layer signaling, configured for a control resource set including a PDCCH scheduling the PDSCH, or a QCL assumption of the control resource set having the lowest index.

If the higher layer signaling enableDefaultTCI-StatePerCoresetPoolIndex is configured for the terminal, with respect to a PDSCH scheduled in a control resource set configured to have a CORESETPoolIndex value of 0, which is higher layer signaling, the terminal may apply, to a PDSCH DMRS, a TCI state configured or activated for a control resource set which has the lowest index and is monitorable in a slot closest to the PDSCH among control resource sets having the same value as a CORESETPoolIndex value (e.g., 0), which is the higher layer signaling, configured for a control resource set including a PDCCH scheduling the PDSCH, and/or a QCL assumption of the control resource set having the lowest index. With respect to a PDSCH scheduled in a control resource set configured to have a CORESETPoolIndex value of 1, which is higher layer signaling, the terminal may apply, to a PDSCH DMRS, a TCI state configured or activated for a control resource set which has the lowest index and is monitorable in a slot closest to the PDSCH among control resource sets having the same value as a CORESETPoolIndex value (e.g., 1), which is the higher layer signaling, configured for a control resource set including a PDCCH scheduling the PDSCH, and/or a QCL assumption of the control resource set having the lowest index.
If the higher layer signaling enableDefaultTCI-StatePerCoresetPoolIndex is not configured for the terminal, the terminal may receive PDSCHs scheduled in all control resource sets regardless of a CORESETPoolIndex value, which is higher layer signaling, by using a TCI state indicated by a PDCCH transmitted in a control resource set configured to have a CORESETPoolIndex value of 0, which is higher layer signaling.
If the higher layer signaling enableDefaultTCI-StatePerCoresetPoolIndex is not configured for the terminal, the terminal may receive PDSCHs scheduled in all control resource sets regardless of a CORESETPoolIndex value, which is higher layer signaling, by using a TCI state indicated by a PDCCH transmitted in a control resource set configured to have a CORESETPoolIndex value of 1, which is higher layer signaling.

If the higher layer signaling enableDefaultTCI-StatePerCoresetPoolIndex is not configured for the terminal, with respect to PDSCHs scheduled in all control resource sets regardless of a CORESETPoolIndex value, which is higher layer signaling, the terminal may apply, to a PDSCH DMRS, a TCI state configured or activated for a control resource set which has the lowest index and is monitorable in a slot closest to the PDSCH among control resource sets having the same value as a CORESETPoolIndex value (e.g., 0 or 1), which is the higher layer signaling, configured for a control resource set including a PDCCH scheduling the PDSCH, and/or a QCL assumption of the control resource set having the lowest index.

If the higher layer signaling enableDefaultTCI-StatePerCoresetPoolIndex is not configured for the terminal, with respect to PDSCHs scheduled in all control resource sets regardless of a CORESETPoolIndex value, which is higher layer signaling, the terminal may apply, to a PDSCH DMRS, a TCI state configured or activated for a control resource set which has the lowest index and is monitorable in a slot closest to the PDSCH (here, the control resource set may not be related to whether CORESETPoolIndex is configured therefor or if same is configured, the value) or a QCL assumption of the control resource set having the lowest index.
With respect to the above items, if QCL-TypeD applied to the PDSCH DMRS is different from QCL-TypeD applied to a DMRS of a PDCCH overlapping with the PDSCH on at least one OFDM symbol, and the PDCCH and the PDSCH are connected to the same value of CORESETPoolIndex (i.e., a value of the higher layer signaling CORESETPoolIndex configured for a control resource set in which a PDCCH including scheduling information for the PDSCH is transmitted is equal to a value of the higher layer signaling CORESETPoolIndex configured for a control resource set in which a PDCCH overlapping with the PDSCH is transmitted), the terminal may prioritize PDCCH reception. The terminal may perform the same operation even for intra-band CA (i.e., if the PDSCH and the overlapping control resource set exist on different subcarriers). The terminal may consider or identify that a control resource set configured to have a CORESETPoolIndex value of 0 and a control resource set for which CORESETPoolIndex is not configured are both configured to have a CORESETPoolIndex value of 0.
The higher layer signaling enableDefaultTCI-StatePerCoresetPoolIndex may be replaced with new higher layer signaling (e.g., enableDefaultTCI-StatePerCoresetPoolIndexUnifiedTCI).
The terminal may assume that both TCI states corresponding to two different values of CORESETPoolIndex configured through higher layer signaling are connected to a PCID of a serving cell.
The terminal may assume that a TCI state indicated through a TCI state field in a PDCCH transmitted in a control resource set configured to have a CORESETPoolIndex value of 0 through higher layer signaling is a TCI state to which the PCID of the serving cell is connected. The terminal may assume that a TCI state indicated through a TCI state field in a PDCCH transmitted in a control resource set configured to have a CORESETPoolIndex value of 1 is a TCI state to which a PCID different from that of the serving cell is connected.
   <Default Beam Operation when Single-DCI-Based Multi-TRP PDSCH is Received in Unified TCI Scheme>

As an embodiment of the disclosure, a default beam operation when a single-DCI-based multi-TRP PDSCH is received in a unified TCI scheme is described. The embodiment may be operated in combination with all the embodiments of the disclosure.

A TCI state mentioned in an embodiment may indicate a joint TCI, a separate DL TCI, or a separate UL TCI.

A default beam mentioned in an embodiment may indicate a default TCI state or a default QCL assumption.

Hereinafter, a condition to be commonly applied in situations described later in an embodiment may be as follows.
Single-DCI-based multi-TRP environment: In an embodiment, a single-DCI-based multi-TRP environment may be assumed. As described above, the single-DCI multi-TRP environment may indicate a case where two TCI states in at least one codepoint of a TCI state field in DCI are activated by a base station for a terminal.
Usage of unified TCI state: In an embodiment, an environment where a terminal uses a unified TCI state described above may be assumed. More specifically, the using of the unified TCI state may indicate a case where TCI-State_r17 that is higher layer signaling implying that a terminal operates in a unified TCI scheme in a particular serving cell is configured for the terminal with respect to a PCell or PSCell.
Related to control resource set: In this embodiment, the following assumption on a control resource set may be given. With respect to which TCI state, among multiple unified TCI states indicated to a terminal, to be used to receive a PDCCH transmitted in a corresponding control resource set, the terminal may be configured by a base station through higher layer signaling for each control resource set or each control resource set group as described below.
   For example, the terminal may receive a PDCCH transmitted in a control resource set by using a first unified TCI state among two unified TCI states indicated to the terminal through higher layer signaling in the control resource set, using a second unified TCI state, using both of the first unified TCI state and the second unified TCI state, or using a unified TCI state configured or activated for the control resource set without using the indicated unified TCI states. For example, the terminal may be configured, through higher layer signaling, to receive a PDCCH by using the first unified TCI state, among the two unified TCI states indicated to the terminal, for a first control resource set among three control resource set configured in an activated bandwidth part. The terminal may be configured, through higher layer signaling, to receive a PDCCH by using the second unified TCI state for a second control resource set. The terminal may be configured, through higher layer signaling, to receive a PDCCH by using a unified TCI state configured or activated for a third control resource set without using the indicated unified TCI states for the control resource set.
   As another example, which control resource set group in which a control resource set is included may be configured for the terminal by the base station through higher layer signaling in the control resource set. When receiving PDCCHs transmitted in all control resource sets included in a control resource set group, the terminal may use a first unified TCI state among two unified TCI states indicated to the terminal, use a second unified TCI state, use both of the first unified TCI state and the second unified TCI state, or use a unified TCI state configured or activated for the control resource set without using the indicated unified TCI states. For example, there may be two control resource set groups, and the terminal may be configured, through higher layer signaling, to receive a PDCCH by using the first unified TCI state, among the two unified TCI states indicated to the terminal, for all control resource sets in a first control resource set group configured in an activated bandwidth part. The terminal may be configured, through higher layer signaling, to receive a PDCCH by using the second unified TCI state for all control resource sets in a second control resource set group. As another example, there may be two control resource set groups, and if a particular control resource set is included in a first control resource set group, the terminal may receive a PDCCH by using the first unified TCI state among the two unified TCI states indicated to the terminal. If a particular control resource set is included in a second control resource set group, the terminal may receive a PDCCH by using the second unified TCI state. If a particular control resource set is included both in the first control resource set group and the second control resource set group, the terminal may receive a PDCCH by using both of the first unified TCI state and the second unified TCI state. If a particular control resource set is not included both in the first control resource set group and the second control resource set group, the terminal may receive a PDCCH by using a unified TCI state configured or activated for the control resource set without using the indicated unified TCI states.

According to an embodiment, if the higher layer signaling SSB-MTCAdditionalPCI is not configured for a terminal by a base station, the terminal may assume that all TCI states configured through higher layer signaling are connected to a PCID of a serving cell. If two TCI states are activated for at least one codepoint among codepoints of a TCI state field in a PDCCH by the base station for the terminal, the terminal may assume that the two TCI states are both connected to the PCID of the serving cell.

According to an embodiment, if the higher layer signaling SSB-MTCAdditionalPCI is configured for a terminal by a base station, the terminal may assume that some of all TCI states configured through higher layer signaling are connected to a PCID of a serving cell and the remaining some are connected to a PCID different from that of the serving cell. The TCI states connected to the PCID different from that of the serving cell may all be connected to the same PCID, or some of them are connected to a particular PCID and the remaining some may be connected to a different PCID. Here, TCI states and PCIDs may be assumed to be connected in one-to-one correspondence. If one or two TCI states are activated for at least one codepoint among codepoints of a TCI state field in a PDCCH by the base station for the terminal, the terminal may assume that one of the following examples is possible for the one or two TCI states activated in each codepoint.
[TCI state field activation example 1] One TCI state connected to a PCID of a serving cell may be activated in a random codepoint.
[TCI state field activation example 2] One TCI state connected to a PCID different from that of a serving cell may be activated in a random codepoint.
[TCI state field activation example 3] Two TCI states connected to a PCID of a serving cell may be activated in a random codepoint.
[TCI state field activation example 4] Two TCI states may be activated in a random codepoint, one TCI state of them may be connected to a PCID of a serving cell, and the other TCI stat may be connected to a PCID different from that of the serving cell.
[TCI state field activation example 5] Two TCI states connected to PCIDs different from that of a serving cell may be activated in a random codepoint, and the two PCIDs may be the same.
[TCI state field activation example 6] Two TCI states connected to PCIDs different from that of a serving cell may be activated in a random codepoint, and the two PCIDs may be different from each other.

If the higher layer signaling tci-PresentInDCI and tci-PresentInDCI-1-2 are configured or not configured for a terminal, a scheduling offset between a PDCCH and a PDSCH is shorter than timeDurationForQCL that is a reference time descried above, the terminal is in an RRC-connected mode, at least one TCI state configured by higher layer signaling in a serving cell includes QCL-TypeD as qcl-Type information, and the higher layer signaling followUnifiedTCIstate or the above higher layer signaling for each control resource set which implies which TCI state to be applied among multiple TCI states indicated by a base station is configured or not configured (i.e., regardless of whether higher layer signaling related to whether to apply a TCI state for each control resource set is configured), the terminal may perform an operation for a combination of at least one of the following items.
If the higher layer signaling enableTwoDefaultTCI-States is configured for the terminal,
   If there is one TCI state indicated by the base station to the terminal, the terminal may perform one of the following operations. A condition for the one TCI state indicated by the base station to the terminal may be one of [TCI state field activation example 1] and [TCI state field activation example 2]. The following operations may be performable when a terminal capability indicating each operation being supportable is defined and the terminal capability is reported by the terminal to the base station. Furthermore, the terminal may be able to perform one of the following operations when, in addition to the terminal capability, the base station receives the terminal capability report and configures higher layer signaling configuration information corresponding thereto for the terminal.
      The terminal may receive a PDSCH by using the one TCI state.
      The terminal may receive the PDSCH by using a TCI state configured or activated for a control resource set having the lowest control resource set index among at least one control resource set monitorable in a slot closest to the PDSCH, or a QCL assumption of the control resource set having the lowest index.
      The terminal may, when receiving the PDSCH, apply, to a PDSCH DMRS, two TCI states corresponding to a codepoint having the lowest index among codepoints in which two TCI states are activated among codepoints in a TCI state field in DCI.
      The terminal may be notified of one of the possible operations from the base station and use same when receiving the PDSCH. The notification from the base station may be possible through at least one of higher layer signaling, MAC-CE signaling, or L1 signaling.
   If there are two TCI states indicated by the base station to the terminal, the terminal may perform one of the following operations. A condition for the two TCI states indicated by the base station to the terminal may be at least one of [TCI state field activation example 3] to [TCI state field activation example 6]. The following operations may be performable when a terminal capability indicating each operation being supportable is defined and the terminal capability is reported by the terminal to the base station. Furthermore, the terminal may be able to perform at least one of the following operations when, in addition to the terminal capability, the base station receives the terminal capability report and configures higher layer signaling configuration information corresponding to the received terminal capability report for the terminal.
      The terminal may receive a PDSCH by using a first TCI state among the two TCI states.
      The terminal may receive the PDSCH by using a second TCI state among the two TCI states.
      The terminal may be notified of which TCI state, among the two TCI states, to be used to receive the PDSCH, from the base station through higher layer signaling configuration information.
      The terminal may receive the PDSCH by using a TCI state configured or activated for a control resource set having the lowest control resource set index among at least one control resource set monitorable in a slot closest to the PDSCH, or a QCL assumption of the control resource set having the lowest index.
      The terminal may receive the PDSCH by using the two TCI states.
      The terminal may receive the PDSCH by using the first TCI state among the two TCI states and a TCI state configured or activated for a control resource set having the lowest control resource set index among at least one control resource set monitorable in a slot closest to the PDSCH, or a QCL assumption of the control resource set having the lowest index.
      The terminal may, when receiving the PDSCH, apply, to a PDSCH DMRS, two TCI states corresponding to a codepoint having the lowest index among codepoints in which two TCI states are activated among codepoints in a TCI state field in DCI.
      The terminal may be notified of at least one of the possible operations from the base station and use same when receiving the PDSCH. The notification from the base station may be performed through at least one of higher layer signaling, MAC-CE signaling, or L1 signaling.
   Among the above items, in a case where the number of TCI states to be used by the terminal for PDSCH reception is 2 (e.g., the terminal receives a PDSCH by using the two indicated TCI states or uses two TCI states corresponding to a codepoint having the lowest index among codepoints in which two TCI states are activated among codepoints in a TCI state field in DCI), if tdmSchemeA is configured for the terminal as a value of the higher layer signaling repetitionScheme or the higher layer signaling repetitionNumber is configured therefor, and a scheduling offset between a PDCCH and a first PDSCH reception occasion among multiple PDSCH reception occasions is shorter than timeDurationForQCL, the terminal may use two TCI states corresponding to a codepoint having the lowest index among codepoints in which two TCI states are activated among codepoints in a TCI state field in DCI, to apply same to the PDSCH reception occasions repeatedly received on time resources. The terminal may use the activated TCI state codepoint for a slot including the first PDSCH reception occasion. If cyclicMapping is configured for the terminal through higher layer signaling, the terminal may apply first and second TCI states among the two TCI states corresponding to the codepoint having the lowest index to the first PDSCH reception occasion and a second PDSCH reception occasion, respectively. The terminal may identically apply the same application method to subsequent PDSCH reception occasions. If the higher layer signaling sequentialMapping is configured for the terminal, the terminal may apply the first TCI state among the two TCI states corresponding to the codepoint having the lowest index to the first PDSCH reception occasion and the second PDSCH reception occasion, and may apply the second TCI state to third and fourth PDSCH reception occasions. The terminal may identically apply the same application method to subsequent PDSCH reception occasions.
If the higher layer signaling enableTwoDefaultTCI-States is not configured for the terminal,
   If there is one TCI state indicated by the base station to the terminal, the terminal may perform at least one of the following operations. A condition for the one TCI state indicated by the base station to the terminal may be at least one of [TCI state field activation example 1] and [TCI state field activation example 2]. The following operations may be performable when a terminal capability indicating each operation being supportable is defined and the terminal capability is reported by the terminal to the base station. Furthermore, the terminal may perform at least one of the following operations when, in addition to the terminal capability, the base station receives the terminal capability report and configures higher layer signaling configuration information corresponding to the terminal capability report for the terminal.
      The terminal may receive a PDSCH by using the one TCI state.
      The terminal may receive the PDSCH by using a TCI state configured or activated for a control resource set having the lowest control resource set index among at least one control resource set monitorable in a slot closest to the PDSCH, or a QCL assumption of the control resource set having the lowest index.
      The terminal may be notified of at least one of the possible operations from the base station and use same when receiving the PDSCH. The notification from the base station may perform at least one of higher layer signaling, MAC-CE signaling, or L1 signaling.
   If there are two TCI states indicated by the base station to the terminal, the terminal may perform at least one of the following operations. A condition for the two TCI states indicated by the base station to the terminal may be at least one of [TCI state field activation example 3] to [TCI state field activation example 6]. The following operations may be performable when a terminal capability indicating each operation being supportable is defined and the terminal capability is reported by the terminal to the base station. Furthermore, the terminal may perform at least one of the following operations when, in addition to the terminal capability, the base station receives the terminal capability report and configures higher layer signaling configuration information corresponding to the terminal capability report for the terminal.
      The terminal may receive a PDSCH by using a first TCI state among the two TCI states.
      The terminal may receive the PDSCH by using a second TCI state among the two TCI states.
      The terminal may be notified of which TCI state, among the two TCI states, to be used to receive the PDSCH, from the base station through higher layer signaling configuration information.
      The terminal may receive the PDSCH by using a TCI state configured or activated for a control resource set having the lowest control resource set index among at least one control resource set monitorable in a slot closest to the PDSCH, or a QCL assumption of the control resource set having the lowest index.
      The terminal may be notified of at least one of the possible operations from the base station and use same when receiving the PDSCH. The notification from the base station may perform at least one of higher layer signaling, MAC-CE signaling, or L1 signaling.
With respect to the above items, if QCL-TypeD applied to the PDSCH DMRS (i.e., QCL-TypeD information in two TCI states indicated by a codepoint having the lowest index and in which two TCI states are activated among codepoints of a TCI state field in a PDCCH) is different from QCL-TypeD applied to a DMRS of a PDCCH overlapping with the PDSCH on at least one OFDM symbol, the terminal may prioritize PDCCH reception and may perform the same operation even for intra-band CA (i.e., if the PDSCH and an overlapping control resource set exist on different subcarriers).
The higher layer signaling enableTwoDefaultTCI-States may be replaced with new higher layer signaling (e.g., enableTwoDefaultTCI-StatesUnifiedTCI).
With respect to the above items, it may be assumed that a codepoint of a TCI state field corresponding to at least one of [TCI state field activation example 1] to [TCI state field activation example 6] described above is indicated for the terminal by the base station, and the terminal uses a default TCI state to be used at the time of PDSCH reception at a time point at which the indicated TCI state is applied (e.g., from a first slot after BAT symbols from PUCCH transmission including information relating to whether reception of a PDCCH indicating the codepoint of the TCI state field is successful).

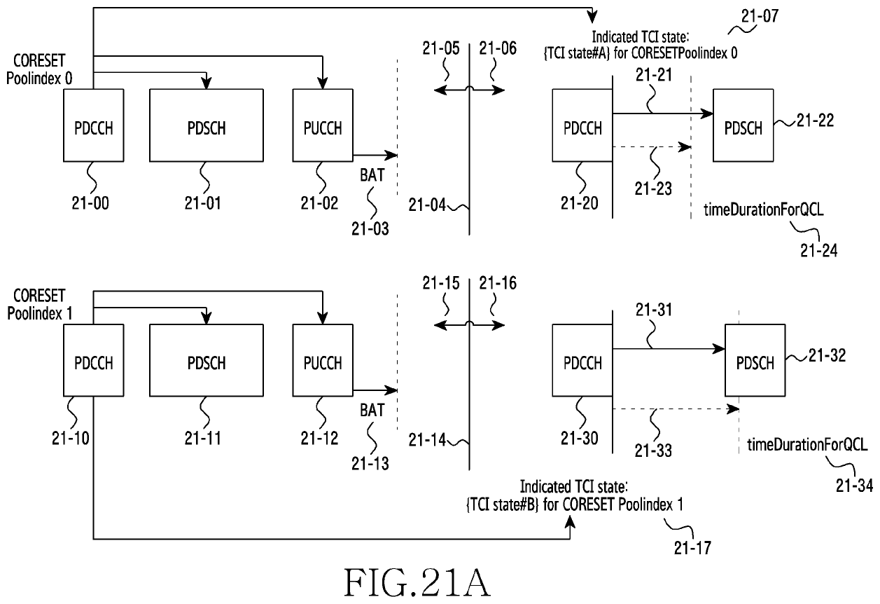

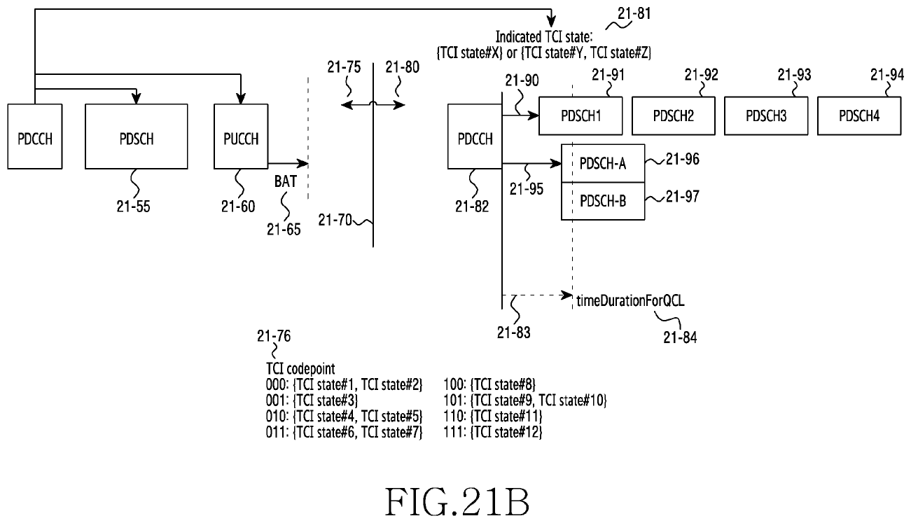

FIG. 21A illustrates a default beam operation when a unified TCI state-based single or multi-TRP PDSCH is received, according to an embodiment of the disclosure.

FIG. 21B illustrates a default beam operation when a unified TCI state-based single or multi-TRP PDSCH is received, according to an embodiment of the disclosure.

Referring to FIG. 21A and FIG. 21B, a terminal may receive, from a base station, DCI format 1_1 or 1_2 including downlink data channel scheduling information (with DL assignment) or not including downlink data channel scheduling information (without DL assignment), and the terminal may apply one joint TCI state or one separate TCI state set indicated by a TCI state field in the DCI to uplink transmission and downlink reception beams.

According to an embodiment, in case that two different values of CORESETPoolIndex are configured for a terminal through higher layer signaling and the terminal receives DCI format 1_1 or DCI format 1_2 including downlink data channel scheduling information transmitted in a control resource set having a CORESETPoolIndex value of 0 (21-00) so that one joint TCI state or one separate TCI state set based on a unified TCI scheme is indicated, the terminal may receive a PDSCH scheduled based on the received DCI (21-01) and transmit a PUCCH including a HARQ-ACK indicating whether reception of the DCI and the PDSCH is successful (21-02). The HARQ-ACK may include whether reception is successful, for both the DCI and the PDSCH. If the terminal fails to receive at least one of the DCI and the PDSCH, the terminal may transmit a NACK, and if the terminal succeeds in receive both of them, the terminal may transmit an ACK.

In case that the new TCI state indicated through DCI 21-00 is the same as a TCI state that has previously been indicated and thus been being applied to uplink transmission and downlink reception beams, the terminal may maintain the previously applied TCI state. In case that the new TCI state is different from the previously indicated TCI state, the terminal may determine, as a time point for application of the joint TCI state or separate TCI state set, which is indicatable by a TCI state field included in the DCI, a time point 21-06 after the first slot 21-04 after passage of a time interval as long as a beam application time (BAT) 21-03 after PUCCH transmission. The terminal may use the previously indicated TCI state at a time point 21-05 before the first slot 21-04. For example, the terminal may assume a situation where TCI state #A 21-07 is newly indicated and is applicable at the time point 21-06 after a particular time point 21-04.

Similarly, if a terminal receives DCI format 1_1 or DCI format 1_2 including downlink data channel scheduling information transmitted in a control resource set having a CORESETPoolIndex value of 1 (21-10) so that one joint TCI state or one separate TCI state set based on a unified TCI scheme is indicated, the terminal may receive a PDSCH scheduled based on the received DCI (21-11) and transmit a PUCCH including a HARQ-ACK indicating whether reception of the DCI and the PDSCH is successful (21-12). The indicated TCI state may be applied at a time point 21-16 after the first slot 21-14 after passage of a time interval as long as a beam application time (BAT) 21-13 after PUCCH transmission, and the previously indicated TCI state may be used at a time point 21-15 before the first slot 21-14. For example, the terminal may assume a situation where TCI state #B 21-17 is newly indicated and is applicable at the time point 21-16 after a particular time point 21-14.

The terminal may determine, according to a combination of various conditions, which TCI state or QCL assumption to be applied to receive a PDSCH during a time interval 21-23 or 21-33 corresponding to timeDurationForQCL 21-24 or 21-34, which is a terminal capability value related to a beam change time reported by the terminal, after reception of a PDCCH 21-20 or 21-30. For example, the combination of the various conditions may include whether a TCI state indicated by a PDCCH corresponding to each CORESETPoolIndex value is connected to a PCID of a serving cell or a PCID different from that of the serving cell and/or whether particular higher layer signaling (e.g., enableDefaultTCI-StatePerCoresetPoolIndex) is configured.
For example, in case that the higher layer signaling enableDefaultTCI-StatePerCoresetPoolIndex is configured for the terminal, the terminal may receive a PDSCH 21-22 scheduled in the control resource set 21-20 configured to have a CORESETPoolIndex value of 0, which is higher layer signaling, by using a TCI state indicated by a PDCCH transmitted in a control resource set configured to have a CORESETPoolIndex value of 0, which is higher layer signaling, during a designated time (e.g., the time interval 21-23 or 21-33 corresponding to timeDurationForQCL 21-24 or 21-34, which is a terminal capability value related to a beam change time reported by the terminal, after reception of the PDCCH 21-20 or 21-30). —The terminal may receive a PDSCH scheduled in a control resource set configured to have a CORESETPoolIndex value of 1, which is higher layer signaling, by using a TCI state indicated by a PDCCH transmitted in a control resource set configured to have a CORESETPoolIndex value of 1, which is higher layer signaling. All TCI states corresponding to respective values of CORESETPoolIndex may all be considered or identified to be connected to a PCID of a serving cell.
As another example, if the higher layer signaling enableDefaultTCI-StatePerCoresetPoolIndex is configured for the terminal, the terminal may receive a PDSCH scheduled in a control resource set configured to have a CORESETPoolIndex value of 0, which is higher layer signaling, by using a TCI state indicated by a PDCCH transmitted in a control resource set configured to have a CORESETPoolIndex value of 0, which is higher layer signaling, during the time (i.e., the time interval 21-23 or 21-33 corresponding to timeDurationForQCL 21-24 or 21-34, which is a terminal capability value related to a beam change time reported by the terminal, after reception of the PDCCH 21-20 or 21-30). With respect to a PDSCH scheduled in a control resource set configured to have a CORESETPoolIndex value of 1, which is higher layer signaling, the terminal may apply, to a PDSCH DMRS, a TCI state configured or activated for a control resource set which has the lowest index and is monitorable in a slot closest to the PDSCH among control resource sets having the same value as a CORESETPoolIndex value (e.g., 1), which is the higher layer signaling, configured for a control resource set including a PDCCH scheduling the PDSCH, or a QCL assumption of the control resource set having the lowest index. It may be considered or identified that a TCI state indicated by a PDCCH transmitted in a control resource set configured to have a CORESETPoolIndex value of 0 corresponds to a PCID of a serving cell, and a TCI state indicated by a PDCCH transmitted in a control resource set configured to have a CORESETPoolIndex value of 1 corresponds to a PCID different from that of the serving cell.

In a case where two TCI states are activated for at least one codepoint of a TCI state field in DCI by the base station for the terminal, in case that DCI format 1_1 or DCI format 12 including downlink data channel scheduling information transmitted in a control resource set is received (21-50) so that one joint TCI state or one separate TCI state set based on a unified TCI scheme is indicated, the terminal may receive a PDSCH scheduled based on the received DCI (21-55) and transmit a PUCCH including a HARQ-ACK indicating whether reception of the DCI and the PDSCH is successful (21-60). The HARQ-ACK may include whether reception is successful, for both the DCI and the PDSCH. If the terminal fails to receive at least one of the DCI and the PDSCH, the terminal may transmit a NACK, and if the terminal succeeds in receive both of them, the terminal may transmit an ACK.

If the new TCI state indicated through DCI 21-50 is the same as a TCI state that has previously been indicated and thus been being applied to uplink transmission and downlink reception beams, the terminal may maintain the previously applied TCI state. If the new TCI state is different from the previously indicated TCI state, the terminal may determine, as a time point for application of the joint TCI state or separate TCI state set, which is indicatable by a TCI state field included in the DCI, a time point 21-80 after the first slot 21-70 after passage of a time interval as long as a beam application time (BAT) 21-65 after PUCCH transmission. The terminal may use the previously indicated TCI state at a time point 21-75 before the first slot 21-70, and may assume a situation where one TCI state (e.g., TCI state #X) or two TCI states (e.g., TCI state #Y and TCI state #Z) 21-81 are newly indicated and are applicable at the time point 21-80 after a particular time point 21-70.

According to an embodiment, the terminal may determine, according to a combination of various conditions, which TCI state or QCL assumption to be applied to receive a PDSCH during a time interval 21-83 or 21-90 corresponding to timeDurationForQCL 21-84, which is a terminal capability value related to a beam change time reported by the terminal, after reception of a PDCCH 21-82. For example, the combination of the various conditions may include at least one of [TCI state field activation example 1] to [TCI state field activation example 6] described above, and/or whether particular higher layer signaling (e.g., enableTwoDefaultTCI-States) is configured.

For example, if the higher layer signaling enableTwoDefaultTCI-States is configured for the terminal, two TCI states (e.g., TCI state #Y and TCI state #Z 21-81) are indicated by the base station, and the two TCI states are both connected to a PCID of a serving cell (i.e., in a case of [TCI state field activation example 3] described above), the terminal may receive a PDSCH by using the two TCI states indicated by the base station within the time interval (i.e., during the time interval 21-83 or 21-90 corresponding to timeDurationForQCL 21-84, which is a terminal capability value related to a beam change time reported by the terminal, after reception of the PDCCH 21-82).
IftdmSchemeA is configured for the terminal as a value of the higher layer signaling repetitionScheme or the higher layer signaling repetitionNumber is configured therefor, and a scheduling offset 21-90 between the PDCCH 21-82 and a first PDSCH reception occasion 21-91 among multiple PDSCH reception occasions is shorter than timeDurationForQCL 21-84, the terminal may use TCI state #Y and TCI state #Z indicated by the base station (21-81) to apply same to the PDSCH reception occasions repeatedly received on time resources. If cyclicMapping is configured for the terminal through higher layer signaling, the terminal may apply TCI state #Y and TCI state #Z to the first PDSCH reception occasion 21-91 and a second PDSCH reception occasion 21-92, respectively. The terminal may identically apply the same application method to subsequent PDSCH reception occasions. If the higher layer signaling sequentialMapping is configured for the terminal, the terminal may apply TCI state #Y to the first PDSCH reception occasion 21-91 and the second PDSCH reception occasion 21-92, and may apply TCI state #Z to a third PDSCH reception occasion 21-93 and a fourth PDSCH reception occasion 21-94. The terminal may identically apply the same application method to subsequent PDSCH reception occasions.
   If fdmSchemeA or fdmSchemeB is configured for the terminal as a value of the higher layer signaling repetitionScheme, the terminal may apply TCI state #Y, among the two TCI states indicated by the base station, to a PDSCH 21-96 corresponding to a first RB group, and apply TCI state #Z among the two TCI states to a PDSCH 21-97 corresponding to a second RB group to receive same.
As another example, if the higher layer signaling enableTwoDefaultTCI-States is configured for the terminal, one TCI state (e.g., TCI state #X 21-81) is indicated by the base station, and the one TCI state is connected to a PCID different from that of a serving cell (i.e., in a case of [TCI state field activation example 2] described above), the terminal may receive a PDSCH DMRS by applying, thereto, two TCI states corresponding to a codepoint having the lowest index among codepoints in which two TCI states are activated among codepoints in a TCI state field in DCI, within the time interval (i.e., during the time interval 21-83 or 21-90 corresponding to timeDurationForQCL 21-84, which is a terminal capability value related to a beam change time reported by the terminal, after reception of the PDCCH 21-82).
   If tdmSchemeA is configured for the terminal as a value of the higher layer signaling repetitionScheme or the higher layer signaling repetitionNumber is configured therefor, and the scheduling offset 21-90 between the PDCCH 21-82 and the first PDSCH reception occasion 21-91 among multiple PDSCH reception occasions is shorter than timeDurationForQCL 21-84, the terminal may use two TCI states corresponding to a codepoint having the lowest index among codepoints in which two TCI states are activated among codepoints 21-76 in a TCI state field in DCI (use TCI state #1 and TCI state #2 corresponding to codepoint 000 (21-76)) to apply same to the PDSCH reception occasions repeatedly received on time resources. The terminal may use the activated TCI state codepoint for a slot including the first PDSCH reception occasion. If cyclicMapping is configured for the terminal through higher layer signaling, the terminal may apply TCI state #1 and TCI state #2 among the two TCI states corresponding to the codepoint having the lowest index to the first PDSCH reception occasion 21-91 and the second PDSCH reception occasion 21-92, respectively. The terminal may identically apply the same application method to subsequent PDSCH reception occasions. If the higher layer signaling sequentialMapping is configured for the terminal, the terminal may apply TCI state #1 among the two TCI states corresponding to the codepoint having the lowest index to the first PDSCH reception occasion 21-91 and the second PDSCH reception occasion 21-92, and may apply TCI state #2 to a third PDSCH reception occasion 21-93 and a fourth PDSCH reception occasion 21-94. The terminal may identically apply the same application method to subsequent PDSCH reception occasions.
   If fdmSchemeA or fdmSchemeB is configured for the terminal as a value of the higher layer signaling repetitionScheme, the terminal may apply TCI state #1, among the two TCI states corresponding to the codepoint having the lowest index, to the PDSCH 21-96 corresponding to a first RB group, and apply TCI state #2, among the two TCI states corresponding to the codepoint having the lowest index, to the PDSCH 21-97 corresponding to a second RB group to receive same.

### <Method of Dynamic Switching Between Single-TRP PDSCH Reception Operation and Multi-TRP PDSCH Reception Operation in Unified TCI Scheme>

As an embodiment of the disclosure, a method of dynamic switching between a single-TRP PDSCH reception operation and a multi-TRP PDSCH reception operation in a unified TCI scheme is described. The embodiment may be operated in combination with all the embodiments of the disclosure.

A TCI state mentioned in an embodiment may indicate a joint TCI, a separate DL TCI, or a separate UL TCI.

A default beam mentioned in an embodiment may indicate a default TCI state or a default QCL assumption.

Hereinafter, a condition to be commonly applied in situations described later in an embodiment may be as follows.
Single-DCI-based multi-TRP environment: In an embodiment, a single-DCI-based multi-TRP environment may be assumed. As described above, the single-DCI multi-TRP environment may indicate a case where two TCI states in at least one codepoint of a TCI state field in DCI are activated by a base station for a terminal.
Usage of unified TCI state: In an embodiment, an environment where a terminal uses a unified TCI state described above may be assumed. More specifically, the using of the unified TCI state may indicate a case where TCI-State_r17 that is higher layer signaling implying that a terminal operates in a unified TCI scheme in a particular serving cell is configured for the terminal with respect to a PCell or PSCell.
Related to control resource set: In this embodiment, the following assumption on a control resource set may be given. With respect to which TCI state, among multiple unified TCI states indicated to a terminal, to be used to receive a PDCCH transmitted in a corresponding control resource set, the terminal may be configured by a base station through higher layer signaling for each control resource set or each control resource set group as described below.
   For example, the terminal may receive a PDCCH transmitted in a control resource set by using a first unified TCI state among two unified TCI states indicated to the terminal through higher layer signaling in the control resource set, using a second unified TCI state, using both of the first unified TCI state and the second unified TCI state, or using a unified TCI state configured or activated for the control resource set without using the indicated unified TCI states. For example, the terminal may be configured, through higher layer signaling, to receive a PDCCH by using the first unified TCI state, among the two unified TCI states indicated to the terminal, for a first control resource set among three control resource set configured in an activated bandwidth part. The terminal may be configured, through higher layer signaling, to receive a PDCCH by using the second unified TCI state for a second control resource set. The terminal may be configured, through higher layer signaling, to receive a PDCCH by using a unified TCI state configured or activated for a third control resource set without using the indicated unified TCI states for the control resource set.
   As another example, which control resource set group in which a control resource set is included may be configured for the terminal by the base station through higher layer signaling in the control resource set. When receiving PDCCHs transmitted in all control resource sets included in a control resource set group, the terminal may use a first unified TCI state among two unified TCI states indicated to the terminal, use a second unified TCI state, use both of the first unified TCI state and the second unified TCI state, or use a unified TCI state configured or activated for the control resource set without using the indicated unified TCI states. For example, there may be two control resource set groups. There may be two control resource set groups, and the terminal may be configured, through higher layer signaling, to receive a PDCCH by using the first unified TCI state, among the two unified TCI states indicated to the terminal, for all control resource sets in a first control resource set group configured in an activated bandwidth part. The terminal may be configured, through higher layer signaling, to receive a PDCCH by using the second unified TCI state for all control resource sets in a second control resource set group. As another example, there may be two control resource set groups, and if a particular control resource set is included in a first control resource set group, the terminal may receive a PDCCH by using the first unified TCI state among the two unified TCI states indicated to the terminal. If a particular control resource set is included in a second control resource set group, the terminal may receive a PDCCH by using the second unified TCI state. If a particular control resource set is included both in the first control resource set group and the second control resource set group, the terminal may receive a PDCCH by using both of the first unified TCI state and the second unified TCI state. If a particular control resource set is not included both in the first control resource set group and the second control resource set group, the terminal may receive a PDCCH by using a unified TCI state configured or activated for the control resource set without using the indicated unified TCI states.

According to an embodiment of the disclosure, a method of dynamic switching between a single-TRP PDSCH reception operation and a multi-TRP PDSCH reception operation in a unified TCI scheme is described. In the unified TCI scheme, even when a PDSCH is scheduled and a TCI state is newly indicated through a PDCCH, there may be a restriction on time resources called a beam application time. In addition, an already indicated TCI state is applied for transmission or reception before passage of a beam application time, and after passage of the beam application time, application of a newly indicated TCI state may be required for transmission or reception. Therefore, a TCI state indicated by a PDCCH scheduling a PDSCH may not be directly applied to the PDSCH. However, in a case of a PDSCH, a factor for distinguishing between single and multi-TRP-based PDSCH scheduling is the number of TCI states existing in a codepoint indicated by a TCI state in a PDCCH. Due to this problem, dynamic switching between single and multi-TRP-based PDSCH scheduling through a PDCCH may be impossible. Therefore, the following methods may be considered.

According to an embodiment of the disclosure, a terminal may define a dynamic switching-related new DCI field to support a dynamic switching function for single or multi-TRP-based PDSCH scheduling based on scheduling DCI in a unified TCI scheme. The conventional distinguishment between single DCI-based single and multi-TRP-based PDSCH scheduling is made using the number of TCI states indicated by a TCI state field. In the unified TCI scheme, scheduling DCI is unable to directly indicate a TCI state of a scheduled PDSCH. Therefore, a new DCI field in DCI format 1_1 or 1_2 is defined by 1 or 2 bits and may be used for dynamic switching between single and multi-TRP-based PDSCH scheduling. Two joint TCI states or a separate TCI state set including two DL TCI states may be indicated to the terminal through a PDCCH or MAC-CE, based on the unified TCI scheme, and the terminal may consider a situation after passage of a beam application time corresponding to the indicated TCI states. That is, the two TCI states have already been indicated to the terminal and the beam application time has passed, and thus the terminal may assume a situation where application of the indicated TCI states is also possible. In addition, a new field in DCI may exist according to whether higher layer signaling is configured, the higher layer signaling corresponding to a terminal capability report which may include information relating to whether dynamic switching between single DCI-based single and multi-TRP-based PDSCH scheduling is possible. The new field in DCI may be referred to as a TCI state selection field below.

If higher layer signaling is configured for the terminal by a base station and thus the TCI state selection field exists in DCI, the terminal may define the TCI state selection field as follows.
In a case where the TCI state selection field is defined by 1 bit, if a value of the TCI state selection field is indicated as 0, the terminal may expect scheduling for a single-TRP-based PDSCH. —A TCI state to be applied to single-TRP-based PDSCH reception may be a first TCI state among the indicated two TCI states or a joint TCI state or DL TCI state having a low index. If a value of the TCI state selection field is indicated as 1, the terminal may expect scheduling for a multi-TRP-based PDSCH, and as a TCI state to be applied, both of the indicated two joint TCI states or both of the two DL TCI states in the indicated separate TCI state set may be used.
In case that the TCI state selection field is defined by 2 bits, the terminal may expect, from the base station, 4 types of different dynamic switching between single and multi-TRP-based PDSCH scheduling by using the field.
   In case that a value of the TCI state selection field is indicated as “00,” the terminal may consider or identify scheduling of a single-TRP-based PDSCH which is receivable using the first TCI state among the indicated TCI states.
   In case that a value of the TCI state selection field is indicated as “01,” the terminal may consider or identify scheduling of a single-TRP-based PDSCH which is receivable using a second TCI state among the indicated TCI states.
   In case that a value of the TCI state selection field is indicated as “10,” the terminal may consider or identify scheduling of a multi-TRP-based PDSCH which is receivable using the indicated two TCI states. If TDM-based multi-TRP PDSCH repetitive transmission is scheduled for the terminal, the terminal may first consider the first TCI state in an TCI state mapping order. That is, if a TDRA entry including repetitionNumber having a value equal to or greater than 2 is indicated to the terminal through a Time Domain Resource Allocation field in DCI, slotBased is configured as the higher layer signaling RepetitionSchemeConfig-r16, and cyclicMapping is configured as the higher layer signaling tciMapping in slotBased, the terminal may apply the first and second TCI states to PDSCHs for odd-numbered and even-numbered PDSCH reception occasions to receive the PDSCHs, respectively. For example, in a case of four PDSCH repetitive transmissions, the terminal may apply the first TCI state to first and third PDSCHs and apply the second TCI state to the second and fourth PDSCHs to receive same. In addition, if a TDRA entry including repetitionNumber having a value greater than 2 is indicated to the terminal through a Time Domain Resource Allocation field in DCI, slotBased is configured as the higher layer signaling RepetitionSchemeConfig-r16, and sequentialMapping is configured as the higher layer signaling tciMapping in slotBased, the terminal may apply the first TCI state for first two PDSCH reception occasions, and apply the second TCI state to PDSCHs for next two PDSCH reception occasions, and may repeat this operation. For example, in a case of six PDSCH repetitive transmissions, the terminal may apply the first TCI state to first, second, fifth, and sixth PDSCHs and apply the second TCI state to third and fourth PDSCHs to receive same.
   In case that a value of the TCI state selection field is indicated as “11,” the terminal may consider or identify multi-TRP-based PDSCH scheduling by using the indicated two TCI states, and if TDM-based PDSCH repetitive transmission is scheduled for the terminal, the terminal may first consider the second TCI state in an TCI state mapping order. That is, if a TDRA entry including repetitionNumber having a value equal to or greater than 2 is indicated to the terminal through a Time Domain Resource Allocation field in DCI, slotBased is configured as the higher layer signaling RepetitionSchemeConfig-r16, and cyclicMapping is configured as the higher layer signaling tciMapping in slotBased, the terminal may apply the second and first TCI states to PDSCHs for odd-numbered and even-numbered PDSCH reception occasions to receive the PDSCHs, respectively. For example, in a case of four PDSCH repetitive transmissions, the terminal may apply the second TCI state to first and third PDSCHs and apply the first TCI state to the second and fourth PDSCHs to receive same. In addition, if a TDRA entry including repetitionNumber having a value greater than 2 is indicated to the terminal through a Time Domain Resource Allocation field in DCI, slotBased is configured as the higher layer signaling RepetitionSchemeConfig-r16, and sequentialMapping is configured as the higher layer signaling tciMapping in slotBased, the terminal may apply the second TCI state for first two PDSCH reception occasions, and apply the first TCI state to PDSCHs for next two PDSCH reception occasions, and may repeat this operation. For example, in a case of six PDSCH repetitive transmissions, the terminal may apply the second TCI state to first, second, fifth, and sixth PDSCHs and apply the first TCI state to third and fourth PDSCHs to receive same. Alternatively, “11,” a value of the TCI state selection field, is a reserved field and may be a meaningless field.

A PDCCH transmitted from the base station to the terminal may include PDSCH scheduling information and the TCI state selection field (e.g., the TCI state selection field may exist when corresponding higher layer signaling is configured). However, the terminal is unable to know information included in the PDCCH until reception and decoding of the PDCCH are completed, and thus is unable to recognize scheduling information of a PDSCH within a time interval corresponding to a particular reference value (e.g., timeDurationForQCL) after a last symbol of the PDCCH reception. The following two cases for the TCI state selection field may exist.
If higher layer signaling indicating existence or absence of the TCI state selection field is configured, the terminal is able to know the fact that a TCI state selection field exists in the PDCCH, but is unable to identify information on the TCI state selection field until reception and decoding of the PDCCH are completed.
If higher layer signaling indicating existence or absence of the TCI state selection field is not configured, the TCI state selection field does not exist in the PDCCH, and thus the terminal is required to be able to receive a PDSCH which may be scheduled by the PDCCH, by using the indicated TCI states or a TCI state of a particular fixed scheme.

With respect to both of the two cases described above, the terminal is required to be able to receive a PDSCH within at least a time interval corresponding to a particular reference value (e.g., timeDurationForQCL) after a last symbol of the PDCCH reception by using a TCI state or QCL assumption defined according to a rule determined based on the same understanding as that of the base station.

In case that the terminal is not configured with a higher layer signaling by the base station and thus the TCI state selection field does not exist in DCI, the TCI state selection field does not exist in the PDCCH, and thus the terminal may perform PDSCH reception within a time interval corresponding to a particular reference value (e.g., timeDurationForQCL) from a last symbol of a reception time point of the PDCCH including PDSCH scheduling information or even after passage of the time interval corresponding to the particular reference value (e.g., timeDurationForQCL) by using a TCI state or QCL assumption determined based on the same understanding as that of the base station. Although the terminal receives a configuration of higher layer signaling from the base station and thus the TCI state selection field exists in DCI, even when the terminal performs PDSCH reception within a time interval corresponding to a particular reference value (e.g., timeDurationForQCL) after a last symbol of a reception time point of the PDCCH, the terminal may perform the PDSCH reception according to a TCI state or QCL assumption determined based on the same understanding as that of the base station. For the two cases described above, the terminal may perform a default operation for a TCI state selection field according to each condition below.
In case that the higher layer signaling enableTwoDefaultTCI-States is configured for the terminal,
   If there is one TCI state indicated by the base station to the terminal, the terminal may perform one of the following operations. A condition for the one TCI state indicated by the base station to the terminal may be one of [TCI state field activation example 1] and [TCI state field activation example 2]. The following operations may be performable when a terminal capability indicating each operation being supportable is defined and the terminal capability is reported by the terminal to the base station. Furthermore, the terminal may be able to perform at least one of the following operations when, in addition to the terminal capability, the base station receives the terminal capability report and configures higher layer signaling configuration information corresponding thereto for the terminal.
   The terminal may receive a PDSCH by using the one TCI state.
   The terminal may receive the PDSCH by using a TCI state configured or activated for a control resource set having the lowest control resource set index among at least one control resource set monitorable in a slot closest to the PDSCH, or a QCL assumption of the control resource set.
   The terminal may, when receiving a PDSCH, apply, to a PDSCH DMRS, two TCI states corresponding to a codepoint having the lowest index among codepoints in which two TCI states are activated among codepoints in the TCI state field in the DCI.
   The terminal may be notified of one of the possible operations from the base station and use same when receiving the PDSCH. The notification from the base station may be performed through at least one of higher layer signaling, MAC-CE signaling, or L1 signaling.
   If there are two TCI states indicated by the base station to the terminal, the terminal may perform one of the following operations. A condition for the two TCI states indicated by the base station to the terminal may be at least one of [TCI state field activation example 3] to [TCI state field activation example 6]. The following operations may be performable when a terminal capability indicating each operation being supportable is defined and the terminal capability is reported by the terminal to the base station. Furthermore, the terminal may perform at least one of the following operations when, in addition to the terminal capability, the base station receives the terminal capability report and configures higher layer signaling configuration information corresponding to the terminal capability report for the terminal.
   The terminal may receive a PDSCH by using a first TCI state among the indicated two TCI states.
   The terminal may receive a PDSCH by using a second TCI state among the indicated two TCI states.
   The terminal may be notified of which TCI state, among the indicated two TCI states, to be used to receive the PDSCH, from the base station through higher layer signaling configuration information. The higher layer signaling that the terminal may receive from the base station may indicate at least one of the first TCI state among the indicated two TCI states, the second TCI state, the first and second TCI states, and a default TCI state other than the two TCI states.
   The terminal may receive the PDSCH by using a TCI state configured or activated for a control resource set having the lowest control resource set index among at least one control resource set monitorable in a slot closest to the PDSCH, or a QCL assumption of the control resource set having the lowest index.
   The terminal may receive the PDSCH by using the two TCI states.
   The terminal may receive the PDSCH by using the first TCI state among the two TCI states and a TCI state configured or activated for a control resource set having the lowest control resource set index among at least one control resource set monitorable in a slot closest to the PDSCH, or a QCL assumption of the control resource set having the lowest index.
   The terminal may, when receiving a PDSCH, apply, to a PDSCH DMRS, two TCI states corresponding to a codepoint having the lowest index among codepoints in which two TCI states are activated among codepoints in the TCI state field in the DCI.
   The terminal may be notified of one of the possible operations from the base station and use same when receiving the PDSCH. The notification from the base station may be performed through at least one of higher layer signaling, MAC-CE signaling, or L1 signaling.
   Among the above items, in a case where the number of TCI states to be used by the terminal for PDSCH reception is 2 (e.g., the terminal receives a PDSCH by using the two indicated TCI states or uses two TCI states corresponding to a codepoint having the lowest index among codepoints in which two TCI states are activated among codepoints in a TCI state field in DCI), if tdmSchemeA is configured for the terminal as a value of the higher layer signaling repetitionScheme or the higher layer signaling repetitionNumber is configured therefor, and a scheduling offset between a PDCCH and a first PDSCH reception occasion among multiple PDSCH reception occasions is shorter than timeDurationForQCL, the terminal may use two TCI states corresponding to a codepoint having the lowest index among codepoints in which two TCI states are activated among codepoints in a TCI state field in DCI, to apply same to the PDSCH reception occasions repeatedly received on time resources. The terminal may use the activated TCI state codepoint for a slot including the first PDSCH reception occasion. If cyclicMapping is configured for the terminal through higher layer signaling, the terminal may apply first and second TCI states among the two TCI states corresponding to the codepoint having the lowest index to the first PDSCH reception occasion and a second PDSCH reception occasion, respectively. The terminal may identically apply the same application method to subsequent PDSCH reception occasions. If the higher layer signaling sequentialMapping is configured for the terminal, the terminal may apply the first TCI state among the two TCI states corresponding to the codepoint having the lowest index to the first PDSCH reception occasion and the second PDSCH reception occasion, and may apply the second TCI state to third and fourth PDSCH reception occasions. The terminal may identically apply the same application method to subsequent PDSCH reception occasions.
If the higher layer signaling enableTwoDefaultTCI-States is not configured for the terminal,
If there is one TCI state indicated by the base station to the terminal, the terminal may perform one of the following operations. A condition for the one TCI state indicated by the base station to the terminal may be at least one of [TCI state field activation example 1] and [TCI state field activation example 2]. The following operations may be performable when a terminal capability indicating each operation being supportable is defined and the terminal capability is reported by the terminal to the base station. Furthermore, the terminal may be able to perform one of the following operations when, in addition to the terminal capability, the base station receives the terminal capability report and configures higher layer signaling configuration information corresponding to the terminal capability report for the terminal.
The terminal may receive a PDSCH by using the one TCI state.
The terminal may receive the PDSCH by using a TCI state configured or activated for a control resource set having the lowest control resource set index among at least one control resource set monitorable in a slot closest to the PDSCH, or a QCL assumption of the control resource set having the lowest index.
The terminal may be notified of one of the possible operations from the base station and use same when receiving the PDSCH. The notification from the base station may be performed through at least one of higher layer signaling, MAC-CE signaling, or L1 signaling.
If there are two TCI states indicated by the base station to the terminal, the terminal may perform one of the following operations. A condition for the one TCI state indicated by the base station to the terminal may be one of [TCI state field activation example 3] to [TCI state field activation example 6]. The following operations may be performable when a terminal capability indicating each operation being supportable is defined and the terminal capability is reported by the terminal to the base station. Furthermore, the terminal may be able to perform one of the following operations when, in addition to the terminal capability, the base station receives the terminal capability report and configures higher layer signaling configuration information corresponding to the terminal capability report for the terminal.
The terminal may receive a PDSCH by using a first TCI state among the two TCI states.
The terminal may receive the PDSCH by using a second TCI state among the two TCI states.
The terminal may be notified of which TCI state, among the two TCI states, to be used to receive the PDSCH, from the base station through higher layer signaling configuration information. The higher layer signaling that the terminal may receive from the base station may indicate one type of the first TCI state among the indicated two TCI states, the second TCI state among the two TCI states, the first and second TCI states, and a default TCI state other than the two TCI states.
The terminal may receive the PDSCH by using a TCI state configured or activated for a control resource set having the lowest control resource set index among at least one control resource set monitorable in a slot closest to the PDSCH, or a QCL assumption of the control resource set.
The terminal may be notified of one of the possible operations from the base station and use same when receiving the PDSCH. The notification from the base station may be performed through at least one of higher layer signaling, MAC-CE signaling, or L1 signaling.
With respect to the above items, if QCL-TypeD applied to a PDSCH DMRS (i.e., QCL-TypeD information in two TCI states indicated by a codepoint having the lowest index and in which two TCI states are activated among codepoints of a TCI state field in a PDCCH) is different from QCL-TypeD applied to a DMRS of a PDCCH overlapping with the PDSCH on at least one OFDM symbol, the terminal may prioritize PDCCH reception. The terminal may perform the same operation even for intra-band CA (i.e., if the PDSCH and the overlapping control resource set exist on different subcarriers).
The higher layer signaling enableTwoDefaultTCI-States may be replaced with new higher layer signaling (e.g., enableTwoDefaultTCIselection-UnifiedTCI).
With respect to the above items, it may be assumed that a codepoint of a TCI state field corresponding to one type of [TCI state field activation example 1] to [TCI state field activation example 6] described above is indicated for the terminal by the base station, and the terminal uses a default TCI state to be used at the time of the PDSCH reception at a time point at which the indicated TCI state is applied (e.g., from a first slot after BAT symbols from PUCCH transmission including information relating to whether reception of a PDCCH indicating the codepoint of the TCI state field is successful).
With respect to the above items, in a case where the TCI state selection field does not exist or in a case where, even if the TCI state selection field exists, the terminal receives the PDSCH before passage of a time interval corresponding to a particular reference value (e.g., timeDurationForQCL) after a last symbol of a reception time point of the PDCCH, the terminal may identically apply a default beam operation scheme when a single-DCI-based multi-TRP PDSCH is received, as defined above.
With respect to the above items, when higher layer signaling indicating existence of the TCI state selection field is configured for the terminal, the terminal may consider the following assumptions for each downlink DCI format.
   For DCI format 1_1 and 1_2, the terminal may assume that a TCI state selection field may exist as described above, the bit length of the field may be 1 or 2 bits, and the lengths of the TCI state selection fields in DCI format 1_1 and 12 may be the same or different from each other.
   For DCI format 1_0, according to different field definitions which may be determined according to different RNTIs, when it is possible to secure the size of reserved bits by the bit length (e.g., 1 or 2 bits) of the TCI state selection fields in DCI format 1_1 and 1_2, the terminal may assume that the TCI state selection filed may exist. If reserved bits are not secured by the bit length of the TCI state selection field, the terminal may assume that the TCI state selection filed does not exist in DCI format 1_0. For example, in a case of DCI format 1_0 including a CRC scrambled by a C-RNTI, a CS-RNTI, or an MCS-C-RNTI, if all bits of a frequency resource allocation field are 1, when the DCI format is monitored in a common search space at the time of operation in a cell operating for shared spectrum channel access in FR1 or a cell within FR2-2, reserved bits of DCI format 10 may exist in number of 10 bits, and otherwise, same may exist in number of 12 bits. In this case, according to existence or absence of the TCI state selection field and the bit length thereof (if the bit length of the TCI state selection field is X), the length of final reserved bits may be determined to be (10-X) bits (e.g., if the TCI state selection field exists and the number of existing reserved bits is 10 bits) or 12 bits (if the TCI state selection field does not exist and the number of existing reserved bits is 12 bits). As another example, in a case of DCI format 1_0 including a CRC scrambled by a C-RNTI, a CS-RNTI, or an MCS-C-RNTI, if not all bits of a frequency resource allocation field are 1, when the DCI format is monitored in a common search space at the time of operation in a cell within FR2-2 and the bit length of a ChannelAccess-Cpext field is 0 bits, reserved bits of DCI format 1_0 may be 2 bits, and otherwise, same may be 0 bits. In this case, the length of the reserved bits may be possibly 0, and thus the TCI state selection field may exist. In this case, a default operation for a TCI state selection field which is definable by the above items may be performed.
For DCI format 1_0, the TCI state selection field does not exist, and the terminal may perform a default operation for a TCI state selection field which is definable by the above items.

When a terminal receives PUSCH scheduling information from a base station, the terminal may identify whether a particular field exists in DCI, based on whether higher layer signaling configuration information is received from the base station. The particular field may be a previously defined sounding reference signal (SRS) resource set indicator field, or a new field for PUSCH transmission that is newly defined similarly to the TCI state selection field. In the following description, the new field for PUSCH transmission or the SRS resource set indicator may be named a “unified TCI-based PUSCH transmission-related field.”

As a condition for existence of a unified TCI-based PUSCH transmission-related field, two different SRS resource sets having the higher layer signaling txConfig configured as nonCodebook and a usage value configured as nonCodebook may be configured for a terminal by a base station, or two different SRS resource sets having the higher layer signaling txConfig configured as codebook and a usage value configured as codebook may be configured.

If a unified TCI-based PUSCH transmission-related field exists, a terminal may apply, to PUSCH transmission, an operation similar to that for the TCI state selection field. For example, the unified TCI-based PUSCH transmission-related field may be defined by 2 bits. A first codepoint indicates to perform PUSCH transmission, based on a first TCI state among indicated two TCI states, and other codepoints may be defined similarly to the TCI state selection field.

If a unified TCI-based PUSCH transmission-related field does not exist, a terminal may similarly apply a default operation of the TCI state selection field. The default operation for the TCI state selection field and a default optional when the unified TCI-based PUSCH transmission-related field does not exist may be defined to be the same. For example, in the default operation for the TCI state selection field or when the unified TCI-based PUSCH transmission-related field does not exist, the terminal may apply a first TCI state among indicated multiple TCI states.
When higher layer signaling indicating existence of a unified TCI-based PUSCH transmission-related field is configured for the terminal, the terminal may consider the following assumptions for each downlink DCI format.
   For DCI format 0_1 and 0_2, the terminal may assume that a unified TCI-based PUSCH transmission-related field may exist as described above. The bit length of the field may be 1 or 2 bits, and the lengths of the TCI state selection fields in DCI format 0_1 and 0_2 may be the same or different from each other.
   For DCI format 0_0, the terminal may assume that the unified TCI-based PUSCH transmission-related field may exist according to a condition, and if a padding bit is not used for DCI format 0_0, the terminal may define a unified TCI-based PUSCH transmission-related field instead of the padding bit.
   For DCI format 0_0, the TCI state selection field does not exist, and the terminal may perform a default operation for a TCI state selection field or an operation for the unified TCI-based PUSCH transmission-related field, which is definable by the above items.

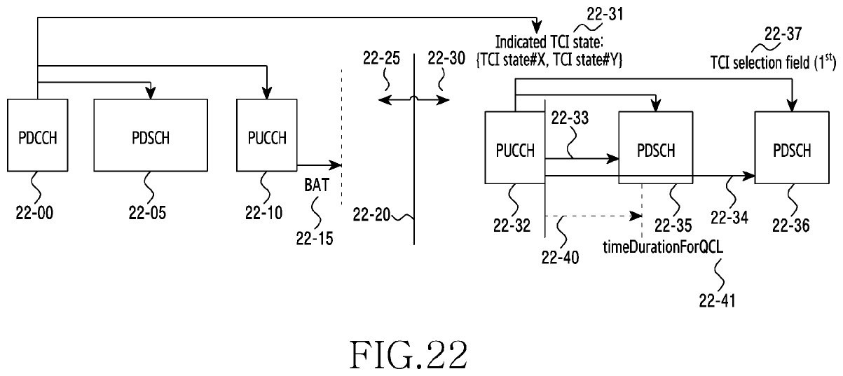

FIG. 22 is a diagram illustrating an operation depending on a TCI state selection field when a unified TCI state-based PDSCH is received, according to an embodiment of the disclosure.

Referring to FIG. 22, a terminal may receive, from a base station, DCI format 1_1 or 1_2 including downlink data channel scheduling information (with DL assignment) or not including downlink data channel scheduling information (without DL assignment), and apply one joint TCI state or one separate TCI state set indicated by a TCI state field in the DCI to uplink transmission and downlink reception beams.

In a case where two TCI states are activated for at least one codepoint of a TCI state field in DCI by the base station for the terminal, if DCI format 1_1 or 1_2 including downlink data channel scheduling information transmitted in a control resource set is received (22-00) so that one joint TCI state or one separate TCI state set based on a unified TCI scheme is indicated, the terminal may receive a PDSCH scheduled based on the received DCI (22-05) and transmit a PUCCH including a HARQ-ACK indicating whether reception of the DCI and the PDSCH is successful (22-10). The HARQ-ACK may include whether reception is successful, for both the DCI and the PDSCH. If the terminal fails to receive at least one of the DCI and the PDSCH, the terminal may transmit a NACK, and if the terminal succeeds in receive both of them, the terminal may transmit an ACK.

If the new TCI state indicated through DCI 22-00 is the same as a TCI state that has previously been indicated and thus been being applied to uplink transmission and downlink reception beams, the terminal may maintain the previously applied TCI state. If the new TCI state is different from the previously indicated TCI state, the terminal may determine, as a time point for application of the joint TCI state or separate TCI state set, which is indicatable by a TCI state field included in the DCI, a time point 22-30 after the first slot 22-20 after passage of a time interval as long as a beam application time (BAT) 22-15 after PUCCH transmission. The terminal may use the previously indicated TCI state at a time point 22-25 before the first slot 22-20, and may assume a situation where two TCI states (TCI state #X and TCI state #Y) 22-31 are newly indicated and are applicable at the time point 22-30 after a particular time point 22-20.

At the time point 22-30, the terminal receives a PDCCH 22-32, and the PDCCH may include PDSCH scheduling information and the TCI state selection field (as described above, the TCI state selection field may exist when corresponding higher layer signaling is configured). However, the terminal is unable to know information included in the PDCCH until reception and decoding of the PDCCH are completed, and thus is unable to recognize scheduling information of a PDSCH within a time interval of timeDurationForQCL 22-41 after a last symbol 22-40 of the PDCCH reception. For the TCI state selection field, the following two cases may exist.
In case that higher layer signaling indicating existence or absence of the TCI state selection field is configured, the terminal is able to know the fact that a TCI state selection field exists in the PDCCH, but is unable to identify information on the TCI state selection field until reception and decoding of the PDCCH are completed.
In case that higher layer signaling indicating existence or absence of the TCI state selection field is not configured, the TCI state selection field does not exist in the PDCCH, and thus the terminal is required to be able to receive a PDSCH which may be scheduled by the PDCCH, by using the indicated TCI states or a TCI state of a particular fixed scheme.

With respect to both of the two cases described above, the terminal is required to be able to receive a PDSCH within at least the time interval of timeDurationForQCL 22-41 after the last symbol 22-40 of the PDCCH reception by using a TCI state or QCL assumption defined according to a rule determined based on the same understanding as that of the base station.

Therefore, if a scheduling offset 22-33 of a PDSCH 22-35 scheduled through the PDCCH 22-32 is scheduled to be shorter than timeDurationForQCL 22-41, the terminal may receive the PDSCH, based on a TCI state or QCL assumption defined according to a particular rule as described above regardless of whether the TCI state selection field exists.

If a scheduling offset 22-34 of a PDSCH 22-36 scheduled through the PDCCH 22-32 is scheduled to be longer than timeDurationForQCL 22-41, when the TCI state selection field exists (22-37), the terminal may receive the PDSCH by selecting a particular TCI state (e.g., a first TCI state among indicated two TCI states) among TCI states indicated by the field. When the TCI state selection field does not exist, the terminal may receive the PDSCH, based on a TCI state or QCL assumption defined according to a particular rule as described above. For example, the terminal may receive the PDSCH by using TCI state #X that is the first TCI state among the indicated two TCI states.

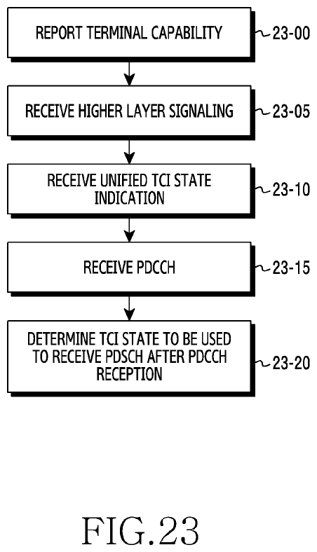

FIG. 23 illustrates an operation of a terminal according to an embodiment of the disclosure.

Referring to FIG. 23, a terminal according to an embodiment may report a terminal capability to a base station (operation 23-00). The reporting of the terminal capability may include each terminal capability indicating support or nonsupport of a multi-DCI or single-DCI multi-TRP operation method, a unified TCI scheme operation method, whether a PCID different from that of a serving cell is configurable and an inter-cell beam management operation method, a default beam operation considering PDSCH reception in a unified TCI scheme mentioned in the above embodiment, a default beam operation when a multi-DCI-based multi-TRP PDSCH is received in a unified TCI scheme, a default beam operation when a single-DCI-based multi-TRP PDSCH is received in a unified TCI scheme, and/or various detailed methods relating to a method of dynamic switching between single and multi-TRP PDSCH reception operations in a unified TCI scheme.

According to an embodiment, the terminal may receive higher layer signaling from the base station (operation 23-05). The higher layer signaling may include higher layer signalings indicating support or nonsupport of, from the base station, a multi-DCI or single-DCI multi-TRP operation method, a unified TCI scheme operation method, whether a PCID different from that of a serving cell is configurable and an inter-cell beam management operation method, a default beam operation considering PDSCH reception in a unified TCI scheme mentioned in the above embodiment, a default beam operation when a multi-DCI-based multi-TRP PDSCH is received in a unified TCI scheme, a default beam operation when a single-DCI-based multi-TRP PDSCH is received in a unified TCI scheme, and/or various detailed methods relating to a method of dynamic switching between single and multi-TRP PDSCH reception operations in a unified TCI scheme.

According to an embodiment, the terminal may receive a unified TCI state indication from the base station (operation 23-10). As described above, the terminal may receive an indication of a unified TCI state through a TCI state field in a PDCCH, and the indicated unified TCI state may be applied from a first slot after BAT symbols after a last symbol of PUCCH transmission including HARQ-ACK information indicating information relating to whether reception of the PDCCH indicating the unified TCI state is successful.

The terminal may receive a PDCCH from the base station (operation 23-15). The PDCCH may include or not include the TCI state selection field or a unified TCI state-based PUSCH transmission-related field according to a DCI format and whether higher layer signaling is configured.

The terminal may determine a TCI state or QCL assumption to be used to receive a PDSCH after a last symbol of a PDCCH reception time point, and receive the PDSCH from the base station. The terminal may determine the TCI state or QCL assumption to be used to receive the PDSCH within or after a time interval corresponding to a particular reference value (e.g., timeDurationForQCL) after the last symbol of the PDCCH reception time point, based on higher layer signaling related to existence or absence of the TCI state selection field or the unified TCI state-based PUSCH transmission-related field, higher layer signaling related to a default beam operation for the multi-DCI or single-DCI multi-TRP operation, the number of the unified TCI states indicated in operation 23-10 described above, and whether the unified TCI state is connected to a PCID of a serving cell and/or a PCID different from that of the serving cell.

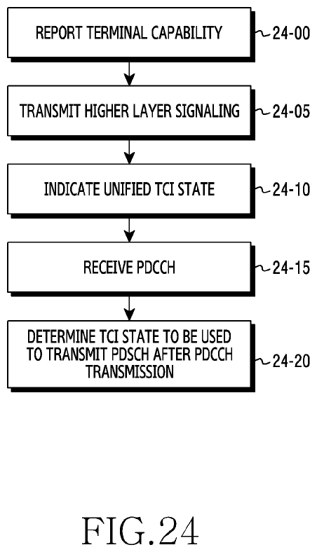

FIG. 24 illustrates an operation of a base station according to an embodiment of the disclosure.

Referring to FIG. 24, a base station according to an embodiment may receive a terminal capability from a terminal (operation 24-00). The reporting of the terminal capability may include each terminal capability indicating support or nonsupport of a multi-DCI or single-DCI multi-TRP operation method, a unified TCI scheme operation method, whether a PCID different from that of a serving cell is configurable and an inter-cell beam management operation method, a default beam operation considering PDSCH reception in a unified TCI scheme mentioned in the above embodiment, a default beam operation when a multi-DCI-based multi-TRP PDSCH is received in a unified TCI scheme, a default beam operation when a single-DCI-based multi-TRP PDSCH is received in a unified TCI scheme, and/or various detailed methods relating to a method of dynamic switching between single and multi-TRP PDSCH reception operations in a unified TCI scheme.

According to an embodiment, the base station may transmit higher layer signaling to the terminal (operation 24-05). The higher layer signaling may include higher layer signalings indicating support or nonsupport of, from the base station, a multi-DCI or single-DCI multi-TRP operation method, a unified TCI scheme operation method, whether a PCID different from that of a serving cell is configurable and an inter-cell beam management operation method, a default beam operation considering PDSCH reception in a unified TCI scheme mentioned in the above embodiment, a default beam operation when a multi-DCI-based multi-TRP PDSCH is received in a unified TCI scheme, a default beam operation when a single-DCI-based multi-TRP PDSCH is received in a unified TCI scheme, and/or various detailed methods relating to a method of dynamic switching between single and multi-TRP PDSCH reception operations in a unified TCI scheme.

According to an embodiment, the base station may transmit a unified TCI state indication to the terminal (operation 24-10). The base station may indicate a unified TCI state to the terminal through a TCI state field in a PDCCH, and the indicated unified TCI state may be applied from a first slot after BAT symbols after a last symbol of PUCCH transmission including HARQ-ACK information indicating information relating to whether reception of the PDCCH indicating the unified TCI state is successful.

The base station may transmit a PDCCH to the terminal (operation 24-15). The PDCCH may include or not include the TCI state selection field or a unified TCI state-based PUSCH transmission-related field according to a DCI format and whether higher layer signaling is configured.

The base station may determine a TCI state or QCL assumption to be used to receive a PDSCH after a last symbol of a PDCCH reception time point, and transmit the PDSCH to the terminal (operation 24-20). The base station may determine the TCI state or QCL assumption to be used to receive the PDSCH within or after a time interval corresponding to a particular reference value (e.g., timeDurationForQCL) after the last symbol of the PDCCH reception time point, based on higher layer signaling related to existence or absence of the TCI state selection field or the unified TCI state-based PUSCH transmission-related field, higher layer signaling related to a default beam operation for the multi-DCI or single-DCI multi-TRP operation, the number of the unified TCI states indicated in operation 23-10 described above, and whether the unified TCI state is connected to a PCID of a serving cell and/or a PCID different from that of the serving cell.

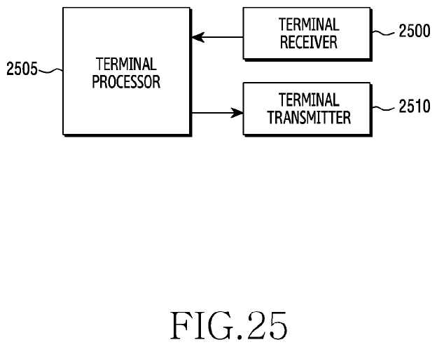

FIG. 25 illustrates the structure of a UE in a wireless communication system according to an embodiment of the disclosure. Referring to FIG. 25, the UE may include a transceiver, which refers to a UE receiver 2500 and a UE transmitter 2510 as a whole, a memory (not illustrated), and a UE processor 2505 (or UE controller or processor). According to the above-described communication methods of the UE, the UE's transceiver 2500 and 2510, memory, and the UE processor 2505 may operate. Components of the UE are not limited to the above-described example. For example, the UE may include a larger or smaller number of components than the above-described components. Furthermore, the transceiver, the memory, and the processor may be implemented as a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the UE's operations. In addition, the memory may store control information or data included in signals transmitted/received by the UE. The memory may include storage media such as a ROM, a RAM, a hard disk, a CD-ROM, and a DVD, or a combination of storage media. In addition, the UE may include multiple memories.

In addition, the processor may control a series of processes such that the UE can operate according to the above-described embodiments. For example, the processor may control components of the UE so as to receive DCI configured in two layers such that multiple PDSCHs are received simultaneously. The UE may include multiple processors, and the processors may perform the UE's component control operations by executing programs stored in the memory.

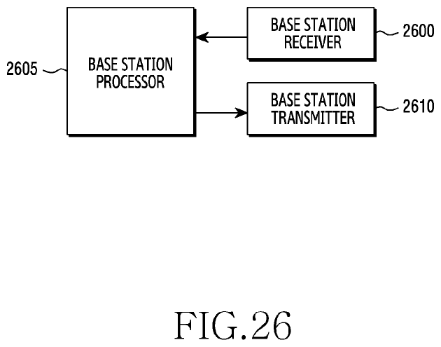

FIG. 26 illustrates the structure of a base station in a wireless communication system according to an embodiment of the disclosure.

Referring to FIG. 26, the base station may include a transceiver, which refers to a base station receiver 2600 and a base station transmitter 2610 as a whole, a memory (not illustrated), and a base station processor 2605 (or base station controller or processor). According to the above-described communication methods of the base station, the base station's transceiver 2600 and 2610, memory, and the base station processor 2605 may operate. Components of the base station are not limited to the above-described example. For example, the base station may include a larger or smaller number of components than the above-described components. Furthermore, the transceiver, the memory, and the processor may be implemented as a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the base station's operations. In addition, the memory may store control information or data included in signals transmitted/received by the base station. The memory may include storage media such as a ROM, a RAM, a hard disk, a CD-ROM, and a DVD, or a combination of storage media. In addition, the base station may include multiple memories.

The processor may control a series of processes such that the base station can operate according to the above-described embodiments of the disclosure. For example, the processor may control components of the base station so as to configure DCI configured in two layers including allocation information regarding multiple PDSCHs and to transmit the same. The base station may include multiple processors, and the processors may perform the base station's component control operations by executing programs stored in the memory.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Moreover, although the above embodiments have been described based on the FDD LTE system, other variants based on the technical idea of the embodiments may also be implemented in other systems such as TDD LTE, 5G, and NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Various embodiments of the disclosure have been described above. The above description of the disclosure is merely for the purpose of illustration, and embodiments of the disclosure are not limited to the embodiments set forth herein. Those skilled in the art will appreciate that other particular modifications and changes may be easily made without departing from the technical idea or the essential features of the disclosure. The scope of the disclosure should be determined not by the above description but by the appended claims, and all modifications or changes derived from the meaning and scope of the claims and equivalent concepts thereof shall be construed as falling within the scope of the disclosure.

A method performed by a user equipment (UE) in a wireless communication system is provided. The method comprises receiving, from a base station, first downlink control information (DCI) including a transmission configuration indicator (TCI) field, receiving, from the base station, a second DCI for scheduling at least one physical downlink shared channel (PDSCH) and receiving, from the base station, PDSCHs based on two TCI states for multi-transmission reception points (m-TRPs), in case that the second DCI includes a TCI selection field including a first value, wherein at least one of the two TCI states is identified based on the TCI field.

The method further comprises receiving, from the base station, the PDSCHs based on the two TCI states for the m-TRPs, in case that the second DCI does not include the TCI selection field and the UE supports two default beams for the m-TRPs.

The method further comprises receiving, from the base station, a PDSCH based on a first TCI state, in case that the UE does not support two default beams for the m-TRPs and an offset between a reception of the second DCI and a reception of the PDSCH is less than a threshold.

The method further comprises receiving, from the base station, the at least one PDSCH based on at least one TCI state indicated by a radio resource control (RRC) configuration, in case that the second DCI corresponds to a DCI format in which the TCI selection field does not exist.

The TCI selection field is configured by a radio resource control (RRC) configuration and includes 2 bits, and a second value of the TCI selection field is reserved.

A user equipment (UE) in a wireless communication system is provided. The UE comprises a transceiver; and a controller coupled with the transceiver and configured to receive, from a base station, first downlink control information (DCI) including a transmission configuration indicator (TCI) field, receive, from the base station, a second DCI for scheduling at least one physical downlink shared channel (PDSCH), and receive, from the base station, PDSCHs based on two TCI states for multi-transmission reception points (m-TRPs), in case that the second DCI includes a TCI selection field including a first value, wherein at least one of the two TCI states is identified based on the TCI field.

The controller is further configured to receive, from the base station, the PDSCHs based on the two TCI states for the m-TRPs, in case that the second DCI does not include the TCI selection field and the UE supports two default beams for the m-TRPs.

The controller is further configured to receive, from the base station, a PDSCH based on a first TCI state, in case that the UE does not support two default beams for the m-TRPs and an offset between a reception of the second DCI and a reception of the PDSCH is less than a threshold.

The controller is further configured to receive, from the base station, the at least one PDSCH based on at least one TCI state indicated by a radio resource control (RRC) configuration, in case that the second DCI corresponds to a DCI format in which the TCI selection field does not exist.

The TCI selection field is configured by a radio resource control (RRC) configuration and includes 2 bits, and a second value of the TCI selection field is reserved.

A method performed by a base station in a wireless communication system is provided. The method comprises transmitting, to a user equipment (UE), first downlink control information (DCI) including a transmission configuration indicator (TCI) field, transmitting, to the UE, a second DCI for scheduling at least one physical downlink shared channel (PDSCH) and transmitting, to the UE, a PDSCH based on the second DCI, wherein the PDSCH is associated with multi-transmission reception points (m-TRPs) which are based on two TCI states, in case that the second DCI includes a TCI selection field including a first value, and wherein at least one of the two TCI states is identified based on the TCI field.

The PDSCH is associated with the m-TRPs which are based on the two TCI states, in case that the second DCI does not include the TCI selection field and the UE supports two default beams for the m-TRPs.

The PDSCH is associated with a single TRP which is based on a first TCI state, in case that the UE does not support two default beams for the m-TRPs and an offset between a reception of the second DCI and a reception of the PDSCH is less than a threshold.

The PDSCH is associated with a TCI state indicated by a radio resource control (RRC) configuration, in case that the second DCI corresponds to a DCI format in which the TCI selection field does not exist.

The TCI selection field is configured by a radio resource control (RRC) configuration and includes 2 bits, and wherein a second value of the TCI selection field is reserved.

A base station in a wireless communication system is provided. The base station comprises a transceiver and a controller coupled with the transceiver and configured to transmit, to a user equipment (UE), first downlink control information (DCI) including a transmission configuration indicator (TCI) field, transmit, to the UE, a second DCI for scheduling at least one physical downlink shared channel (PDSCH), and transmit, to the UE, a PDSCH based on the second DCI, wherein the PDSCH is associated with multi-transmission reception points (m-TRPs) which are based on two TCI states, in case that the second DCI includes a TCI selection field including a first value, and wherein at least one of the two TCI states is identified based on the TCI field.

The PDSCH is associated with the m-TRPs which are based on the two TCI states, in case that the second DCI does not include the TCI selection field and the UE supports two default beams for the m-TRPs.

The PDSCH is associated with a single TRP which is based on a first TCI state, in case that the UE does not support two default beams for the m-TRPs and an offset between a reception of the second DCI and a reception of the PDSCH is less than a threshold.

The PDSCH is associated with a TCI state indicated by a radio resource control (RRC) configuration, in case that the second DCI corresponds to a DCI format in which the TCI selection field does not exist.

The TCI selection field is configured by a radio resource control (RRC) configuration and includes 2 bits, and a second value of the TCI selection field is reserved.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, first downlink control information (DCI) including a transmission configuration indicator (TCI) field;
receiving, from the base station, a second DCI for scheduling at least one physical downlink shared channel (PDSCH); and
receiving, from the base station, PDSCHs based on two TCI states for multi-transmission reception points (m-TRPs), in case that the second DCI includes a TCI selection field including a first value,
wherein at least one of the two TCI states is identified based on the TCI field.

2. The method of claim 1, further comprising:
receiving, from the base station, the PDSCHs based on the two TCI states for the m-TRPs, in case that the second DCI does not include the TCI selection field and the UE supports two default beams for the m-TRPs.

3. The method of claim 1, further comprising:
receiving, from the base station, a PDSCH based on a first TCI state, in case that the UE does not support two default beams for the m-TRPs and an offset between a reception of the second DCI and a reception of the PDSCH is less than a threshold.

4. The method of claim 1, further comprising:
receiving, from the base station, the at least one PDSCH based on at least one TCI state indicated by a radio resource control (RRC) configuration, in case that the second DCI corresponds to a DCI format in which the TCI selection field does not exist.

5. The method of claim 1, wherein the TCI selection field is configured by a radio resource control (RRC) configuration and includes 2 bits, and
wherein a second value of the TCI selection field is reserved.

6. A user equipment (UE) in a wireless communication system, the UE comprising:
a transceiver; and
a controller coupled with the transceiver and configured to:
receive, from a base station, first downlink control information (DCI) including a transmission configuration indicator (TCI) field,
receive, from the base station, a second DCI for scheduling at least one physical downlink shared channel (PDSCH), and
receive, from the base station, PDSCHs based on two TCI states for multi-transmission reception points (m-TRPs), in case that the second DCI includes a TCI selection field including a first value,
wherein at least one of the two TCI states is identified based on the TCI field.

7. The UE of claim 6, wherein the controller is further configured to:
receive, from the base station, the PDSCHs based on the two TCI states for the m-TRPs, in case that the second DCI does not include the TCI selection field and the UE supports two default beams for the m-TRPs.

8. The UE of claim 6, wherein the controller is further configured to:
receive, from the base station, a PDSCH based on a first TCI state, in case that the UE does not support two default beams for the m-TRPs and an offset between a reception of the second DCI and a reception of the PDSCH is less than a threshold.

9. The UE of claim 6, wherein the controller is further configured to:
receive, from the base station, the at least one PDSCH based on at least one TCI state indicated by a radio resource control (RRC) configuration, in case that the second DCI corresponds to a DCI format in which the TCI selection field does not exist.

10. The UE of claim 6, wherein the TCI selection field is configured by a radio resource control (RRC) configuration and includes 2 bits, and
wherein a second value of the TCI selection field is reserved.

11. A method performed by a base station in a wireless communication system, the method comprising:
transmitting, to a user equipment (UE), first downlink control information (DCI) including a transmission configuration indicator (TCI) field;
transmitting, to the UE, a second DCI for scheduling at least one physical downlink shared channel (PDSCH); and
transmitting, to the UE, a PDSCH based on the second DCI,
wherein the PDSCH is associated with multi-transmission reception points (m-TRPs) which are based on two TCI states, in case that the second DCI includes a TCI selection field including a first value, and
wherein at least one of the two TCI states is identified based on the TCI field.

12. The method of claim 11, wherein the PDSCH is associated with the m-TRPs which are based on the two TCI states, in case that the second DCI does not include the TCI selection field and the UE supports two default beams for the m-TRPs.

13. The method of claim 11, wherein the PDSCH is associated with a single TRP which is based on a first TCI state, in case that the UE does not support two default beams for the m-TRPs and an offset between a reception of the second DCI and a reception of the PDSCH is less than a threshold.

14. The method of claim 11, wherein the PDSCH is associated with a TCI state indicated by a radio resource control (RRC) configuration, in case that the second DCI corresponds to a DCI format in which the TCI selection field does not exist.

15. The method of claim 11, wherein the TCI selection field is configured by a radio resource control (RRC) configuration and includes 2 bits, and
wherein a second value of the TCI selection field is reserved.

16. A base station in a wireless communication system, the base station comprising:
a transceiver; and
a controller coupled with the transceiver and configured to:
transmit, to a user equipment (UE), first downlink control information (DCI) including a transmission configuration indicator (TCI) field,
transmit, to the UE, a second DCI for scheduling at least one physical downlink shared channel (PDSCH), and
transmit, to the UE, a PDSCH based on the second DCI,
wherein the PDSCH is associated with multi-transmission reception points (m-TRPs) which are based on two TCI states, in case that the second DCI includes a TCI selection field including a first value, and
wherein at least one of the two TCI states is identified based on the TCI field.

17. The base station of claim 16, wherein the PDSCH is associated with the m-TRPs which are based on the two TCI states, in case that the second DCI does not include the TCI selection field and the UE supports two default beams for the m-TRPs.

18. The base station of claim 16, wherein the PDSCH is associated with a single TRP which is based on a first TCI state, in case that the UE does not support two default beams for the m-TRPs and an offset between a reception of the second DCI and a reception of the PDSCH is less than a threshold.

19. The base station of claim 16, wherein the PDSCH is associated with a TCI state indicated by a radio resource control (RRC) configuration, in case that the second DCI corresponds to a DCI format in which the TCI selection field does not exist.

20. The base station of claim 16, wherein the TCI selection field is configured by a radio resource control (RRC) configuration and includes 2 bits, and
wherein a second value of the TCI selection field is reserved.
